(19) United States
(12) Patent Application Publication
(10) Pub. No.: US 2023/0368096 A1
(43) Pub. Date: Nov. 16, 2023

(54) SYSTEMS FOR INFRASTRUCTURE DEGRADATION MODELLING AND METHODS OF USE THEREOF

(71) Applicant: Rutgers, The State University of New Jersey, New Brunswick, NJ (US)

(72) Inventor: Xiang Liu, Highland Park, NJ (US)

(21) Appl. No.: 18/224,413

(22) Filed: Jul. 20, 2023

Related U.S. Application Data
(63) Continuation of application No. PCT/US22/13105, filed on Jan. 20, 2022.
(60) Provisional application No. 63/140,445, filed on Jan. 22, 2021.

(51) Int. Cl. G06Q 10/0631; G06N 3/08

(52) U.S. Cl. CPC G06Q 10/06315; G06N 3/08

(57) ABSTRACT

Systems and methods of present disclosure provide a processor to receive a first dataset with time-independent characteristics of infrastructure assets of an infrastructural system, and a second dataset with time-dependent characteristics of the infrastructure assets. The processor segments the infrastructural system into the infrastructure assets having a variety of asset components. The processor generates data records for each infrastructure asset where each data record includes a subset of the first dataset and a subset of the second dataset. Using the data records, the processor generates a set of features which are input into a degradation machine learning model. The processor receives an output from the degradation machine learning model indicative of a prediction of a condition of a portion of the infrastructural system at a predetermined time and renders on a graphical user interface a representation of a location, the condition and a recommended asset management decision.

### RELATED APPLICATION

This application is a Continuation application relating to and claiming the benefit of commonly-owned, co-pending PCT International Application No. PCT/US2022/013105, filed Jul. 28, 2022, which claims priority to and the benefit of commonly-owned U.S. Provisional Patent Application Ser. No. 63/140,445, filed Jan. 22, 2021, the entirety of which is incorporated by reference in its entirety.

### STATEMENT OF RIGHTS TO INVENTIONS MADE UNDER FEDERALLY SPONSORED RESEARCH

This invention was made with government support under Grant Nos. 693JJ618C000011 and DTFR5317C00004 awarded by the Federal Railroad Administration. The government has certain rights in the invention.

### FIELD OF TECHNOLOGY

The present disclosure generally relates to computer-based platforms/systems, improved computing devices/components and/or improved computing objects configured for infrastructure degradation modelling and methods of use thereof, including predicting time-specific and location-specific infrastructure degradation using Artificial Intelligence (AI) approaches, more specifically machine learning techniques.

### BACKGROUND OF TECHNOLOGY

Infrastructural systems face issues with the identification of time-specific, location-specific inspection, maintenance, repair, replacement, and rehabilitation for infrastructure degradation. For example, roadways, bridges, tunnels, sewage, water supply, electrical power supply, information service, and other infrastructure categories deteriorate over time. The degradation may depend on time-specific and location-specific factors. Identifying the locations with high risk of degradation and failure can allow infrastructural asset management (e.g., construction, inspection, maintenance, repair, replacement or rehabilitation tasks and combinations thereof) to improve resource allocations for safety management and lifecycle asset management optimization.

### SUMMARY OF DESCRIBED SUBJECT MATTER

In some embodiments, the present disclosure provides an exemplary technically improved computer-based method that includes at least the following steps of receiving, by a processor, a first dataset with time-independent characteristics associated with a plurality of infrastructure assets of an infrastructural system; receiving, by the processor, a second dataset with time-dependent characteristics associated with the plurality of infrastructure assets; segmenting, by the processor, the infrastructural system to group segments of a plurality of asset components into the plurality of infrastructure assets; generating, by the processor, a plurality of data records including a data record for each infrastructure asset of the plurality of infrastructure assets where each data record from the plurality of data records includes: i) a subset of the first dataset including time-independent characteristics associated with the plurality of asset components, and ii) a subset of the second dataset including time-dependent characteristics associated with plurality of asset components; generating, by the processor, a set of features associated with the infrastructural system utilizing the plurality of data records; inputting, by the processor, the set of features into a degradation machine learning model; receiving, by the processor, an output from the degradation machine learning model indicative of a prediction of a condition of an infrastructure asset component of the plurality of asset components within a predetermined time; and rendering, by the processor, on a graphical user interface a representation of a location, the condition predicted for the infrastructure asset component within the predetermined time, and at least one recommended asset management decision.

In some embodiments, the present disclosure provides an exemplary technically improved computer-based system that includes at least the following components of at least one database including a first dataset with time-independent characteristics associated with a plurality of infrastructure assets of an infrastructural system and a second dataset with time-dependent characteristics associated with the plurality of infrastructure assets; and at least one processor in communicated with the at least one database. The at least one processor is configured to execute software instructions that cause the at least one processor to perform steps to: receive the first dataset with the time-independent characteristics associated with the plurality of infrastructure assets of the infrastructural system; receive the second dataset with the time-dependent characteristics associated with the plurality of infrastructure assets; segment the infrastructural system into the plurality of infrastructure assets, where each segment includes a plurality of asset components; generate a plurality of data records including a data record for each infrastructure asset of the plurality of infrastructure assets where each data record from the plurality of data records includes: i) a subset of the first dataset including time-independent characteristics associated with the plurality of asset components, and ii) a subset of the second dataset including time-dependent characteristics associated with plurality of asset components; generate a set of features associated with the infrastructural system utilizing the plurality of data records; input the set of features into a degradation machine learning model; receive an output from the degradation machine learning model indicative of a prediction of a condition of an infrastructure asset component of the plurality of asset components within a predetermined time; and render on a graphical user interface a representation of a location, the condition predicted for the infrastructure asset component within the predetermined time, and at least one recommended asset management decision.

Embodiments of systems and methods of the present disclosure further include where the infrastructural system includes a rail system, where the plurality of infrastructure assets include a plurality of rail segments; and where the plurality of asset components include a plurality of adjacent rail subsegments.

Embodiments of systems and methods of the present disclosure further include segmenting, by the processor, the plurality of infrastructure assets into a plurality of segments of infrastructure assets based on length; and generating, by the processor, the plurality of data records representing the plurality of segments of infrastructure assets.

Embodiments of systems and methods of the present disclosure further include segmenting, by the processor, the plurality of infrastructure assets into a plurality of segments of infrastructure assets based on asset features; and generating, by the processor, the plurality of data records representing the plurality of segments of infrastructure assets.

Embodiments of systems and methods of the present disclosure further include where the asset features include at least one of traffic data, vehicle speed data, vehicle operational data, asset weight data, asset age data, asset design data, asset material data, asset condition data, asset defect data, asset failure data, inspection data, maintenance data, repair data, replacement data, rehabilitation data, asset usage data, asset geometry data or a combination thereof.

Embodiments of systems and methods of the present disclosure further include further including determining, by the processor, the plurality of segments of infrastructure assets according to a minimal internal variance of the asset features of the plurality of infrastructure assets in each segment of the plurality of segments of infrastructure assets.

Embodiments of systems and methods of the present disclosure further include where the asset features include at least one of: i) usage data, traffic data, speed data and operational data, ii) environmental impact data, iii) asset characteristics data, design and geometric data, and condition data, iv) inspection results data, v) maintenance, repair, replacement and rehabilitation data, or iv) any combination thereof.

Embodiments of systems and methods of the present disclosure further include generating, by the processor, features associated with the infrastructural system utilizing the plurality of data records; and inputting, by the processor, the features into a feature selection machine learning algorithm to select the set of features.

Embodiments of systems and methods of the present disclosure further include inputting, by the processor, the set of features into the degradation machine learning model to produce event probabilities; encoding, by the processor, outcome events of the set of features into a plurality of outcome labels; mapping, by the processor, the event probabilities to the plurality of outcome labels; and decoding, by the processor, the event probabilities based on the mapping to produce the prediction of the condition.

Embodiments of systems and methods of the present disclosure further include encoding, by the processor, the outcome events of the set of features into at least one soft tiling of the plurality of outcome labels, where the plurality of outcome labels includes a plurality of time-based tiles of outcome labels.

Embodiments of systems and methods of the present disclosure further include where the degradation machine learning model includes at least one neural network.

The following Abbreviations and Acronyms may signify various aspects of the present disclosure:

| Abbreviation or Acronym | Name |
|---|---|
| ANN | Artificial Neural Network |
| AI | Artificial Intelligence |
| AUC | Area Under the Curve |
| BCP | Binary Classification Problem |
| BHB | Bolt Hole Crack |
| CART | Classification and Regression Tree |
| CWR | Continuously Welded Rail |
| EBF | Engine Burn Fracture |
| EDA | Exploratory Data Analyses |
| EFB | Exclusive Feature Bundling |
| FRA | Federal Railroad Administration |
| FIR | Feeding Imbalance Ratio |
| GBDT | Gradient Boosting Decision Tree |
| GOSS | Gradient-Based One-Side Sampling |
| HW | Head Web |
| HSH | Horizontal Split Head |
| ID3 | Iterative Dichotomiser 3 |
| IR | Imbalance Ratio |
| LightGBM | Light Gradient Boosting Model |
| MAE | Mean Absolute Error |
| MSE | Mean Square Error |
| MGT | Gross Million Tonnage |
| MP | Milepost |
| MPH | Maximum Allowed Speed |
| RCF | Rolling Contact Fatigue |
| ROC | Receiver Operating Characteristic |
| SSC | Shelling/Spalling/Corrugation |
| STC-NN | Soft Tile Coding based Neural Network |
| TPTR | Total Predictable Time Range |
| VTI | Vehicle-Track Interaction |
| VSH | Vertical Split Head |
| ZTNB | Zero-Truncated Negative Binomial |

The following Abbreviations and Acronyms may signify nomenclature for various service failure type codes of the present disclosure:

| Abbreviation | Description |
|---|---|
| TDD | Detail Fracture |
| TW | Defective Field Weld |
| SSC | Shelling/Spalling/Corrugation |
| EFBW | In-Track Electric Flash Butt Weld |
| SD | Shelly Spots |
| EBF | Engine Burn Fracture |
| BHB | Bolt Hole Crack |
| HW | Head Web |
| HSH | Horizontal Split Head |
| VSH | Vertical Split Head |
| EB | Engine Burn - (Not Fractured) |
| OAW | Defective Plant Weld |
| FH | Flattened Head |
| CH | Crushed Head |
| SW | Split Web |
| SDZ | Shelly Spots in Dead Zones of Switch |
| TDT | Transverse Fissure |
| TDC | Compound Fissure |
| LER | Loss of Expected Response-Loss of Ultrasonic Signal |
| BRO | Broken Rail Outside Joint Bar Limits |
| DWL | Separation Defective Field Weld (Longitudinal) |
| BB | Broken Base |
| PIPE | Piped Rail |
| DR | Damaged Rail |

The following Abbreviations and Acronyms may signify various nomenclature for Geometry Track Exception Types of aspects of the present disclosure

| Subgroup | Geometry Track Exception Type |
|---|---|
| CROSS- | CROSS-LEVEL |
| LEVEL/CLIM | CLIM |
| | WIDE GAGE |
| | PLG 24 1ST LEVEL |
| | PLG 24 2ND LEVEL |
| GAGE | GWP 1ST LEVEL |
| | GWP 2ND LEVEL |
| | LOADED GAGE |
| | TIGHT GAGE |
| | LEFT RAIL CANT |
| CANT | RIGHT RAIL CANT |
| | CONC LT RAIL CANT |
| | CONC RT RAIL CANT |
| ALIGNMENT | ALIGNMENT LEFT |
| | ALIGNMENT RIGHT |
| | ALIGNMENT |
| | ALIGNMENT LFET 31 FT |
| | ALIGNMENT RIGHT 31 FT |
| WARP 31 | WARP 31 FT |
| WARP 62 | WARP 62 FT |
| | WARP 62 FT > 6 IN XLV |
| | EXCESS. ELEVATION |
| | CURVE SPEED 3IN |
| SPEED/ELEVATION | CURVE SPEED 4IN |
| | RUN OFF LEFT |
| | RUN OFF RIGHT |
| | RIGHT VERT ACC |
| | PROFILE RIGHT 62 FT |
| PROFILE/SURFACE | PROFILE LEFT 62 FT |
| | UNBALANCE 4 IN |
| | UNBALANCE 3 IN |

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a Class I railroad mainline freight-train derailment frequency by accident cause group in accordance with illustrative embodiments of the present disclosure;

FIG. 2 depicts a classification of selected contributing factors in accordance with illustrative embodiments of the present disclosure;

FIG. 3A depicts a distribution of rail laid year in accordance with illustrative embodiments of the present disclosure;

FIG. 3B depicts a distribution of grade (percent) in accordance with illustrative embodiments of the present disclosure;

FIG. 3C depicts a distribution of curvature degree (curved portion only) in accordance with illustrative embodiments of the present disclosure;

FIG. 3D depicts the top ten defect types during an example period in accordance with illustrative embodiments of the present disclosure;

FIG. 3E depicts a distribution of six types of remediation action during an example period in accordance with illustrative embodiments of the present disclosure;

FIG. 3F depicts the top ten types of broken rails during an example period in accordance with illustrative embodiments of the present disclosure;

FIG. 3G depicts a track geometry track exception by type during an example period in accordance with illustrative embodiments of the present disclosure;

FIG. 3H depicts a distribution of VTI Exception types during an example period in accordance with illustrative embodiments of the present disclosure;

FIG. 3I depicts a multi-source data fusion in accordance with illustrative embodiments of the present disclosure;

FIG. 3J depicts a data mapping to reference location in accordance with illustrative embodiments of the present disclosure;

FIG. 3K depicts a structure of the integrated database in accordance with illustrative embodiments of the present disclosure;

FIG. 3L depicts an example of tumbling window in accordance with illustrative embodiments of the present disclosure;

FIG. 3M depicts a feature construction with nearest service failure in the study period in accordance with illustrative embodiments of the present disclosure;

FIG. 3N depicts a feature construction without nearest service failure in the study period in accordance with illustrative embodiments of the present disclosure;

FIG. 4 depicts a correlation between each two input variables in accordance with illustrative embodiments of the present disclosure;

FIG. 5A depicts a fixed-length segmentation in accordance with illustrative embodiments of the present disclosure;

FIG. 5B depicts a feature-based segmentation in accordance with illustrative embodiments of the present disclosure;

FIG. 5C depicts a process of dynamical segmentation in accordance with illustrative embodiments of the present disclosure;

FIG. 6A depicts a distribution of traffic tonnage before and after feature transformation in accordance with illustrative embodiments of the present disclosure;

FIG. 6B depicts selected top ten important features using lightGBM algorithm in accordance with illustrative embodiments of the present disclosure;

FIG. 6C depicts a schematic illustration of STC-NN algorithm framework in accordance with illustrative embodiments of the present disclosure;

FIG. 6D depicts an illustrative example of tile-coding in accordance with illustrative embodiments of the present disclosure;

FIG. 6E depicts an illustrative example of soft-tile-coding in accordance with illustrative embodiments of the present disclosure;

FIG. 6F depicts a forward architecture of STC-NN model for prediction in accordance with illustrative embodiments of the present disclosure;

FIG. 6G depicts a backward architecture of the STC-NN Model for training process in accordance with illustrative embodiments of the present disclosure;

FIG. 6H depicts a process to transform the output encoded vector into the probability distribution with respect to lifetime in accordance with illustrative embodiments of the present disclosure;

FIG. 6I depicts a cumulative probability and probability density of 100 randomly selected segments with respect to different timestamps in accordance with illustrative embodiments of the present disclosure;

FIG. 6J depicts an illustrative comparison between two typical segments in terms of broken rail probability prediction in accordance with illustrative embodiments of the present disclosure;

FIG. 6K depicts AUC values by the number of training steps in accordance with illustrative embodiments of the present disclosure;

FIG. 6L depicts the AUCs by FIR in the STC-NN Model in accordance with illustrative embodiments of the present disclosure;

FIG. 6M depicts a comparison of computation time for one-month prediction by alternative models in accordance with illustrative embodiments of the present disclosure;

FIG. 6N depicts a receiver operating characteristics curve with t0=30 days in accordance with illustrative embodiments of the present disclosure;

FIG. 6O depicts a time-dependent AUC performance in accordance with illustrative embodiments of the present disclosure;

FIG. 6P depicts a comparison of the cumulative probability by prediction period between the segments with and without broken rails in accordance with illustrative embodiments of the present disclosure;

FIG. 6Q depicts an empirical and predicted numbers of broken rails on network level in accordance with illustrative embodiments of the present disclosure;

FIG. 6R depicts a risk-based network screening for broken rail identification with prediction period as one month in accordance with illustrative embodiments of the present disclosure;

FIG. 6S depicts a visualization of predicted broken rail marked with various categories in accordance with illustrative embodiments of the present disclosure;

FIG. 6T depicts a visualization of screened network in accordance with illustrative embodiments of the present disclosure;

FIG. 6U depicts a visualization of broken rails within screened network in accordance with illustrative embodiments of the present disclosure;

FIG. 7A depicts a broken-rail derailment rate per broken rail by season in accordance with illustrative embodiments of the present disclosure;

FIG. 7B depicts a number of broken-rail derailments per broken rail by curvature in accordance with illustrative embodiments of the present disclosure;

FIG. 7C depicts a number of broken-rail derailments per broken rail by signal setting in accordance with illustrative embodiments of the present disclosure;

FIG. 7D depicts a broken-rail-caused derailment rate per broken rail by annual traffic density in accordance with illustrative embodiments of the present disclosure;

FIG. 7E depicts a broken-rail-caused derailment rate per broken rail in terms of FRA Track Class in accordance with illustrative embodiments of the present disclosure;

FIG. 7F depicts a number of broken-rail derailments per broken rail by annual traffic density level and signal setting in accordance with illustrative embodiments of the present disclosure;

FIG. 7G depicts a number of broken-rail derailments per broken rail by season and signal setting in accordance with illustrative embodiments of the present disclosure;

FIG. 8A depicts a number of cars (railcars and locomotives) derailed per broken-rail-caused freight-train derailment, Class I railroad on mainline during an example period in accordance with illustrative embodiments of the present disclosure;

FIG. 8B depicts a schematic architecture of decision tree in accordance with illustrative embodiments of the present disclosure;

FIG. 8C depicts a variable importance for train derailment severity data in accordance with illustrative embodiments of the present disclosure;

FIG. 8D depicts a decision tree in broken-rail-caused train derailment severity prediction in accordance with illustrative embodiments of the present disclosure;

FIG. 9A depicts a step-by-step broken-rail derailment risk calculation in accordance with illustrative embodiments of the present disclosure;

FIG. 9B depicts a mockup interface of the tool for broken-rail derailment risk in accordance with illustrative embodiments of the present disclosure;

FIG. 10 depicts a block diagram of an exemplary computer-based system and platform 1000 in accordance with one or more embodiments of the present disclosure.

FIG. 11 depicts a block diagram of another exemplary computer-based system and platform 1100 in accordance with one or more embodiments of the present disclosure.

FIG. 12 depicts a block diagram of an exemplary cloud computing architecture of the exemplary computer-based system and platform 1100 in accordance with one or more embodiments of the present disclosure.

FIG. 13 depicts a block diagram of another exemplary cloud computing architecture in accordance with one or more embodiments of the present disclosure.

FIG. 14 depicts examples of the top ten types of service failures in accordance with illustrative embodiments of the present disclosure;

FIG. 15A depicts a Receiver Operating Characteristics (ROC) curve with respective to different prediction periods for an extreme gradient boosting algorithm in accordance with illustrative embodiments of the present disclosure;

FIG. 15B depicts a network screening curve with respective to different prediction periods for the extreme gradient boosting algorithm in accordance with illustrative embodiments of the present disclosure;

FIG. 16A depicts a schematic for a random forests framework in accordance with illustrative embodiments of the present disclosure;

FIG. 16B depicts a ROC curve with respective to different prediction periods for the random forests framework in accordance with illustrative embodiments of the present disclosure;

FIG. 16C depicts a network screening curve with respective to different prediction periods for the random forests framework in accordance with illustrative embodiments of the present disclosure;

FIG. 17A depicts leaf-wise tree growth in a light gradient boosting machine algorithm in accordance with illustrative embodiments of the present disclosure;

FIG. 17B depicts level-wise tree growth in the light gradient boosting machine algorithm in accordance with illustrative embodiments of the present disclosure;

FIG. 17C depicts a ROC curve with respective to different prediction periods for the light gradient boosting machine algorithm in accordance with illustrative embodiments of the present disclosure;

FIG. 17D depicts a network screening curve with respective to different prediction periods for the light gradient boosting machine algorithm in accordance with illustrative embodiments of the present disclosure;

FIG. 18A depicts a ROC curve with respective to different prediction periods for a logistic regression algorithm in accordance with illustrative embodiments of the present disclosure;

FIG. 18B depicts a network screening curve with respective to different prediction periods for the logistic regression algorithm in accordance with illustrative embodiments of the present disclosure;

FIG. 19A depicts a ROC curve with respective to different prediction periods for a proportion hazard regression algorithm in accordance with illustrative embodiments of the present disclosure; and

FIG. 19B depicts a network screening curve with respective to different prediction periods for the proportion hazard regression algorithm in accordance with illustrative embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

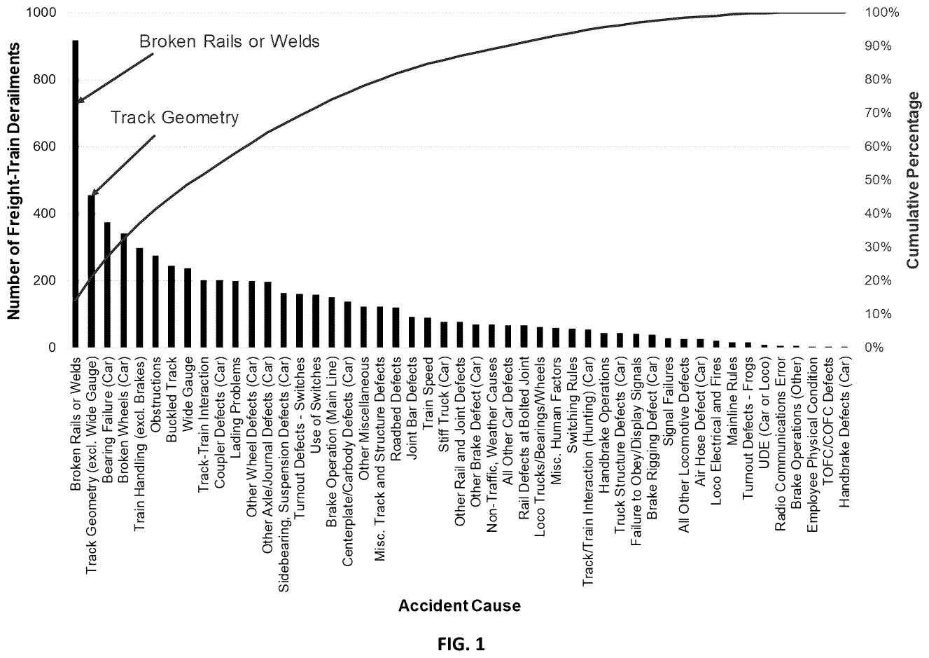

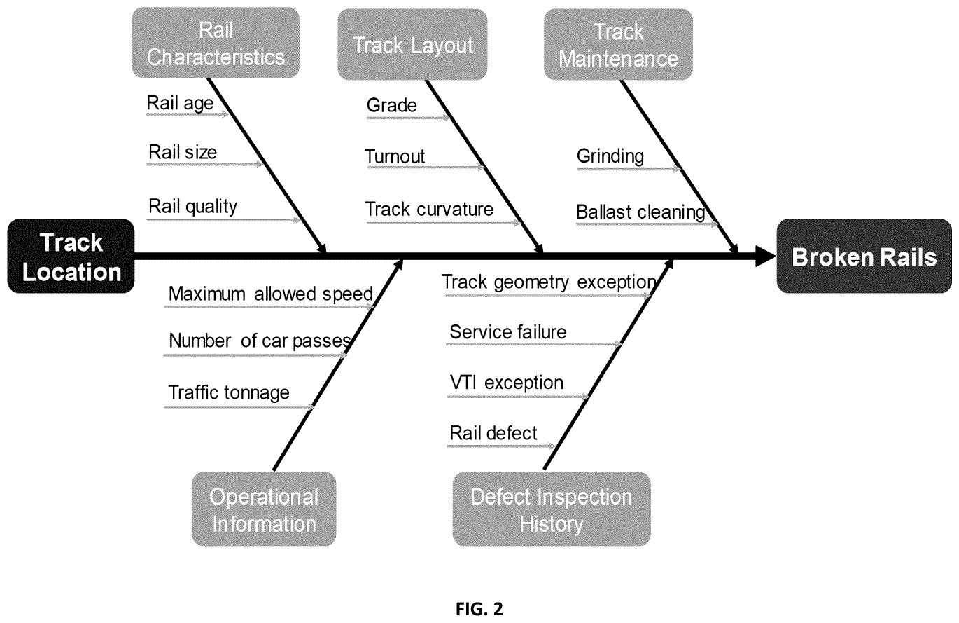

FIGS. 1 through 19B illustrate systems and methods of infrastructure degradation prediction and failure prediction and identification. The following embodiments provide technical solutions and technical improvements that overcome technical problems, drawbacks and/or deficiencies in the technical fields involving infrastructure inspection, inspection and/or maintenance and repair.

U.S. freight railroads spent over $660 billion in inspection and/or maintenance and capital expenditures between 1980 and 2017, with over $24.8 billion in capital and inspection and/or maintenance disbursements in 2017 alone (AAR, 2018). Although freight-train derailment rates in the U.S. have been reduced by 44% since 2010, derailment remains a common type of freight train accident in the U.S. According to accident data from the Federal Railroad Administration (FRA) of the U.S. Department of Transportation (USDOT), approximately 6,450 freight-train derailments occurred between 2000 and 2017, causing $2.5 billion worth of infrastructure and rolling stock damage.

The FRA of USDOT classifies over 380 distinct accident causes into categories of infrastructure, rolling stock, human factor, signaling and others. Based on a statistical analysis of the freight-train derailments that occurred on Class I mainlines from 2000 to 2017, broken rails or welds have been the leading cause in recent years of freight-train derailments (see, for example, FIG. 1). As a result, broken-rail prevention and risk management have been being a major activity for a long time for the railroad industry. In addition to the United States, other countries with heavy-haul railroad activity have also identified the crucial importance of broken rail risk management.

Quantifying mainline infrastructure failure risk and thus identifying the locations with high risk can allow infrastructure maintainers to improve resource allocations for safety management and inspection and/or maintenance optimization. The failure risk may be depending on the probability of the occurrence of broken-infrastructure-related failure and the severity of broken-infrastructure-related failure.

For example, quantifying mainline broken-rail derailment risk and thus identifying the locations with high risk can allow railroads to improve resource allocations for safety management and inspection and/or maintenance optimization. The derailment risk may be depending on the probability of the occurrence of broken-rail derailment and the severity of broken-rail-caused derailment that is defined as the number of cars derailed from a train. The number of cars derailed in freight-train derailments is related to several factors, including the train length, derailment speed, and proportion of loaded cars.

The railroad company has various types of data, including track characteristics (e.g. rail profile information, rail laid information), traffic-related information (e.g. monthly gross tonnage, number of car passes), inspection and/or maintenance records (e.g. rail grinding or track ballast cleaning activities), the past defect occurrences, and many other data sources. In addition, the Federal Railroad Administration (FRA) has collected railroad accident data since 1970s.

These multi-source data provided the basis for understanding the potential factors that may affect the occurrence of broken rails as well as broken-rail-caused derailments. However, there is still limited prior research that takes full advantage of these real-world data to address the relationship between factors and broken-rail-caused derailment risk, while using the risk information to screen the network and identify higher-risk locations.

As explained in more detail, below, technical solutions and technical improvements herein include aspects of improved data interpretation for feature engineering to identify and predict infrastructure degradation and degradation and determine a failure risk at a location within an infrastructure network. Based on such technical features, further technical benefits become available to users and operators of these systems and methods. Moreover, various practical applications of the disclosed technology are also described, which provide further practical benefits to users and operators that are also new and useful improvements in the art.

In some embodiments, an integrated database utilized to maintain datasets of infrastructure asset characteristics in an infrastructure system. In some embodiments, the infrastructure system may include, e.g., train rail system, water supply system, road or highway system, bridges, tunnels, sewage systems, power supply infrastructure systems, telecommunications infrastructure systems, among other infrastructure systems and combinations thereof. The infrastructure assets may include any segment of parts, components and portions of the infrastructure system. For example, segments of roadway, individual or segments of rail, individual or segments of pipes, individual or segments of wiring, telephone poles, sewage drains, among other infrastructure assets and combinations thereof.

Herein, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

Depending on the database model, one or more database query languages may be employed to retrieve data from the database. Examples of database query languages may include: JSONiq, LDAP, Object Query Language (OQL), Object Constraint Language (OCL), PTXL, QUEL, SPARQL, SQL, XQuery, Cypher, DMX, FQL, Contextual Query Language (CQL), AQL, among suitable database query languages.

The database may include one or more software, one or more hardware, or a combination of one or more software and one or more hardware components forming a database management system (DBMS) that interacts with users, applications, and the database itself to capture and analyze the data. The DBMS software additionally encompasses the core facilities provided to administer the database. The combination of the database, the DBMS and the associated applications may be referred to as a “database system”.

In some embodiments, the integrated database may include at least a first dataset of time-independent characteristics of the infrastructure assets. For example, the first dataset may include, e.g., the size, shape, composition and configuration by various measurements of each infrastructure asset, including where it is located, how it is installed, and any other structural specifications.

In some embodiments, the integrated database may include at least a second dataset of time-dependent characteristics of the infrastructure assets. For example, the second dataset may include, e.g., frequency of use, frequency of inspection and/or maintenance, extent of use, extent of inspection and/or maintenance, weather and climate data, seasonality, life span, among other measurements of each time-varying data of the infrastructure asset.

In some embodiments, a prediction system may receive the first dataset and the second dataset for use in determining whether the infrastructure assets are at risk of degradation-related failures. In some embodiments, the prediction system may include one or more computer engines for implementing feature engineering, machine learning model utilization, asset management recommendation decisioning, among other capabilities.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Herein, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

In some embodiments, the prediction system may perform feature engineering, including infrastructure segmentation, feature creation, feature transformation, and feature selection. In some embodiment, infrastructure segmentation may include, e.g., segmenting portions of the infrastructural system into groups of infrastructure assets.

In some embodiments, the prediction system may segment the infrastructural system in infrastructure assets, with each infrastructure asset having segments of asset components (e.g., rails, sections of roadway, pipes, wires, telephone poles, etc.). In some embodiments, there may be two types of strategies for the segmentation process: fixed-length segmentation and feature-based segmentation. fixed-length segmentation divides the whole infrastructural system into segments with a fixed length. For feature-based segmentation, the whole infrastructural system can be divided into segments with varying lengths. If fixed-length segmentation is applied and the small adjacent segments are combined, these combined segments may have different characteristics of certain influencing factors affecting infrastructure degradation. This combination may introduce potentially large variance into the integrated database and further affect the prediction performance. For feature-based segmentation, segmentation features are used to measure the uniformity of adjacent segments. In some embodiments, adjacent segments may be grouped and combined under the condition that these adjacent segments embody similar features. Otherwise, these adjacent segments may be isolated. Feature-based segmentation can reduce the variances in the new segments.

In some embodiments, during the segmentation process, the whole set of infrastructural system segments are divided into different groups. Each group may be formed to maintain the uniformity on each segment of asset components. In some embodiments, aggregation functions are applied to assign the updated values to the new segment of asset components. For example, the average value of nearby fixed length segments may be used for features such as the usage data and use the summation value for features such as a total number of detected defects, or other degradation-related measurements.

In some embodiments, the fixed-length segmentation is the segmentation strategy that uses the fixed length to merge consecutive fixed length segments compulsively, which ignores the variance of the features on these segments. This forced merge strategy can be understood as a moving average filtering along series of infrastructure assets. In the fixed-length segmentation, a pre-determined fixed segmentation length is set to a suitable multiple of the fixed-length. In some embodiments, fixed-length segmentation is the most direct (easiest) approach for infrastructural system segmentation and the algorithm is the fastest. In some embodiments, the internal difference of features can be significant but is likely to be neglected.

In some embodiments, feature-based segmentation may combine uniform segments of asset components together. The uniformity may be defined by the internal variance or variance among the fixed length segments on the new segment. The uniformity is measured by the information loss which is calculated by the summation of the weighted variances on involved features of each asset component. The formula shown below is used to calculate the information loss.

Loss(A)=Σ_{i∈[1,n]}wᵢ·std(Aᵢ) (1-1)

Where:
A: the feature matrix
n: number of involved features
Aᵢ: the i^{th} column of A
wᵢ: the weight associated with the i^{th} feature
std(Aᵢ): the standard deviation of the i^{th} column of A

In some embodiments, the loss function can be interpreted as follows: given multiple features, the weighted summation of the standard deviation of each feature may be calculated, then a value to represent the internal difference of records of one feature is obtained. In some embodiments, the smaller the value of the loss functions, the more uniform each new segment in the segmentation strategy can be, due to minimizing the internal variances of selected features on the same segmentation.

In some embodiments, the static-feature-based segmentation may use time-independent features (e.g., the first dataset) to measure the information when combining consecutive segments to a new longer segment of asset components to form infrastructure assets. In the feature-based segmentation, the information loss Loss(A) may be minimized (e.g., to zero or as close to zero as possible) when determining the length of newly merged segment of asset components. Therefore, feature-based segmentation is an adaptive and dynamic segmentation scheme in which a segment is assigned when at least one involved feature changes. The dynamic segmentation is an advanced type of feature-based segmentation strategy that uses an optimization model to minimize a predefined information loss in order to find the best segment length around a particular location.

In some embodiments, in preparation for static-feature-based segmentation, segmentation features may be selected to determine the uniformity of the adjacent fixed length segments. A new segment is assigned when at least one involved feature changes. The selected segmentation features might be continuous or categorical. For categorical features, the uniformity is defined by whether the features among fixed length segments are identical. In some embodiments, for continuous features, a tolerance threshold may be used to define the uniformity. If the difference of continuous feature values of adjacent segments is smaller than the defined tolerance, uniformity may be deemed to exist. In some embodiments, for feature-based segmentation, e.g., 10% or other suitable percentage (e.g., 5%, 12.5%, 15%, 20%, 25%, etc.) of the standard deviation of differences of continuous features of the two consecutive fixed length segments is used as the tolerance.

In some embodiments, static-feature-based segmentation is easy to understand, and the algorithm is easy to design. The internal difference of time-independent infrastructure asset information is also minimized. In some embodiments, when considering more features, the final merged segments can be more scattered with large number of segmentations. The difference of features within the same segment, such as inspection and/or maintenance and defect history, may be difficult to utilize in feature-based segmentation because they are point-specialized events (non-static).

In some embodiments, a dynamic feature-based segmentation may be employed. Different from the above two segmentation strategies, dynamic-feature-based segmentation may include the segmentation strategy that uses an optimization model to minimize a predefined loss function to find the “best” segment length around a local milepost. In some embodiments, all features are used to calculate the information loss function to evaluate the internal difference of a segment. We can write the optimization model as

$$L = {argmin}_{n} Loss ( {A}^{n} ) \qquad ( 1 - 2 )$$

$$Loss ( A ) = {\sum }_{i ∈ [ 1 , m ]} {w}_{i} \cdot std ( {A}_{i}^{n} ) \qquad ( 1 - 3 )$$

Where:
Aⁿ: feature matrix with n rows (the number of asset components is n)
m: number of involved features
Aᵢⁿ: the i^{th} column of Aⁿ (i^{th} feature)
wᵢ: the weight associated with the i^{th} feature
std(Aᵢⁿ): the standard deviation of the i^{th} column of A

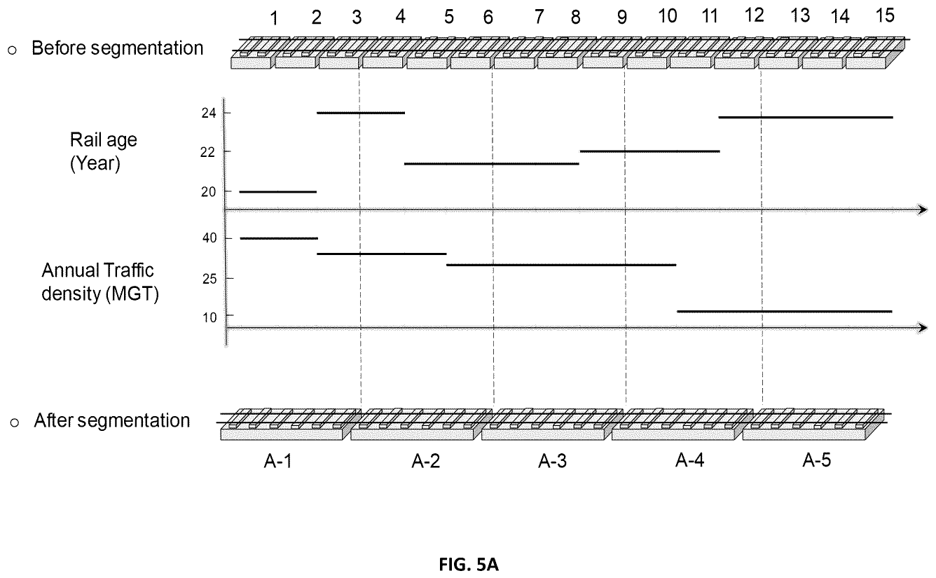

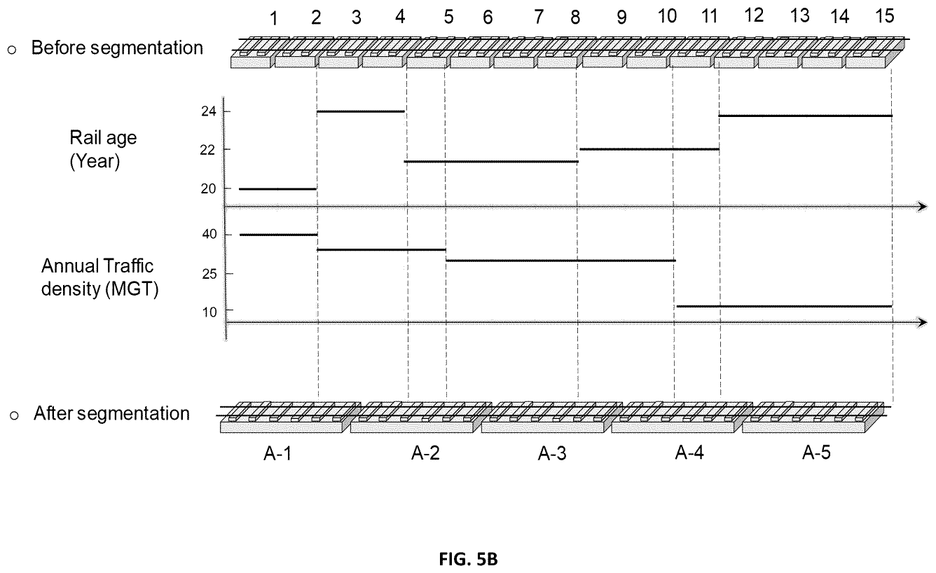

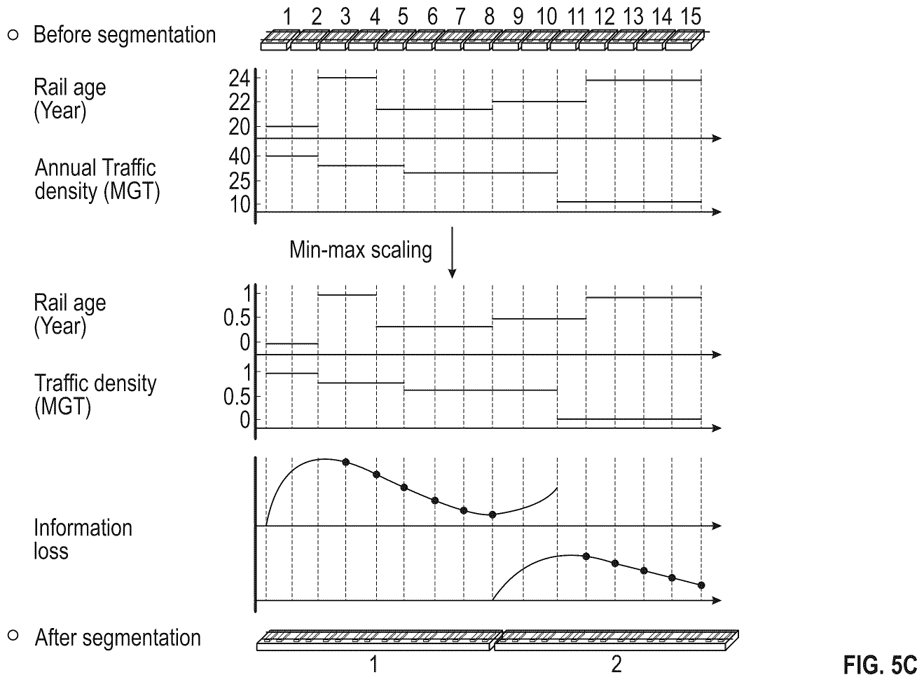

In some embodiments, with a fixed beginning milepost, find the best n that minimizes the loss function of Aⁿ. Aⁿ indicates a segment with length of n. The optimization model can be interpreted as: finding the best segment length to minimize the loss function, from all possible segment combinations. In some embodiments, to solve the optimization model, iteration algorithm may be used to optimize the segmentation and get the approximately optimal solution. In some embodiments, the loss function is also employed to find the best segment length. For the example shown in FIG. 5C, two features are involved for dynamic-feature-based segmentation, which are rail age and annual traffic density. The weights associated with the two features in the information loss function are assumed to be the same.

In some embodiments, dynamic-feature-based segmentation takes all features (both time-independent or time-dependent) into consideration. The influence of the diversity of features can be controlled by changing the weights in the loss function. Dynamic-feature-based segmentation can also avoid the combined segments being too short. Therefore, this type of segmentation strategy might be more appropriate for infrastructural system-scale infrastructure asset degradation prediction. In some embodiments, he computation may be time-consuming compared with fixed-length segmentation and static-feature-based segmentation. The development algorithm is more complex.

In some embodiments, the prediction system may then generate data records for each segment of asset components. Accordingly, the prediction system generates records of infrastructure assets including the segments of asset components. In some embodiments, the prediction system may store the data records of the infrastructure assets in the integrated database or in another database.

In some embodiments, the prediction system may then perform feature engineering on the infrastructural system based on the data records to generate a set of features.

In some embodiments, feature engineering may include feature creation, feature transformation, and feature selection. Feature creation focuses on deriving new features from the original features, while feature transformation is used to normalize the range of features or normalize the length-related features by segment length. Feature selection identifies the set of features that accounts for most variances in the model output.

In some embodiments, the original features in the integrated database, including the time-independent characteristics and the time-dependent characteristics of the asset components. Feature creation may include the extraction of these characteristics from each data record of infrastructure assets according to the asset components forming each infrastructure asset.

In some embodiments, a feature transformation process may be employed to generate features such as, e.g., Cross-Term Features, Min-Max Normalization of features, Categorization of Continuous Features, Feature Distribution Transformation, Feature Scaling by Segment Length and any other suitable features created via feature transformation.

In some embodiments, cross-term features may include interaction items. In some embodiments, cross-term features can be products, divisions, sums, or the differences between two or more features. In terms of the sums of some features, the aim is to combine sparse classes or sparse categories. Sparse classes (in categorical features) are those that have very few total observations, which might be problematic for certain machine learning algorithms, causing models to be overfitted. To avoid sparsity, similar classes may be grouped together to form larger classes (with more observations). Finally, the remaining sparse classes may be grouped into a single “other” class. There is no formal rule for how many classes that each feature needs. The decision also depends on the size of the dataset and the total number of other features in the integrated database.

The range of values of features in the database may vary widely. For some machine learning algorithms, objective functions may not work properly without normalization. Accordingly, in some embodiments, Min-Max normalization may be employed for feature normalization, which may enable each feature to contribute proportionately to the objective function. Moreover, feature normalization may speed up the convergences for gradient descent which are applied in various machine algorithm trainings. Min-max normalization is calculated using the following formula:

$${x}_{new} = \frac{x - min ( x )}{max ( x ) - min ( x )} \qquad ( 1 - 4 )$$

where x is an original value, and x_{new} is the normalized value for the same feature.

In some embodiments, there may be two types of features: categorical and continuous. In some embodiments, continuous features may be transformed to categorical features.

In some embodiments, distributions of continuous features values may be tested, and some features may be identified as distributed skewed towards one direction. In some embodiments, transformation functions may be applied to transform the feature distribution into a normal distribution, in order to improve the performance of the prediction.

In some embodiments, after infrastructural system segmentation based on input features, the segment lengths may vary widely. Due to the aggregation function of summation during segmentation, the values of some features over the segments are proportional to segment lengths. In some embodiments, to avoid repeated consideration of the impact of segment length, feature scaling by segment length may applied to the related features. In this way, the density of some feature values by segment length may calculated. However, there are some segments with very small segment lengths. The density of the features for these short segments may not represent the correct characteristics due to the randomness of occurrence.

In some embodiments, feature selection may include automatically or manually selecting a subset of features from the set of original ones to optimize the model performance using defined criteria. With feature selection, features contributing most to the model performance may be selected. Irrelevant features may be discarded in the final model. Feature selection can also reduce the number of considered features and speed up the model training.

In some embodiments, a machine learning algorithm called LightGBM (Light Gradient Boosting Model) may be used for feature selection considering its fast-computational speed as well as an acceptable model performance based on the AUC. In feature selection, there are thousands of possible combinations of features. It is impossible to scan all possible combinations of features to search for the optimal subset of features. In some embodiments, this optimization-based feature selection method, forward searching, backward searching and simulated annealing techniques are used in steps:

Step 1. In forward searching, select one feature each time to be added into the combination in order to maximally improve AUC, until the AUC is not improved further.

Step 2. Use backward searching to select one feature to be removed from the combination of features obtained from step 1, in order to maximally improve AUC, until AUC is not improved further.

Step 3. After step 2, make multiple loops between step 1 and step 2 until the AUC is not improved further.

Step 4. Because forward searching and backward searching select the features greedily, it is possible to result in a local optimal combination of features for forward searching and backward searching. The simulated annealing algorithm makes the local optima stand out amidst the combination of features. In this step, record the current combination of features with local optima and the corresponding AUC. Then, add a pre-defined potential feature which is not in the current combination and then repeat steps 1 to 4 until the AUC cannot be improved further. The pre-defined potential feature is selected based on the feature performance in step 1.

Step 5. First, create the cross-term features based on the combination of features obtained from step 4. After creating the cross-term features, repeat steps 1 to 4 until obtaining the optimal combination of current features. Due to the computational complexity of step 5, cross-term development is only conducted one time. In the process, we use an indicator N to represent whether creation of cross-term features has been conducted or not. If N is equal to “False”, then create cross-term features and repeat steps 1 to 4. If N is equal to “True”, then the optimal combination of features has been obtained and the process is complete.

In some embodiments, the set of features may be input into a degradation machine learning model of the prediction system. The degradation machine learning model may receive the set of features and utilize the set of features to predict a condition of the asset components of each infrastructure asset (e.g., segment of asset components) over a predetermined period of time (e.g., in the next week, month, two months, three months, six months, year, or multiples thereof).

In some embodiments, the exemplary inventive computer-based systems/platforms, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, the degradation machine learning model may include an architecture based on, e.g., a Soft-Tile Coding Neural Network (STC-NN) having components for, e.g.: (a) Dataset preparation; (b) Input features; (c) Encoder: soft-tile-coding of outcome labels; (d) Model architecture; and (e) Decoder: probability transformation.

In some embodiments, in part (a), dataset preparation, an integrated dataset may be developed which include input features and outcome variables. The outcome variables are continuous lifetimes, which may have a large range. The lifetime may be exact lifetime or censored lifetime. In some embodiments, the exact lifetime is defined as the duration time from the starting observation time to the occurrence time of the event of interest, while censored lifetime is the duration from the starting time to the ending observation time if no event occurs. In some embodiments, input features may be categorical or continuous variables. In some embodiments, for categorical features, one-hot encoding is applied to transform categorical features into a binary vector, in which only one element is 1 and the summation of the vector is equal to 1.

In some embodiments, to improve computational efficiency and model convergence for continuous features, min-max scaling may be employed to rescale the continuous features in the range from zero to one. Scaling the values of different features on the same magnitude efficiently avoids neuron saturation when randomly initializing the neural network. In other words, without scaling features, the coefficients of the features with larger magnitude may be smaller. The coefficients of features with smaller magnitude may be larger.

In some embodiments, in original datasets, the outcome variables may be continuous lifetime values. In some embodiments, a special soft-tile-coding method may be used to transform the continuous outcome into a soft binary vector. Similar to a binary vector, the summation of a soft binary vector is equal to one. The difference is that the soft binary indicates that the feature vector not only consists of the values of 0 and 1, but also of some decimal values such as 1/n (n=2, 3, . . . ). We refer to this kind of soft binary vector as a soft-tile-encoded vector in some embodiments.

In some embodiments, after the encoding process of input features and outcome variables, a customized Neural Network with a SoftMax layer is utilized to learn the mapping between the input features and the encoded output labels. Specifically, the output of the SoftMax layer corresponds to the encoded output label using the soft-tile-coding technique. The customized Neural Network with its output related to a soft-tile-encoded vector may be named as the STC-NN model.

In some embodiments, a decoder process for the soft-tile-coding may be employed. The decoding process may be a method that transforms a soft-tile-encoded vector into its probability along its original continuous lifetime. Instead of obtaining one output, the STC-NN algorithm may obtain a probability distribution of degradation or failure of a particular infrastructure asset or asset component within the predetermined time period. In some embodiments, the present disclosure refers to the degradation or failure as an “event”. Such events may include one or more particular types of degradation or of failure of an infrastructure asset or asset component, or of any type of degradation or failure.

In some embodiments, tile-coding is a general tool used for function approximation. In some embodiments, the continuous lifetime is partitioned into multiple tiles. These multiple tiles may be used as multiple categories, and each category relates to a unique time range. In some embodiments, one partition of the lifetime is called one tiling. Generally, multiple overlapping tiles are used to describe one specific range of the lifetime. There is a finite number of tiles in a tiling. In each tiling, all tiles have the same length of time range, except for the last tile.

For a tile-coding with m tilings and each with n tiles, for each time moment T on the lifetime horizon, the encoded binary feature is denoted as F(T|m, n), and the element Fᵢⱼ(T) is described as:

$${F}_{ij} ( T ) = \{ \begin{matrix}1 , & T ∈ [ i Δ T - {d}_{j} , ( i + 1 ) Δ T - {d}_{j} ) \\ 0 , & otherwise\end{matrix} ; \qquad ( 1 - 5 )$$

$$i = 1 , 2 , … , n ; j = 1 , 2 , … , m$$

where ΔT is the length of the time range of each tile, and dⱼ is the initial offset of each tiling.

In some embodiments, the tile-coded vector may be defined as follows:
Definition 1: F(T|m, n)={Fᵢⱼ(T)| i=1, 2, . . . , n; j=1, 2, . . . , m} is called a soft-tile-encoded vector with parameter m and n if it satisfies the conditions (a) Fᵢⱼ(T)∈{0, 1} and (b) Σᵢ Fᵢⱼ(T)=1.

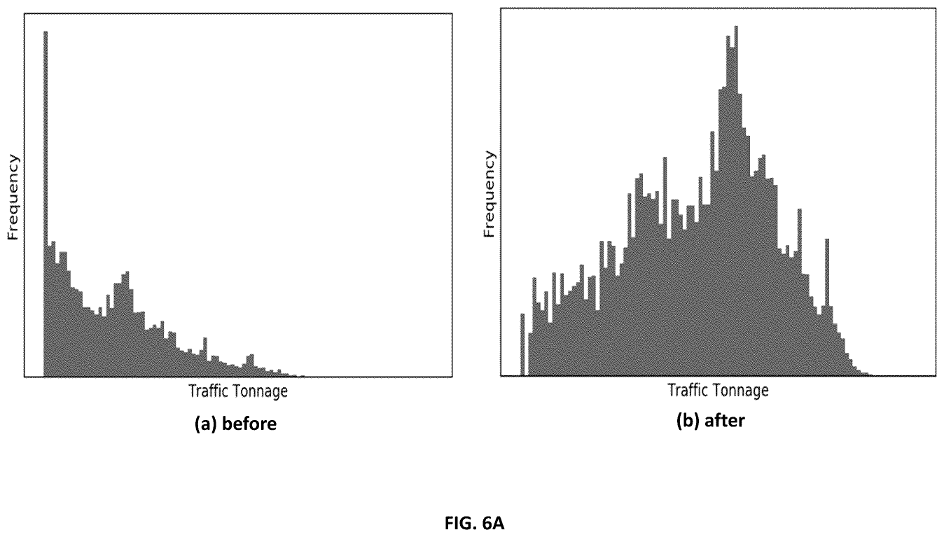

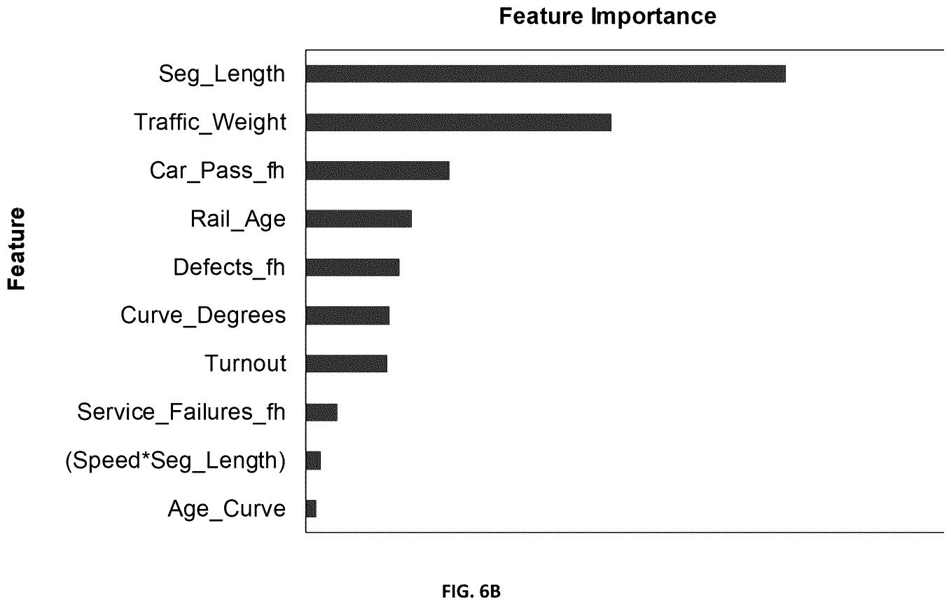

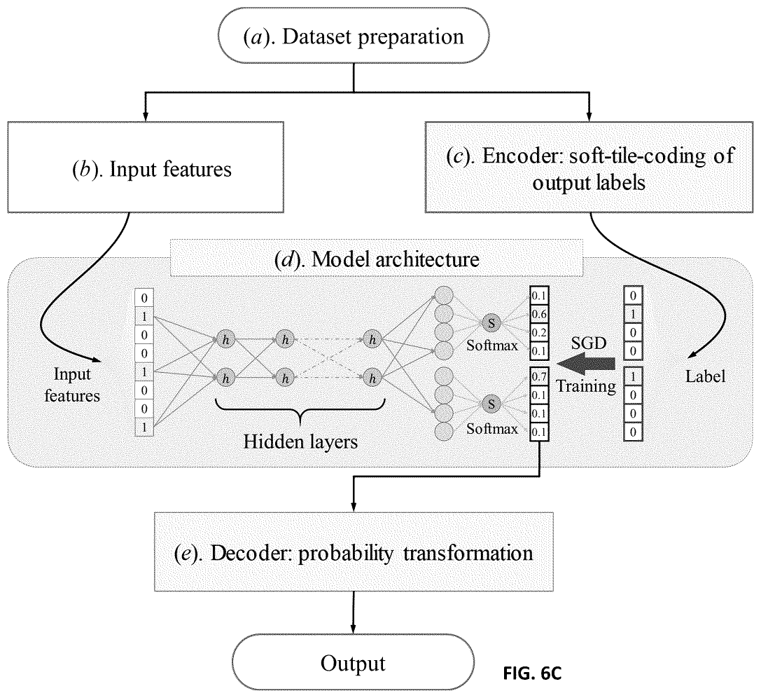

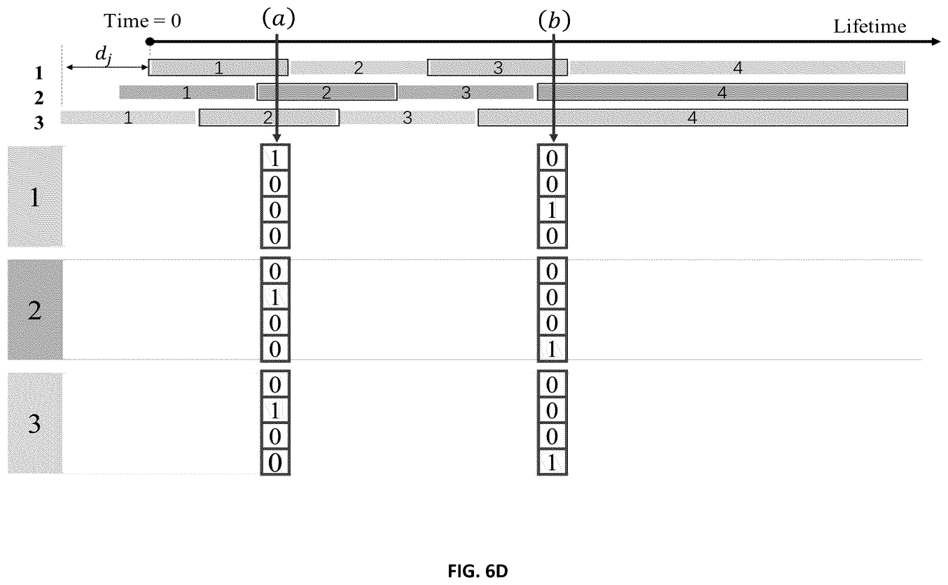

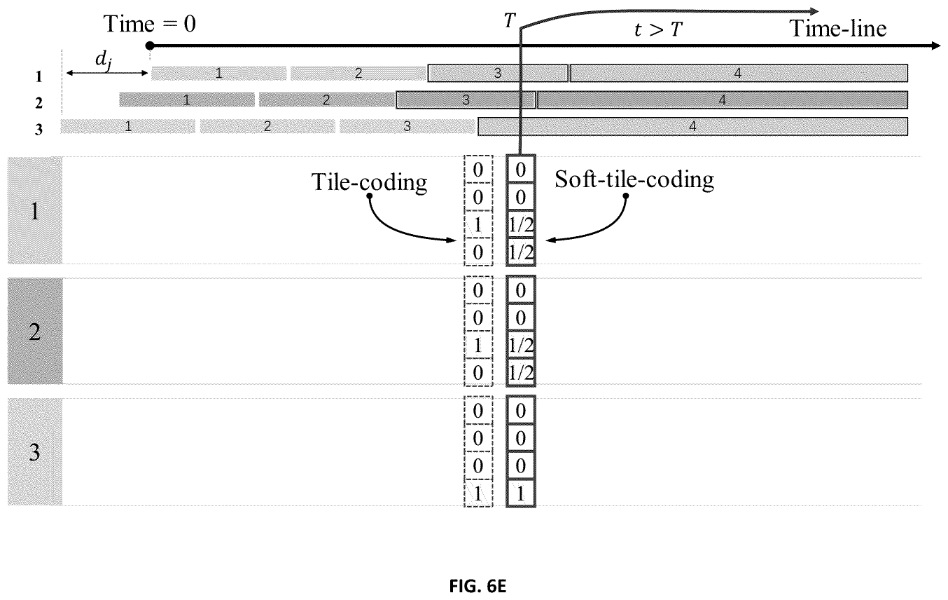

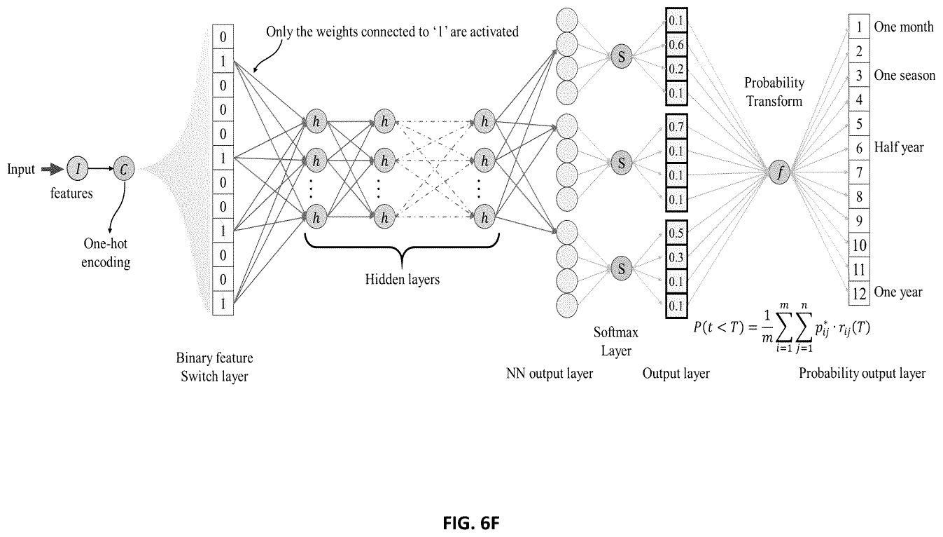

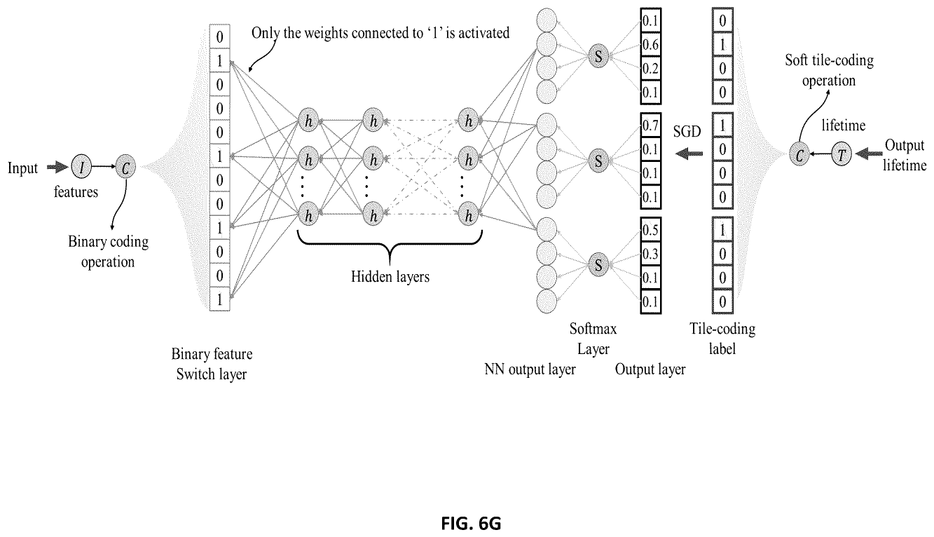

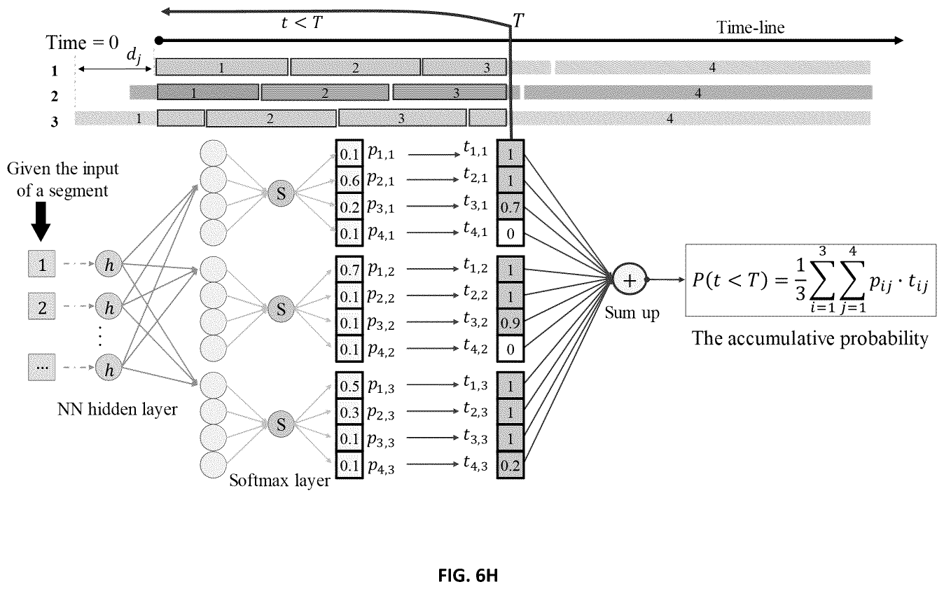

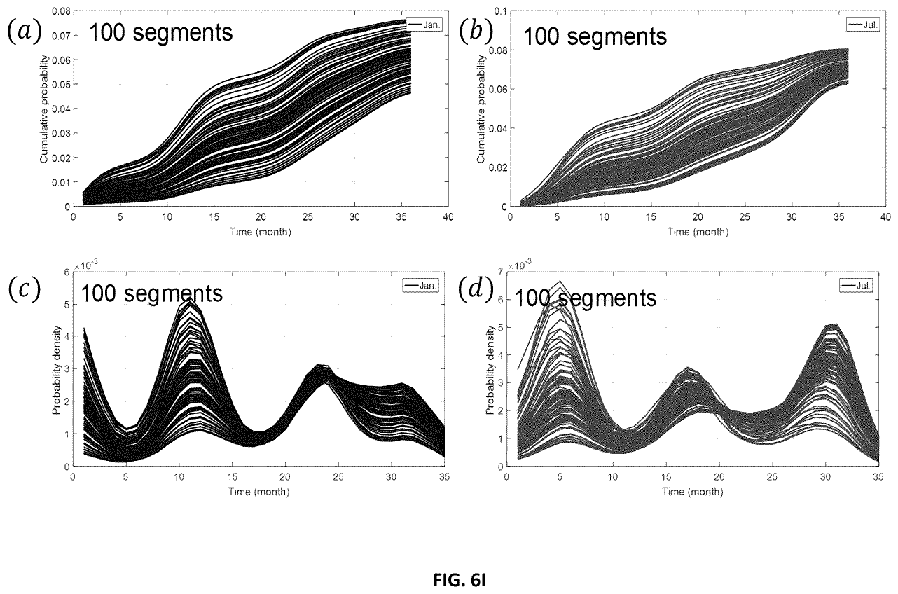

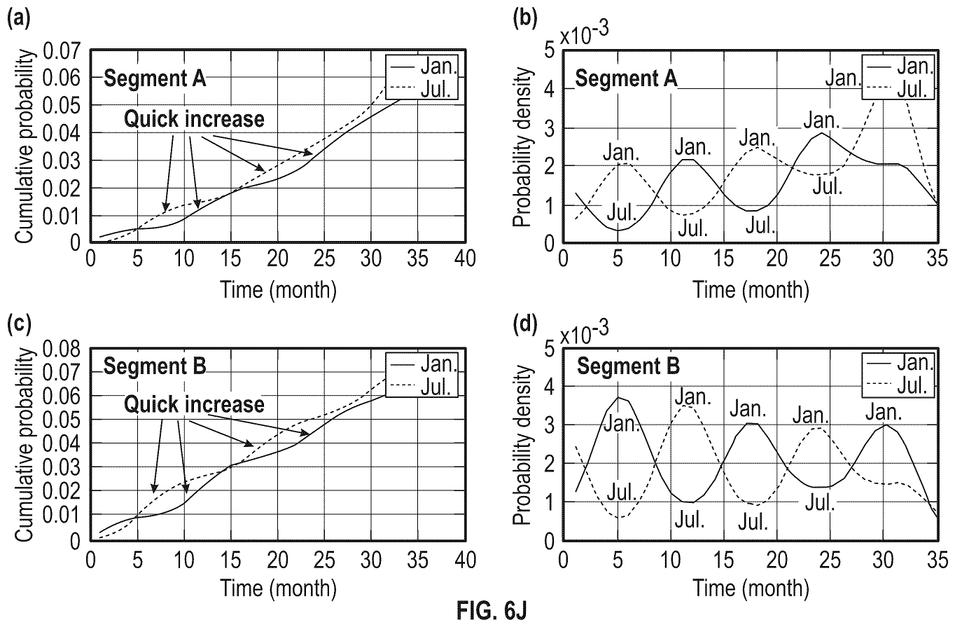

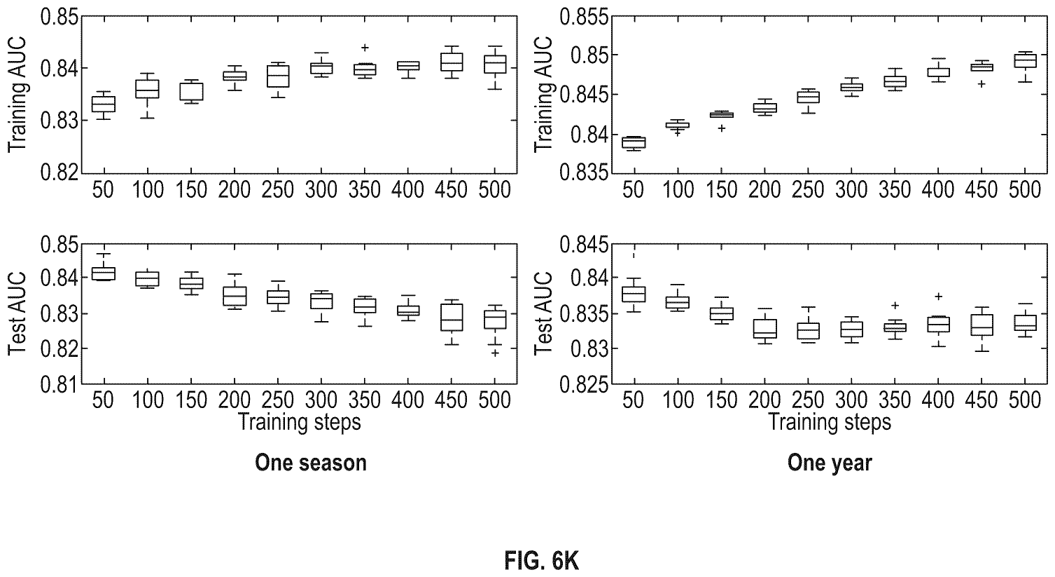

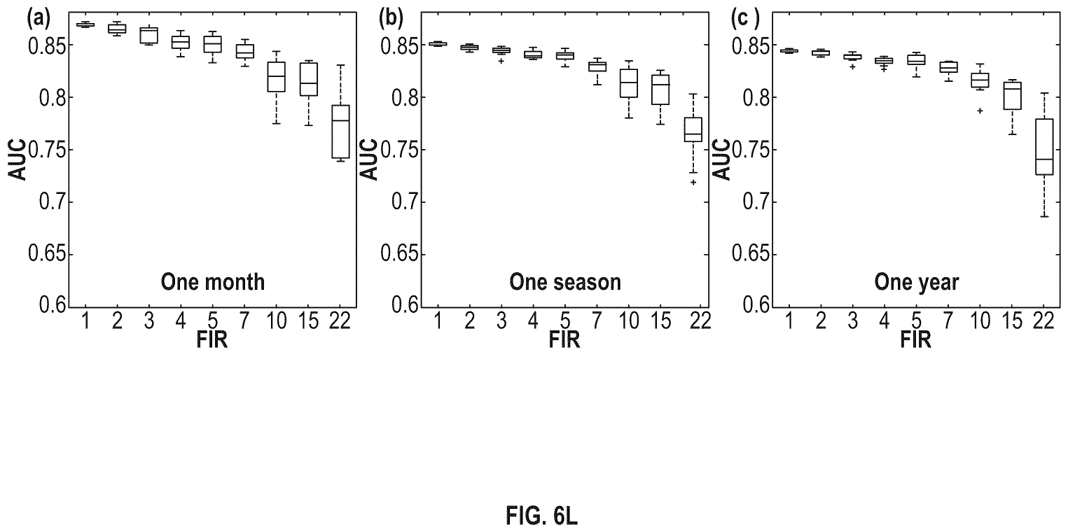

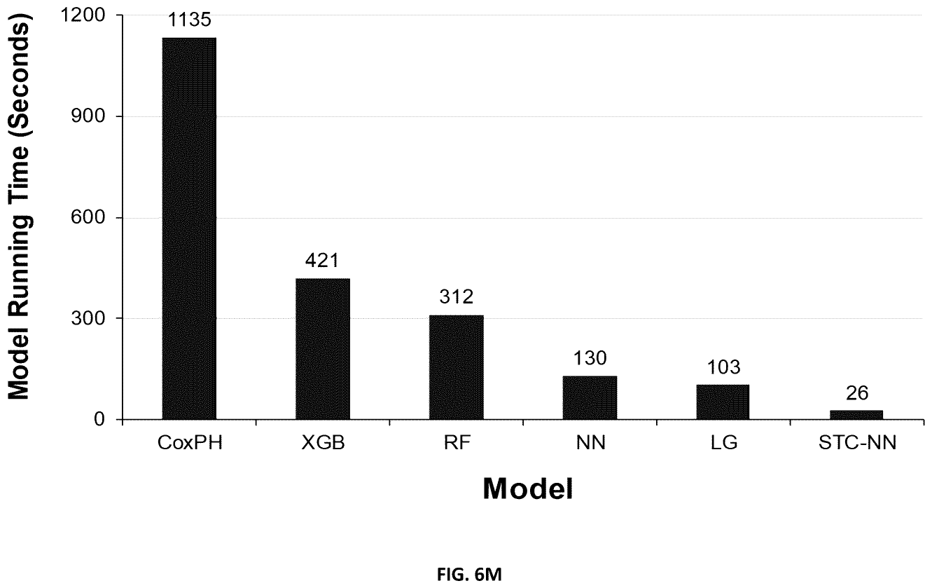

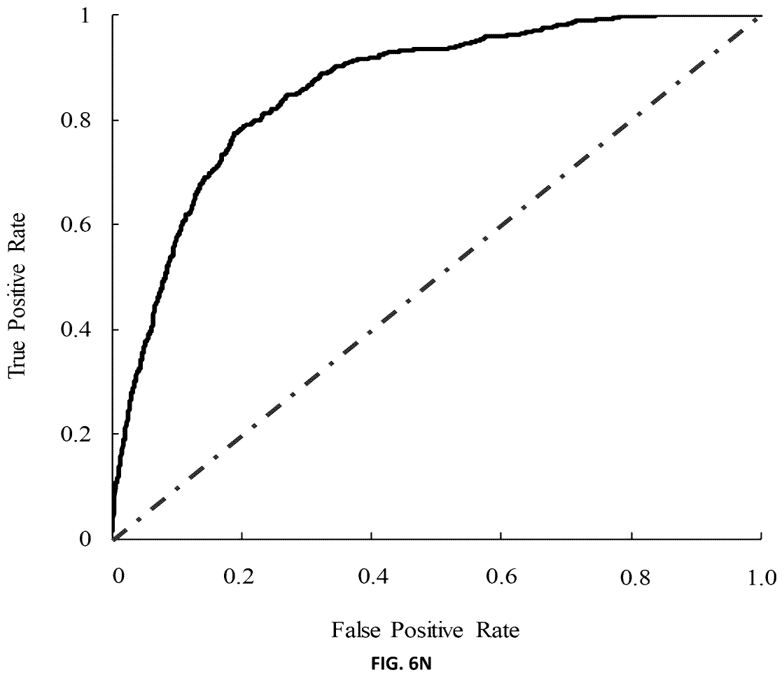

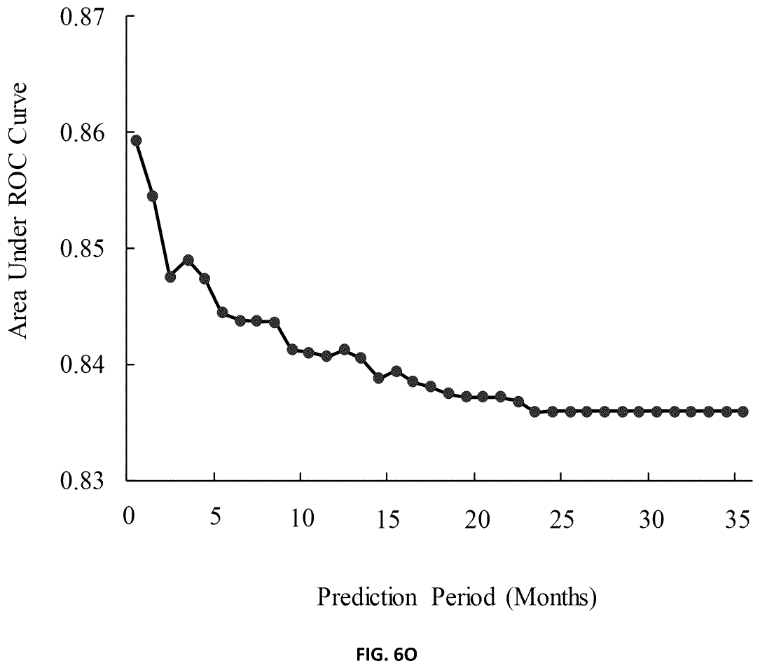

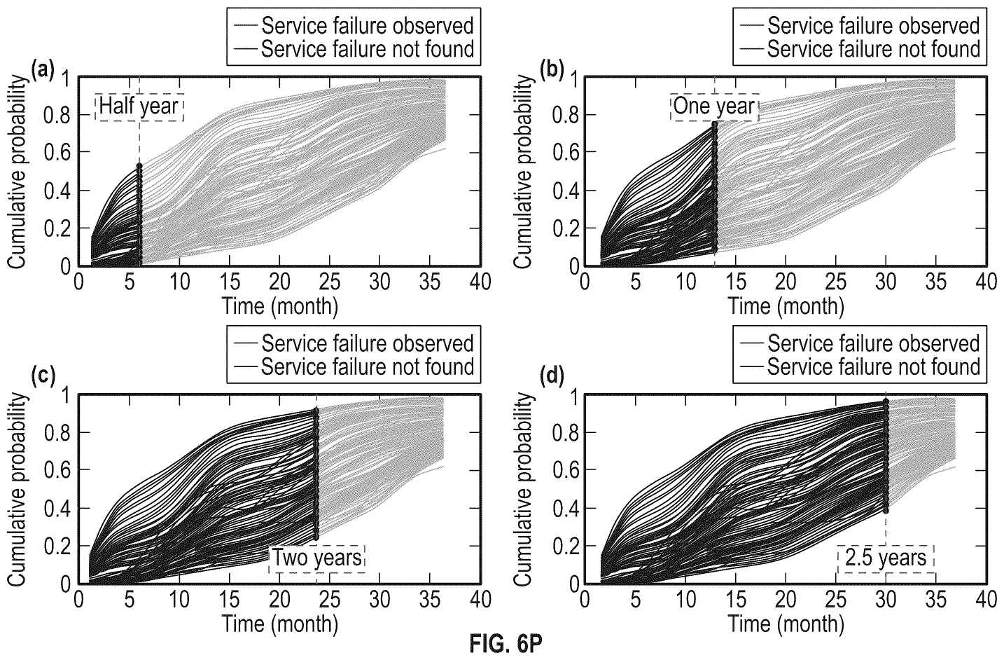

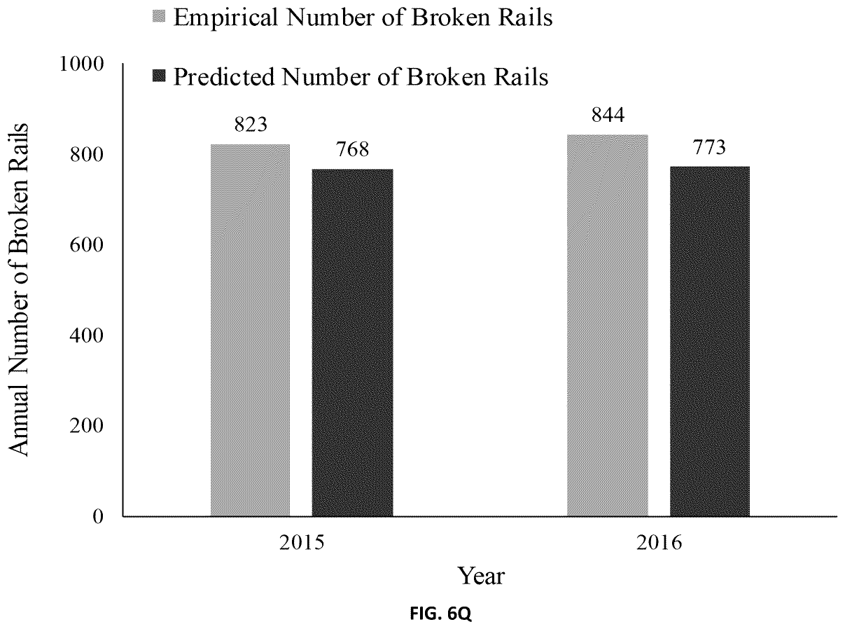

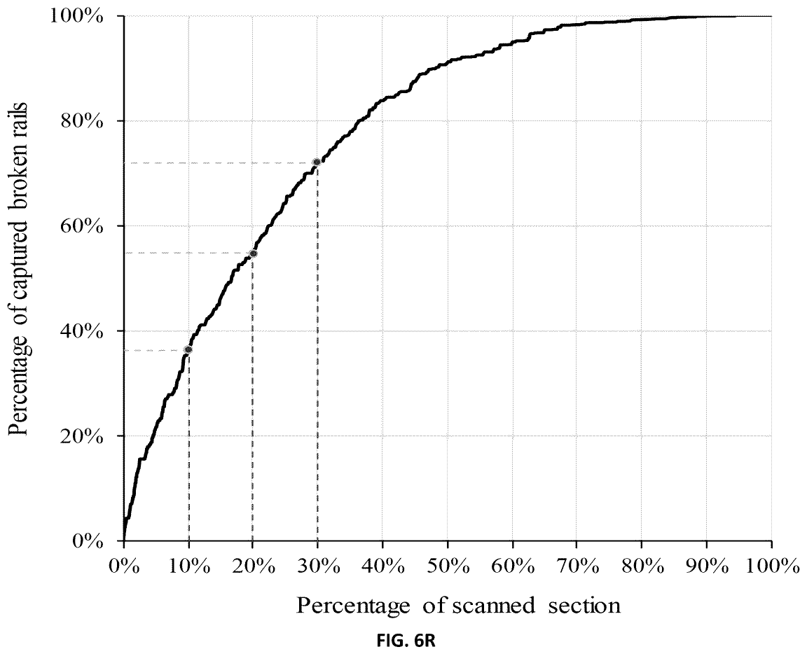

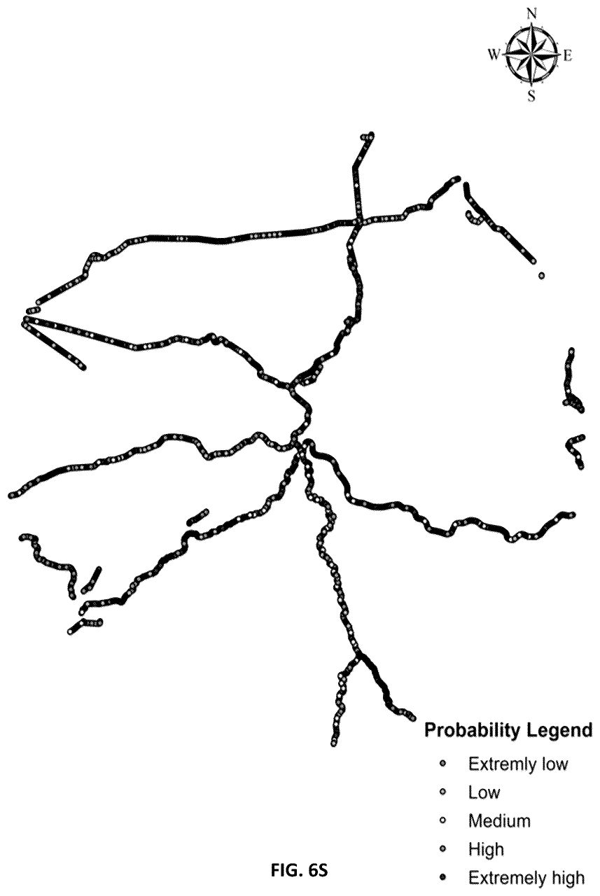

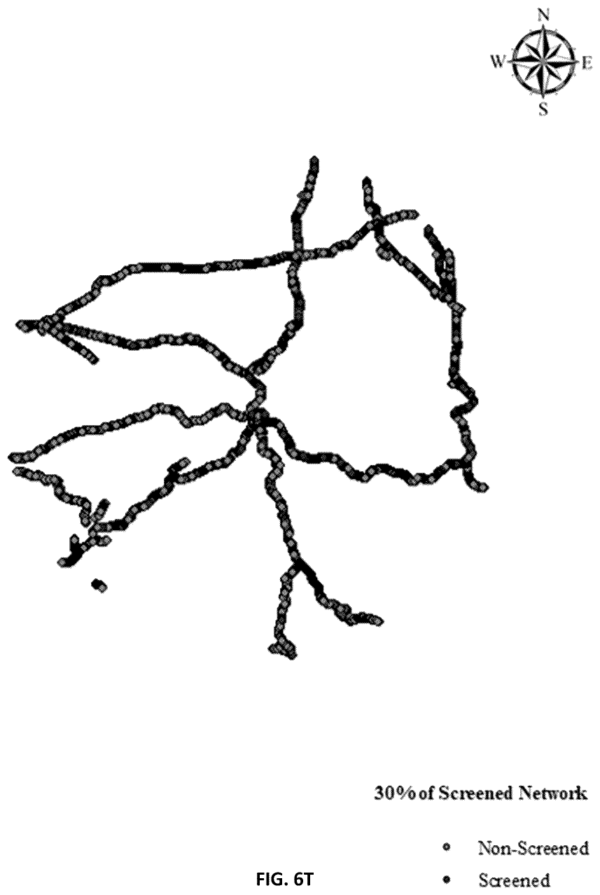

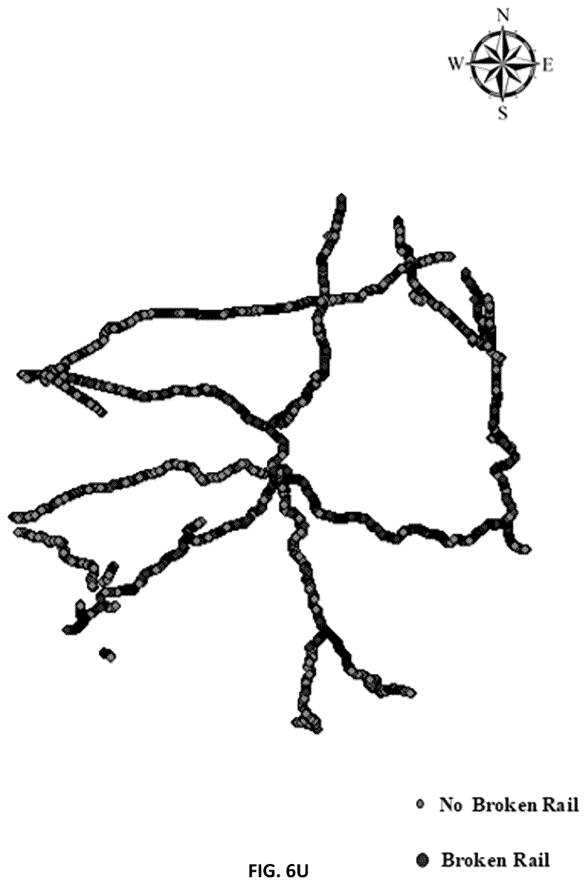

FIG. 6D illustrates two examples for tile-coding of two lifetime values at time (a) and (b) with three tilings (m=3) which include four tiles (n=4). It is found that time (a) is located in the tile-1 for tiling-1, and in the tile-2 for both tiling-2 and tiling-3. The encoded vector of time (a) is given by (1,0,0,0 | 0,1,0,0 |0,1,0,0)^{T}. Similarly, for time (b) we get (0,0,1,0 | 0,1,0,1 |0,0,0,1)^{T}.

In some embodiments, a specific lifetime value may be encoded into a binary vector using tile-coding if an event occurs. However, in some situations, no events occur during the observation time and the event of interest is assumed to happen in the future. In this case, the censored lifetime may be obtained, and the exact lifetime may be unavailable. The other types of tile-coding functions may not be capable of encoding this censored data. To address this issue, the soft-tile-coding function is implemented.

In some embodiments, the soft-tile-coding function is applied to transform the continuous lifetime range into a soft-binary vector, which is a vector whose value is in range [0, 1]. When the event of interest is not observed before the end of observation, the lifetime value is censored, and exact lifetime is not observed. Although the exact lifetime for the event may be unknown, the event of interest does not occur within the observation time period. Similarly, whether the event may happen in the future is unknown, beginning at the current ending observation time. By using soft-tile-coding, this information can be leveraged to build a model and achieve better prediction performance. In some embodiments, the mathematical process is as follows:

For a soft-tile-coding with m tilings, each with n tiles, given a time range T∈[T₀, ∞) on the timeline, the encoded binary feature is denoted as S(T|m, n), and the element Sᵢⱼ(T) is described as:

$${S}_{ij} ( T ) = \{ \begin{matrix}1 / {k}_{j} , & i \geq n - {k}_{j} + 1 \\ 0 , & otherwise\end{matrix} ; \qquad ( 1 - 6 )$$

$$i = 1 , 2 , … , n ; j = 1 , 2 , … , m$$

Where:

$${k}_{j} = {argmax}_{j} {F}_{j} ( {T}_{0} ) \qquad ( 1 - 7 )$$

and Fⱼ(T₀) is the encoded binary feature vector of the jth tiling using tile-coding.

In general, we define the tile-coded vector as follows:
Definition 2: S(T|m, n)={Sᵢⱼ(T) | i=1, 2, . . . , n; j=1, 2, . . . , m} is called a tile-encoded vector with parameter m and n if it satisfies the conditions (a) Sᵢⱼ(T)∈[0, 1] and (b) Σᵢ Sᵢⱼ(T)=1.

One example of soft-tile-coding with three tilings (m=3), each of which include four tiles (n=4), is illustrated in FIG. 6E. It is found that the time T is located in the tile-3, tile-3, and tile-4 for tiling-1, tiling-2, and tiling-3, respectively. The soft-tile-encoded vector is given as (0, 0, 0. 5, 0. 5 | 0, 0, 0. 5, 0. 5 | 0, 0, 0, 1)^{T}. In comparison, the tile-encoded vector is (0, 0, 1, 0 |0, 0, 1, 0 |0, 0, 0, 1)^{T}.

In some embodiments, as presented in FIG. 6F, the forward architecture of STC-NN model is mainly based on a Neural Network. There may be multiple processes to get from the input features to the output probability of event occurrence over time. In some embodiments, there may be three main parts of the model: (1) a neural network, (2) a SoftMax layer with multiple SoftMax functions, and (3) a decoder: probability transformation. The input of the model is transformed into a vector with values in range [0, 1]. The input vector is denoted as g={gᵢ∈[0, 1]|i=1, 2, . . . M}. The hidden layers are densely connected with a nonlinear activation function specified by the hyperbolic tangent, tanh(•).

There are m×n output neurons of the neural network, which connect to a SoftMax layer with m SoftMax functions. Each SoftMax function is bound with n neurons. The mapping from the input g to the output of the SoftMax layer can be written as p(g|θ), where θ is the parameter of the NN. According to Definition 2, p(g|θ) is a soft-tile-encoded vector with parameter m and n.

In some embodiments, the soft-tile-encoded vector p(g|θ) is an intermediate result and can be transformed into probability distribution by a decoder. In some embodiments, the probability distribution represents a probability of one or more types of degradation or failure (events) occurring for a particular infrastructure asset or asset component within a predetermined period of time. The greater the probability of the event occurring within the predetermined period of time, the greater the degradation. Accordingly, the predicted probability distribution represents the degradation of the infrastructure asset and asset components based on the probability of a particular type of degradation or failure occurring.

In some embodiments, the type of event can be correlated to a risk of failure, a risk of resulting failures (e.g., failures caused in other components, systems and devices as a result of the deteriorated or failed infrastructure asset or asset component), a financial impact of the degradation or failure (e.g., cost to repair, cost of material and component loss, cost of resulting failures, etc.). As a result, the probability distribution may be correlated to a risk level and a financial impact within any given time period, including the predetermined time period.

In some embodiments, the backward architecture of the STC-NN model for training is presented in FIG. 6G. Given a feature set as input, we can obtain a soft-tile-encoded vector after the SoftMax layer. Instead of going further for probability transformation, in the training process the soft-tile-encoded vector is used as the final output and a loss function can be defined as Eq. (6-5):

$$ℒ ( g , T \vert θ , m , n ) = \frac{1}{2} {‖ p ( g \vert θ ) - F ( T \vert m , n ) ‖}^{2} \qquad ( 1 - 8 )$$

where, p(g|θ) is the output of the STC-NN model, given input g with parameters θ. F(T|m, n) is a tile-encoded vector if the feature set g relates to an observed lifetime T; otherwise, F(T|m, n)=S(T|m, n), which is a soft-tile-encoded vector if the feature set g relates to an unknown lifetime during the observation period with length T.

Given a training dataset with batch size of N, denoted as {G={g₁, g₂, . . . , g_{N}},T={T₁, T₂, . . . , T_{N}}}, the overall loss function can be written as:

$$ℒ ( G , T \vert θ , m , n ) = \frac{1}{2} {\sum }_{i = 1}^{N} {‖ p ( {g}_{i} \vert θ ) - F ( {T}_{i} \vert m , n ) ‖}^{2} \qquad ( 1 - 9 )$$

In some embodiments, the training process is given as an optimization problem—finding the optimal parameters θ*, such that the loss function [symbol] (G, T|θ, m, n) is minimized, which is written as Eq. (6-7).

$${θ}^{*} = {argmin}_{θ} ℒ ( G , T \vert θ , m , n ) \qquad ( 1 - 10 )$$

In some embodiments, the optimal solution of θ* can be estimated using the stochastic gradient descent (SGD) algorithm, which is achieved by randomly picking one record {gᵢ, Tᵢ} from the dataset, and following the updated process using Eq. (6-8):

$$θ ← θ - α \cdot \frac{\partial p ( {g}_{i} \vert θ )}{\partial θ} \cdot ( p ( {g}_{i} \vert θ ) - F ( {T}_{i} \vert m , n ) ) ; \qquad ( 1 - 11 )$$

$$i = 1 , 2 , … , N$$

where α is the learning rate and ∂p(gᵢ|θ)/∂θ is the gradient (first-order partial derivative) of the output soft-tile-encoded vector to parameter θ. In some embodiments, the calculation of the gradients ∂p(gᵢ|θ)/∂θ is based on the chain rule from the output layer backward to the input layer, which is known as the error back propagation. In some embodiments, a mini-batch gradient descent algorithm is employed instead of a pure SGD algorithm to balance the computation time and convergence rate, however any suitable gradient descent algorithm may be employed.

In some embodiments, different from the training algorithms commonly used for typical NNs, the training algorithm of STC-NN is customized to deal with the skewed distribution in the database. For a rare event, the dataset recording it can be highly imbalanced (i.e. more non-observed events than the observed events of interest due to their rarity).
Definition 3: Imbalance Ratio (IR) is defined as the ratio of the number of records without event occurrence to the number of records with events.

In some embodiments, to enhance the performance of the STC-NN model, instead of feeding the data randomly, a constraint may be utilized for fed model data (training data) in the training process. The definition of Feeding Imbalance Ratio (FIR) is described below.
Definition 4: Feeding Imbalance Ratio (FIR) is defined as the IR of each mini-batch of data to be fed into the model during the training process.

For example, if FIR=1, it means that we feed each mini-batch of data with half including events and the other half without events. When FIR=22, the ratio between non-event and event in the dataset fed into the model is the same as the original dataset. If the FIR is too large, the dataset fed into the model may be imbalanced, and it may be hard to learn the feature combination related to the event occurrence. However, if the FIR is too small, the features related to the event are well learned by the model, but it may lead to a problem of over-estimated probability of the event occurrence. The pseudo code of the training algorithm is presented as follows:

Input:

| | |
|---|---|
| [symbol] | FIR, batch_size, n_epoch, m, n, α |
| [symbol] | Training dataset: (G, T); |
| [symbol] | The numbers of layers and neurons of neural network; |

Initialize:

| | |
|---|---|
| [symbol] | Initialize a neural network p(* \|θ); |
| [symbol] | Split the (G, T) into (G, T)⁺ and (G, T)⁻ according to asset component failure occurrence; |

Main:
For_in range (n_epoch), do

```
(G, T)⁺ = (G, T)⁺.shuffle( )
(G, T)⁻ = (G, T)⁻.shuffle( )
For_in range (round(size((G, T)⁺)/batch_size)), do
  (G, T)ᵢ⁺ = (G, T)⁺.next_batch(batch_size)
  (G, T)ᵢ⁻ = (G, T)⁻.next_batch( FIR * batch_size)
  Fᵢ⁺ = tile_coding(Tᵢ⁺)
  Sᵢ⁻ = soft_tile_coding(Tᵢ⁻)
  (G, F)ᵢ = shuffle(concat(Gᵢ⁺, Gᵢ⁻), concat(Fᵢ⁺, Sᵢ⁻))
  Update the parameter θ of p(* |θ) given mini-batch (G, F)ᵢ.
End For
```

End For
Output: The neural network p(* |θ).
Note:
all superscript + and − indicate records with and without asset component failure, respectively.

In some embodiments, the decoder of soft-tile-coding may be used to transform a soft-tile-encoded vector into a probability distribution with respect to lifetime. Given the input of a feature set g, soft-tile-encoded output p(g|θ)={pᵢⱼ|=1, . . . n; j=1, . . . m} may be obtained through the forward computation of the STC-NN model. Since p(g|θ) is an encoded vector, a decoder-like operation may be used to transform it into values with practical meanings. In some embodiments, the decoder of soft-tile-coding may be defined as follows:
Definition 5: Soft-tile-coding decoder. Given a lifetime value T∈[0, ∞), and a soft-tile-encoded vector p={pᵢⱼ|=1, . . . n; j=1, . . . m}, the occurrence probability P(t<T) may be estimated as:

$$P ( t < T ) = \frac{1}{m} {\sum }_{i = 1}^{m} {\sum }_{j = 1}^{n} {p}_{ij}^{*} \cdot {r}_{ij} ( T ) \qquad ( 1 - 12 )$$

where, m and n are the number of tilings and tiles respectively; p*ᵢⱼ and rᵢⱼ(T) are the probability density and effective coverage ratio of the j-th tile in the i-th tiling, respectively. The value of p*ᵢⱼ can be calculated using pᵢⱼ divided by the length of time range of the corresponding tile. Note that there is no meaning for time t<0, so the length of the first tile of each tiling should be reduced according to the initial offset dⱼ, and we get p*ᵢⱼ as follows.

$${p}_{ij}^{*} = \{ \begin{matrix}{p}_{ij} / Δ T , & i > 1 \\ {p}_{ij} / ( Δ T - {d}_{j} ) , & i = 1\end{matrix} \qquad ( 1 - 13 )$$

$${p}_{ij}^{*} = \{ \begin{matrix}{p}_{ij} / Δ T , & i > 1 \\ {p}_{ij} / ( Δ T - {d}_{j} ) , & i = 1\end{matrix} \qquad ( 1 - 13 )$$

In some embodiments, the effective coverage ratio rᵢⱼ(T) can be calculated according to Eq. (6-11):

$${r}_{ij} ( T ) = \{ \begin{matrix}{t}_{ij} ( T ) / Δ T , & i > 1 & \\ {t}_{ij} ( T ) / ( Δ T - {d}_{j} ) , & i = 1 & \end{matrix} \qquad ( 1 - 14 )$$

where, tᵢⱼ(T)= [symbol] [iΔT+dⱼ, (i+1)ΔT+dⱼ)∩[0, T]] [symbol] is the length of intersection between time range of the jth tile in the i^{th} tiling and the range t∈[0, T]. The operator [symbol] • [symbol] is used to obtain the length of time range.

In some embodiments, according to Definitions 2 and 5, it may be verified that P(t=0)=0 and P(t<T|T→∞)=1. And P(t<T) can be interpreted as the accumulative probability of event occurrence within the lifetime T. An example of the soft-tile-coding decoder is given in FIG. 6H. The vector p is the output of the STC-NN model and the red rectangles on the tiles are tᵢⱼ(T).

In some embodiments, there is an upper time limit when the essential parameter n and ΔT are determined. In some embodiments, Definition 6 may specify the total predictable time range of the STC-NN model, as follows.
Definition 6: Total Predictable Time Range (TPTR) is defined as the time period between defined starting observation time and ending observation time.

In some embodiments, the TPTR of the STC-NN model is defined as TPTR=(n−1)ΔT, where n is the number of tiles in each tiling and ΔT is the length of each tile. In some embodiments, n tiles in each tiling cover the lifetime range between starting observation time and maximum failure time among all the research data. Normally, the failure has not been observed till the ending observation time which is called as censored data in survival analysis. Therefore, the maximum failure time among all the data should be infinite. The first n−1 tiles are set with a fixed and finite time length of ΔT which covers the observation period. The last tile covers the time period t>(n−1)ΔT which is beyond the observation. No additional information about the failure time is provided by the last tile for the prediction. In some embodiments, therefore, the effective total predictable time range (TPTR) equals (n−1)ΔT.

While the above describes the STC-NN, other machine learning models may be employed for the degradation machine learning model. For example, the degradation machine learning model may include, e.g., extreme gradient boosting algorithm, a random forest algorithm, a light gradient boosting machine algorithm, a logistic regression algorithm, a Cox proportional hazards regression model algorithm, an artificial neural network, a support vector machine, an autoencoder, or other machine learning model algorithm, some of which are described in more detail in the following examples.

In some embodiments, the prediction system may produce a prediction for asset component and/or infrastructure asset failure within the predetermined time. The prediction of the probability distribution may include, e.g., a probability or a classification indicating the probability of an event of a given type occurring within the predetermined time. The greater the probability of the event occurring within the predetermined period of time, the greater the condition. Accordingly, the predicted probability distribution represents the condition of the infrastructure asset and asset components based on the probability of a particular type of degradation or failure occurring.

In some embodiments, as described above, the type of event can be correlated to a risk of failure, a risk of resulting failures (e.g., failures caused in other components, systems and devices as a result of the deteriorated or failed infrastructure asset or asset component), a financial impact of the degradation or failure (e.g., cost to repair, cost of material and component loss, cost of resulting failures, etc.). For example, for rail lines, a probability distribution including the probability of a horizontal split head represents a condition, e.g., with respect to preventative inspection and/or maintenance to mitigate causes of a horizontal split head. Similarly, the probability of an asset component (e.g., a pipe, a rail, a road surface, etc.) wearing through is a result of lifetime, use and the presence or lack of inspection and/or maintenance. Thus, the probability of the asset component wearing through represents a degree to which the asset component has experienced, degradation, deterioration or other disrepair due to the lifetime, use and inspection and/or maintenance level of that asset component. Accordingly, the probability distribution indicates the probability of events of particular types occurring within the predetermined time, which represents the condition of the infrastructure asset and/or asset components.

As a result, in some embodiments, the prediction system may generate recommended asset management decisions, such as, e.g., a prioritization of asset components to direct inspection and/or maintenance towards, a recommendation to pursue inspection and/or maintenance for a particular asset component of infrastructure asset, a recommendation to repair or replace one or more asset components, or other asset management decision.

In some embodiments, the prediction system may generate a graphical user interface to depict the location of an asset component or an infrastructure asset in the infrastructural system for which degradation is predicted. In some embodiments, the graphical user interface may represent the predicted degradation using, e.g., a color-coded map of the infrastructural system where specified colors (e.g., red or other suitable color) may indicate the predicted degradation within the predetermined time and/or a likelihood of failure based on the degradation. In some embodiments, the representation may be a list or table labelling asset components and/or infrastructure assets according to location with the associated predicted degree of degradation and/or a likelihood of failure. Other representations are also contemplated.

In some embodiments, the prediction system may render the graphical user interface on a display of a user's computing device, such as, e.g., a desktop computer, laptop computer, mobile computing device (e.g., smartphone, tablet, smartwatch, wearable, etc.).

### Example—Broken Rail-Caused Derailment Prediction

Broken rails are the leading cause of freight-train derailments in the United States. Some embodiments of the present disclosure include a methodological framework for predicting the risk of broken rail-caused derailment via Artificial Intelligence (AI) using network-level track characteristics, inspection and/or maintenance activities, traffic and operation, as well as rail and track inspection results. Embodiments of the present disclosure advanced the state-of-the-art research in the following areas:

Development of a novel machine learning methodology to predict the spatial-temporal probability of broken rail occurrence for any given time horizon. One example of an embodiment of this machine learning methodology includes a customized Soft Tile Coding based Neural Network model (STC-NN) that shows superior performance over several other embodiments of machine learning algorithms in terms of solution quality, computational efficiency, and modeling flexibility.

In some embodiments, an analysis of the relationship between the probability of broken rail-caused derailment and the probability of broken rail occurrence is performed. In some embodiments, new analyses are performed to understand how the probability of broken rail-caused derailment may vary with infrastructure characteristics, signal types, weather, and other factors.

In some embodiments, development of an Integrated Infrastructure Degradation Risk Model for predicting time-specific and location-specific broken rail-caused derailment risk on the network level. Predicting and identifying “high-risk” locations can ultimately lead to safety improvement and inspection and/or maintenance cost saving.

In some embodiments, a STC-NN algorithm can predict broken rail risk for any time period (from 1 month to 2 years), with better performance for short-term prediction (e.g. one month or less) than for long-term prediction (e.g., one year or greater). The algorithm slightly outperformed alternative widely used machine learning algorithms, such as Extreme Gradient Boosting Algorithm (XGBoost), Logistic Regression, and Random Forests, and may be also much more flexible. The model may be able to identify over 71% of broken rails (weighted by segment length) by performing a risk-informed screening of 30% of network mileage.

In some embodiments, infrastructure network segmentation is performed for improved prediction accuracy. In some embodiments, a dynamic segmentation scheme is implemented that represents a significant improvement over the fixed-length segmentation scheme.

For example, in broken rail-caused derailment, segment length, traffic tonnage, number of rail car passes, rail weight, rail age, track curvature, presence of turnout, and presence of historical rail defects may be found to be among influencing factors for broken rail occurrence. In some embodiments, signaled track in the cold season has the lowest ratio of broken rail-caused derailments to broken rails, while non-signaled track in the warm weather has the highest. Moreover, lower FRA track classes (e.g., Class 1, Class 2) have higher ratio of broken rail-caused derailments to broken rails, compared with higher track classes Class 3, Class 4, and Class 5. A longer, heavier train traveling at a higher speed is associated with more cars derailed per broken rail-caused derailment.

### Data Description and Preparation

In some embodiments, to build and train a machine learning algorithm for broken rail-caused derailments, data is collected from two sources: the FRA accident database and enterprise-level “big data” from one Class I freight railroad. The broken-rail derailment data comes from the FRA accident database, which records the time, location, severity, consequence, and contributing factors of each train accident. Using this database, broken-rail-caused freight train derailment data on the main tracks of the studied Class I railroad may be obtained for analyzing the relationship between broken rail and broken-rail-caused derailments, as well as broken-rail derailment severity. The data provided by the railroad company includes: 1) traffic data; 2) rail testing and track geometry inspection data; 3) inspection and/or maintenance activity data; and 4) track layout data (Table 3.1).

TABLE 3.1
Summary of Railroad Provided Data

| Dataset | Description |
|---|---|
| Rail Service Failure Data | Broken rail data from 2011 to 2016 |
| Rail Defect Data | Detected rail defect data from 2011 to 2016 |
| Track Geometry Exception | Detected track geometry exception data from 2011 to |
| Data | 2016 |
| VTI Exception Data | Vehicle-track interaction exception data from 2012 to |
| | 2016 |
| Monthly Tonnage Data | Gross monthly tonnage and car pass data from 2011 to |
| | 2016 |
| Grinding Data | Grinding pass data from 2011 to 2016 |
| Ballast Cleaning Data | Ballast cleaning data from 2011 to 2016 |
| Track Type Data | Single track and multiple track data |
| Rail Data | Rail laid year, new rail versus re-laid rail, and rail |
| | weight data |
| Track Chart | Track profile and maximum allowed speed |
| Curvature Data | Track curvature degree and length |
| Grade Data | Track grade data |
| Turnout Data | Location of turnouts |
| Signal Data | Location and type of rail traffic signal |
| Network GIS Data | Geographic information system data for the whole |
| | network |

### Database Description

In some embodiments, a track file database specifies the starting and ending milepost by prefix and track number, among other track specifications. The track file database is used as a reference database to overlay all other databases (Table 3.2).

TABLE 3.2
Track File Format

| | | | |
|---|---|---|---|
| | Begin Engineer | End Engineer | |
| Prefix | Milepost | Milepost | Track Type |

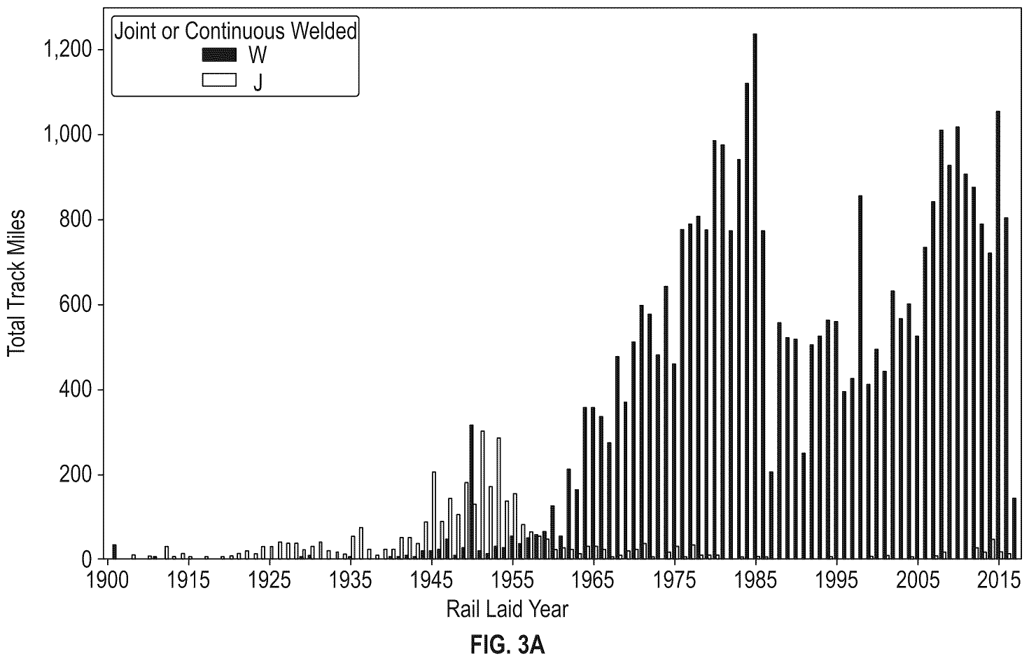

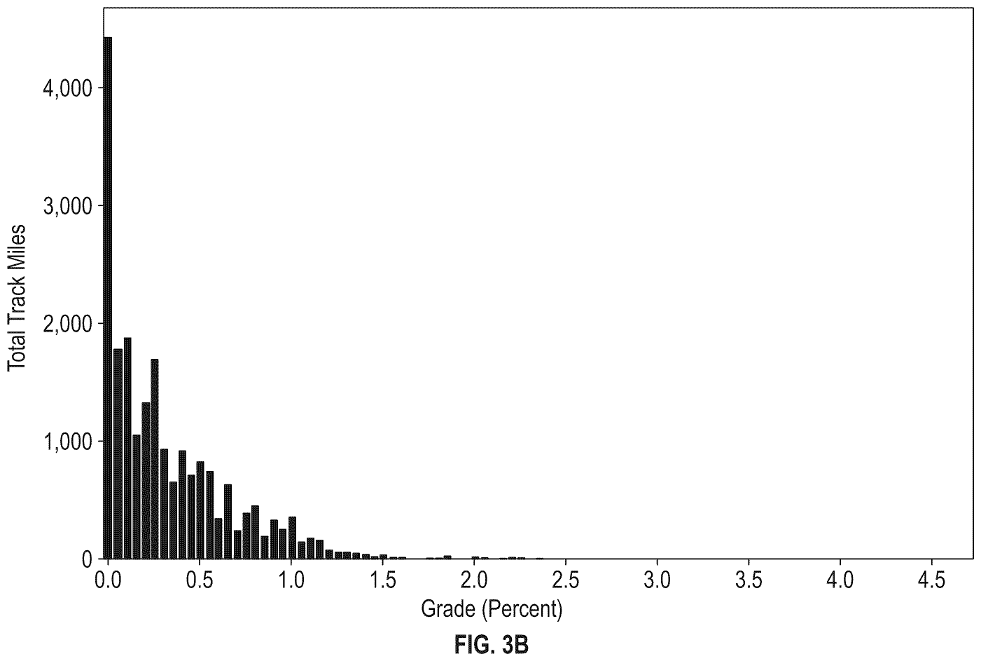

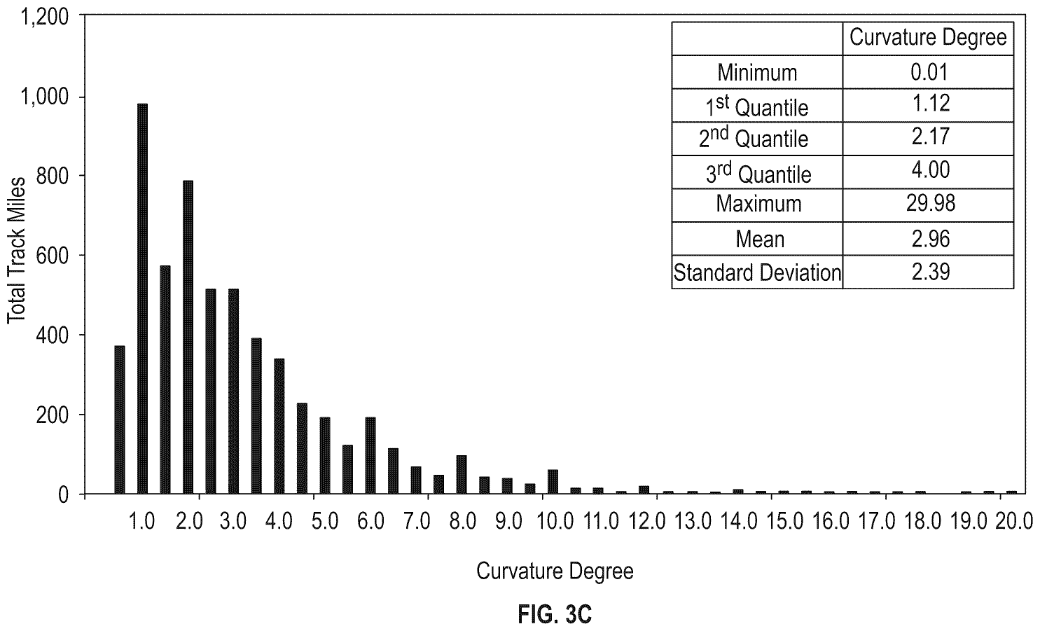

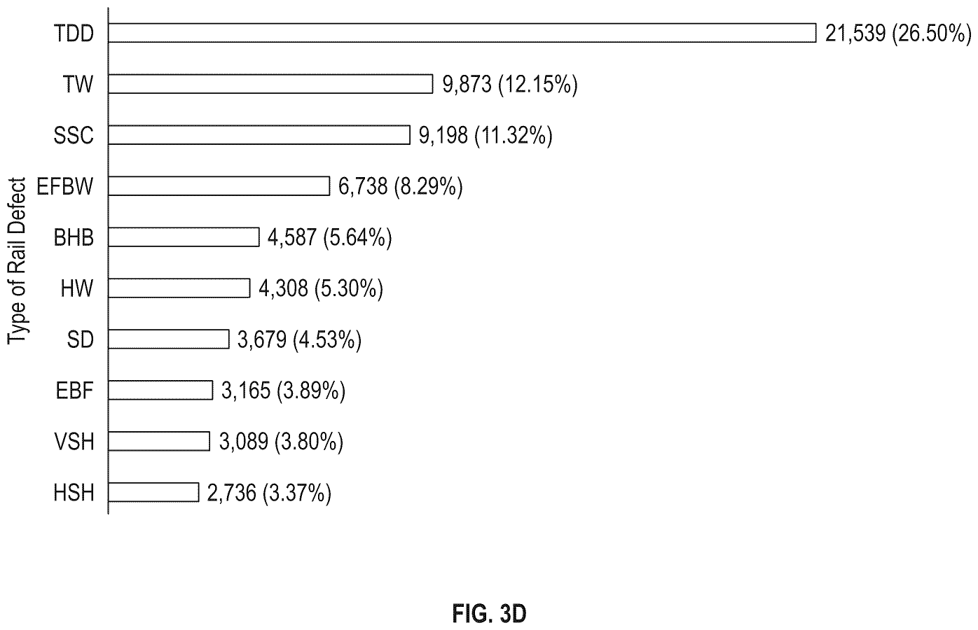

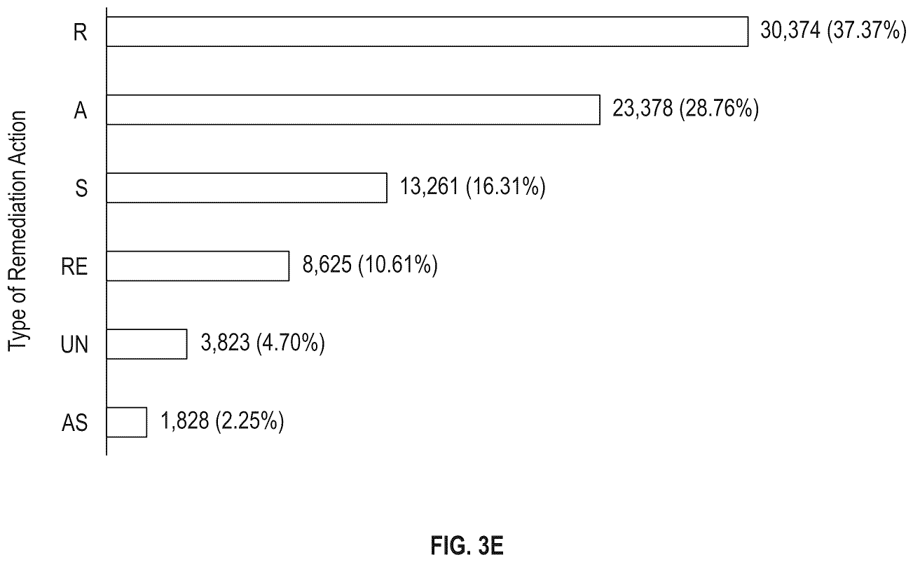

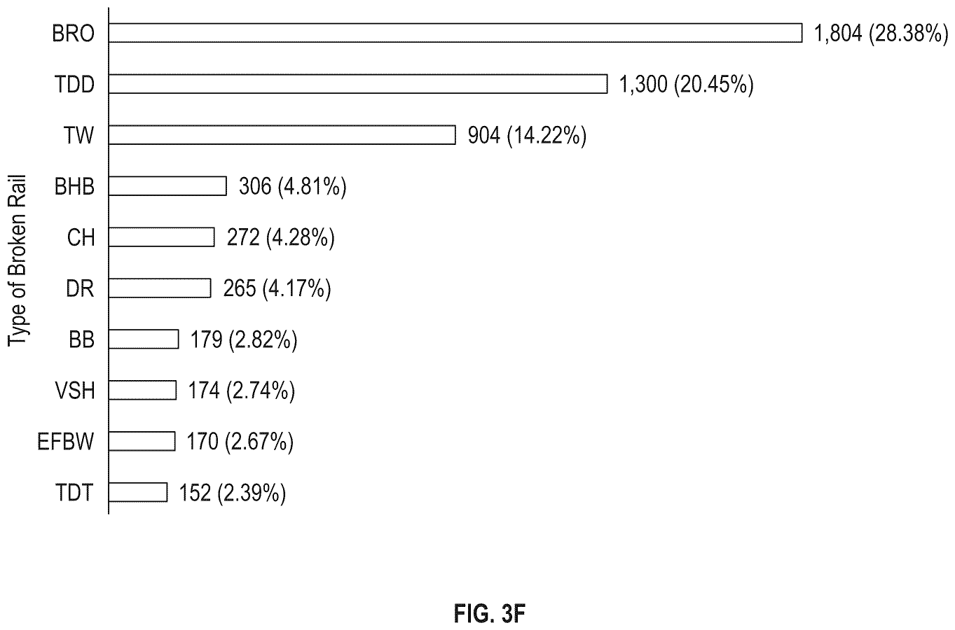

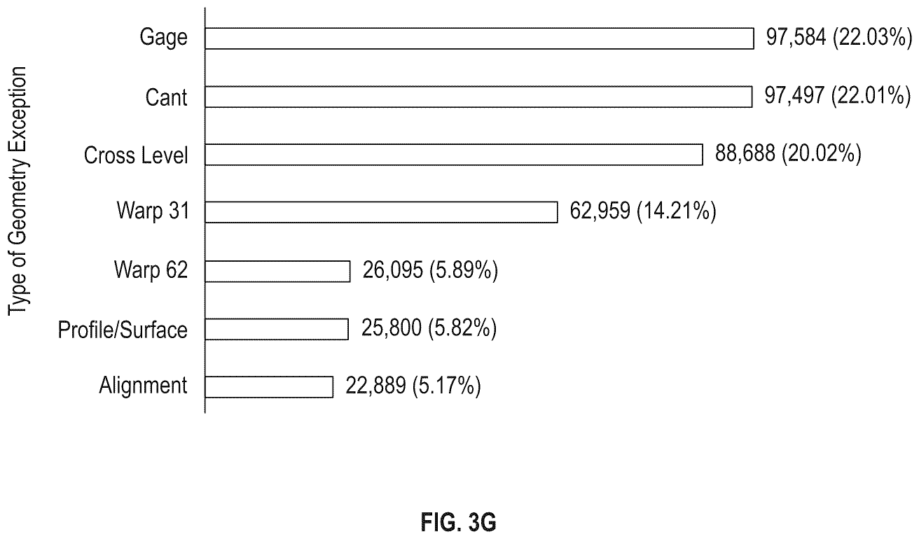

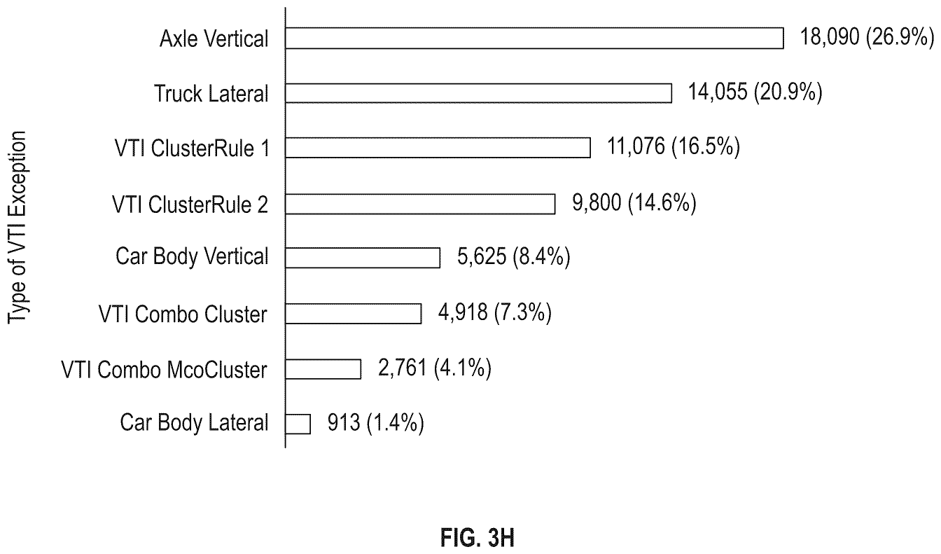

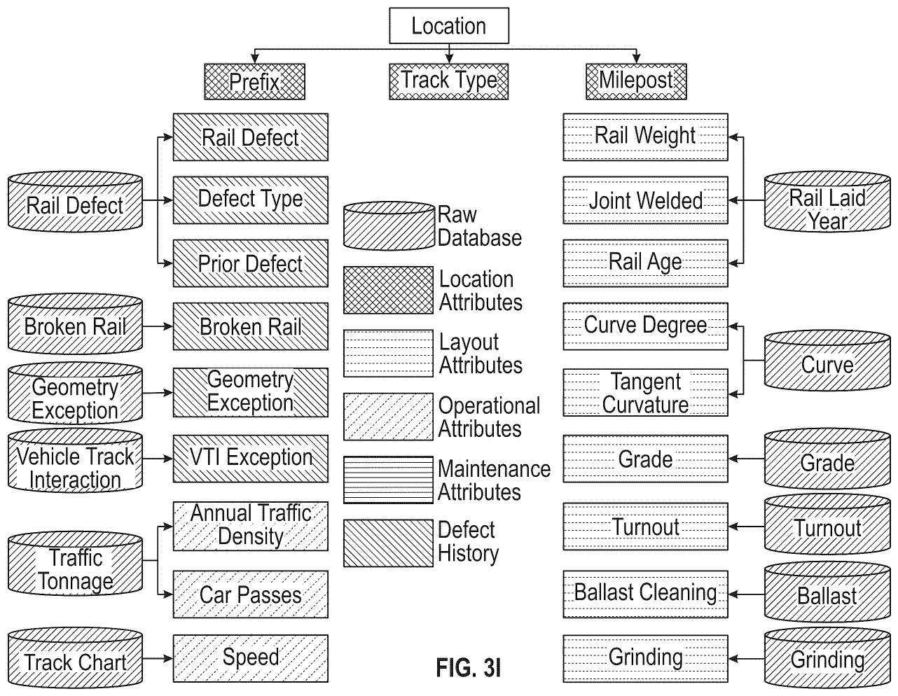

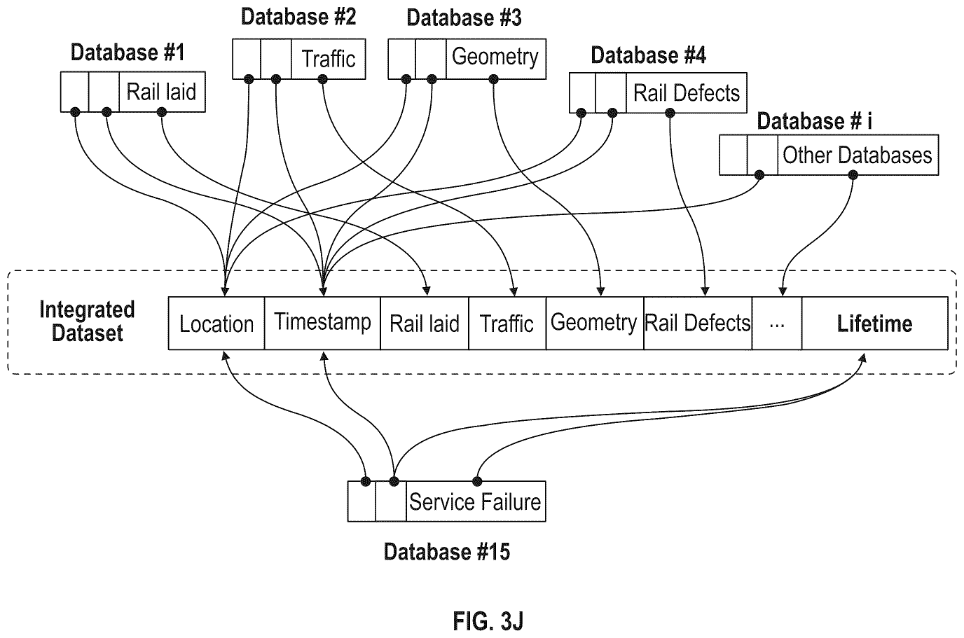

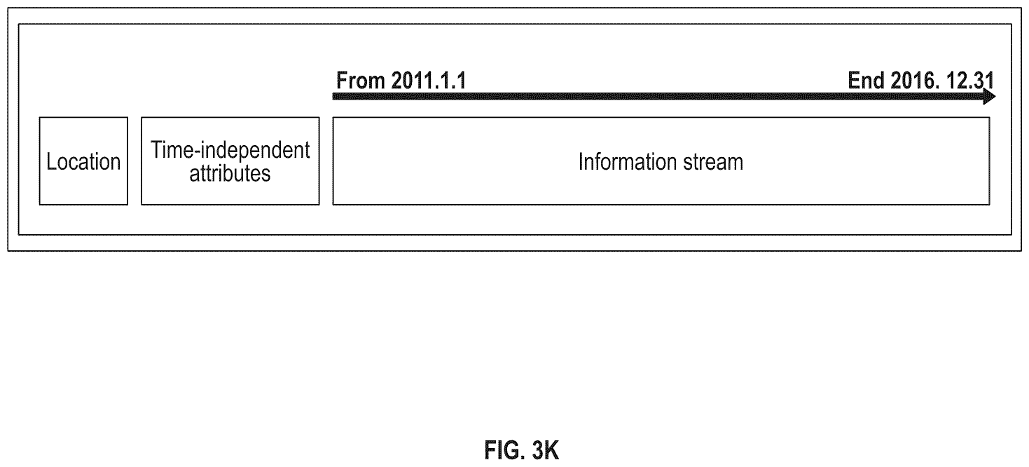

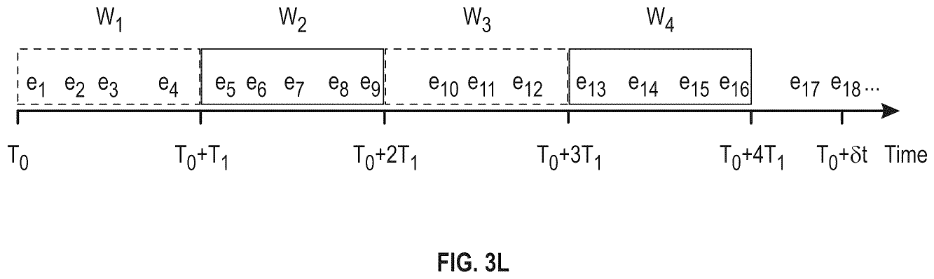

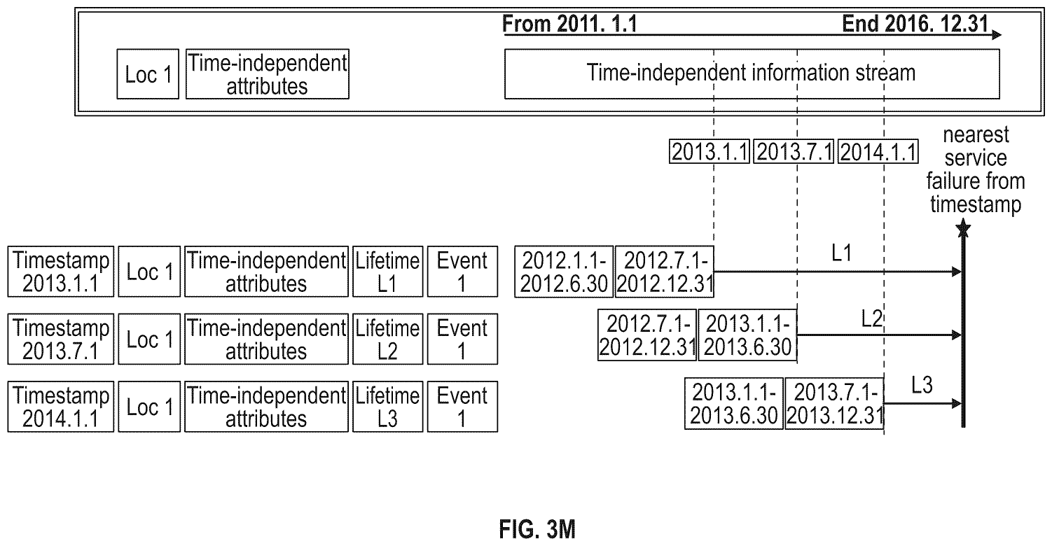

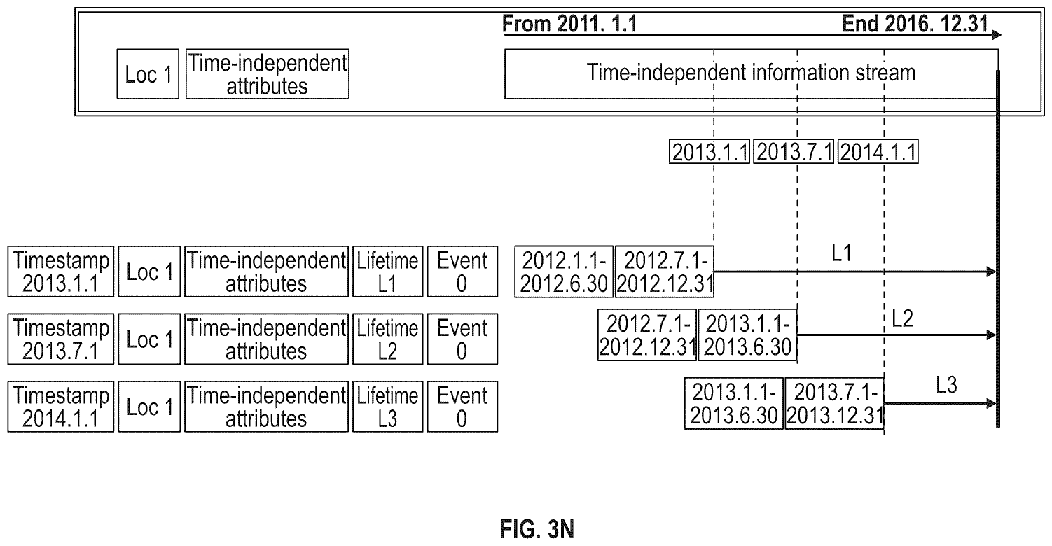

In some embodiments, a rail laid data database includes rail weight, new rail versus re-laid rail, and joint versus continuous welded rails (CWR), among other rail laid metrics (Table 3.3). FIG. 3A illustrates the total rail miles in terms of rail laid year and rail type (jointed rail versus CWR) where W denotes a welded rail and J denotes a jointed rail. FIG. 3 shows that most welded rails may be laid after the 1960s and most joint rails may be laid before the 1960s on this railroad. This research may focus on CWR that accounts for around 90 percent of total track miles.

TABLE 3.3
Rail Laid Dataset Format

| | | | | | | | | |
|---|---|---|---|---|---|---|---|---|
| | Begin | End | Track | Rail | Rail | Rail | New | Joint |
| Prefix | Milepost | Milepost | Type | Side | Weight | Gang | Relay | Weld |

In some embodiments, the tonnage data file database records, e.g., gross tonnage, foreign gross tonnage, hazmat gross tonnage, net tonnage, hazmat net tonnage, tonnage on each axle, and number of gross cars that have passed on each segment, among other tonnage metrics. Every segment in the tonnage data file is distinguished by prefix, track type, starting milepost, and ending milepost. This research uses the gross tonnage and number of gross cars (Table 3.4).

TABLE 3.4
Tonnage Data Format

| | | | | | | | |
|---|---|---|---|---|---|---|---|
| | Begin | End | | | | | |
| Prefix | Milepost | Milepost | Track | Gross Ton | Cars | Year | Month |

In some embodiments, a grade data database records grade data over entire network divided into smaller segments. In some embodiments, the segment may include, e.g., an average length of 0.33 miles, however other average lengths may be employed, such as, e.g., 0.125 miles, 0.1667 miles, 0.25 miles, 0.5 miles, or multiples thereof. The grade data format is illustrated in Table 3.5.

TABLE 3.5
Grade Data Format

| | | | |
|---|---|---|---|
| Prefix | Begin Milepost | End Milepost | Boundary |

In some embodiments, a curvature data database may include the degree of curvature, length of curvature, direction of curvature, super elevation, offset, and spiral lengths, among other curvature metrics. For the segments that are not included in this database, the segments are assumed to be and recorded as tangent tracks. There are approximately 5,800 curve-track miles (26% of the network track miles). The curve data format is illustrated in Table 3.6. FIG. 3C shows the distribution of the curve degree on the railroad network.

TABLE 3.6
Curvature Data Format

| | | | | | | | | |
|---|---|---|---|---|---|---|---|---|
| | Begin | End | Track | Curve | Curve | Curve | Curve | Curve |
| Prefix | Milepost | Milepost | Type | Spiral | Length | Degrees | Direction | Superelevation |

In some embodiments, a database may include a track chart to provide information on the track, including division, subdivision, track alignment, track profile, as well as maximum allowable train speed. The maximum freight speed on the network is 60 MPH. The weighted average speed on the network is 40 MPH. The distribution of the total segment length associated with speed category is listed in Table 3.7.

TABLE 3.7
Distribution of Speed Category

| | | Percentage of |
|---|---|---|
| Speed Category (MPH) | Total Track Miles | Network |
| 0~10 | 1,571.79 | 7.7% |
| 10~25 | 4,237.83 | 20.7% |
| 25~40 | 5,210.90 | 25.4% |
| 40~60 | 9,482.31 | 46.2% |

In some embodiments, a database may include turnout data including, e.g., the turnout direction, turnout size and other information, among other turnout-related information (Table 3.8). There are around 9,000 total turnouts in the network, with an average of 0.35 turnouts per track-mile.

TABLE 3.8
Turnout Data Format

| | | | | |
|---|---|---|---|---|
| | | Turnout | Diverging | |
| Prefix | Milepost | Direction | Prefix | Turnout Size |

In some embodiments, a database may include signal data indicating, e.g., whether a track is in a signalized territory, or other signal-related information (Table 3.9). There are approximately 14,500 track miles with signal, accounting for 67% of track miles of the railroad network.

TABLE 3.9
Signal Data Format

| | | | |
|---|---|---|---|
| Prefix | Begin Milepost | End Milepost | Signal Code |

some embodiments, rail grinding passes are used to remove surface defects and irregularities caused by rolling contact fatigue between wheels and the rail. In addition, rail grinding may reshape the rail-profile, resulting in better load distribution. In some embodiments, a database may record grinding data, including, e.g., the grinding passes for rails on the two sides of the track. In some embodiments, the grinding passes for rails on the two sides of the track may be recorded separately. In some embodiments, the grinding data may include low rail passes and high rail passes (Table 3.10). In some embodiments, the grinding data may include, for tangent rail, the left rail as the low rail and the right rail as the high rail.

TABLE 3.10
Grinding Data Format

| | | | | | | | |
|---|---|---|---|---|---|---|---|
| | | Line | Track | Begin | End | Low Rail | High Rail |
| Date | Subdivision | Segment | ID | Milepost | Milepost | Passes | Passes |

TABLE 3.11
Distribution of Grinding Frequency and Year

| | | Grinding- | Total | Grinding |
|---|---|---|---|---|
| | Grinding | rail- | grinding- | passes per rail |
| Year | frequency | miles | rail-miles | mile |
| 2011 | 0 | 35,191 | 31,848.1 | 0.72 |
| | 1 | 12,935 | | |
| | 2 | 3,475 | | |
| | 2+ | 2,888 | | |
| 2012 | 0 | 21,287 | 35,220.5 | 0.79 |
| | 1 | 16,297 | | |
| | 2 | 4,216 | | |
| | 2+ | 2,690 | | |
| 2013 | 0 | 20,558 | 33,232.1 | 0.75 |
| | 1 | 19,949 | | |
| | 2 | 2,348 | | |
| | 2+ | 2,635 | | |
| 2014 | 0 | 21,152 | 33,558.0 | 0.75 |
| | 1 | 16,354 | | |
| | 2 | 5,008 | | |
| | 2+ | 1,975 | | |
| 2015 | 0 | 20,091 | 30,074.6 | 0.68 |
| | 1 | 21,085 | | |
| | 2 | 1,755 | | |
| | 2+ | 1,558 | | |
| 2016 | 0 | 21,998 | 32,575.3 | 0.73 |
| | 1 | 15,438 | | |
| | 2 | 5,245 | | |
| | 2+ | 1,809 | | |

Ballast cleaning repair or replaces the “dirty” worn ballast with fresh ballast. In some embodiments, a database may record ballast cleaning data including, e.g., the locations of ballast cleaning identified using prefix, track type, begin milepost and end milepost (Table 3.12). In some embodiments, the database may record additional ballast cleaning data including, e.g., other ballast cleaning-related data such as the total mileage of ballast cleaning each year as shown in Table 3.13.

TABLE 3.12
Ballast Cleaning Data Format

| | | | | | |
|---|---|---|---|---|---|
| Year | Corridor | Track ID | Begin MP | End MP | Pass Miles |

TABLE 3.13
Total Track-Miles of Ballast Cleaning by Year

| | Ballast cleaning | Ballast-track- | Total ballast- |
|---|---|---|---|
| Year | frequency | miles | track-miles |
| 2011 | 1 | 900 | 1,149 |
| | 1+ | 116 | |
| 2012 | 1 | 1,609 | 1,864 |
| | 1+ | 122 | |
| 2013 | 1 | 1,335 | 1,763 |
| | 1+ | 193 | |
| 2014 | 1 | 1,735 | 2,393 |
| | 1+ | 285 | |
| 2015 | 1 | 1,862 | 2,299 |
| | 1+ | 213 | |
| 2016 | 1 | 932 | 1,166 |
| | 1+ | 99 | |

In some embodiments, a database may record various types of rail defects in a rail defect database. In some embodiments, there are 25 or more different types of defects recorded. A necessary remediation action can be performed based on the type and severity of the detected defect. In some embodiments, there are 31 or more different action types recorded in the database. In some embodiments, any number of types of defects and any number of action types may be records, such as, e.g., 5 or more, 10 or more, 15 or more, 20 or more, 25 or more, 30 or more, or other numbers of types. In some embodiments, the numbers of each type of rail defects may be considered as input variables for predicting broken rail occurrence. The top 10 defect types account for around 85 percent of total defects as shown in FIG. 3D, where TDD: detail fracture; TW: defective field weld; SSC: shelling/spalling/corrugation; EFBW: in-track electric flash butt weld; BHB: bolt hole crack; HW: head web; SD: shelly spots; EBF: engine burn fracture; VSH: vertical split head; HSH: horizontal split head. FIG. 3E shows the distribution of remediation actions to treat defects, where R indicates to repair or replace or remove rail section; A indicates to apply joint/repair bars; S indicates to slow down speed, RE indicates to visually inspect or supervise movement; UN indicates to unknown; and AS indicates to apply new speed.

In some embodiments, a service failure database may include service failures during a given time period. As an example, the period from 2011 to 2016 may have 6,356 service failures recorded int eh service failure database. Of the top 10 types of broken rails that account for around 87 percent of total broken rails, the distribution of each type is shown in FIG. 3F, where BRO denotes broken rail outside joint bar limits; TDD denotes detail fracture; TW denotes defective field weld; BHB denotes bolt hole crack; CH denotes crushed head; DR denotes damaged rail; BB denotes broken base; VSH denotes vertical split head; EFBW denotes in-track electric flash butt weld; and TDT denotes transverse fissure. The service failure resulting from defect type BRO (broken rail outside joint bar limits) is dominant, which accounts for 28.3% of the total broken rails.

In some embodiments, track geometry may be measured periodically and corrected by taking inspection and/or maintenance or repair actions. In some embodiments, as described above, there may be 31 types of track geometry exceptions (track geometry defects) in the database provided by the railroad. Eight subgroups of track geometry exceptions, in which similar exception types are combined, are developed. An example distribution of seven subgroups is listed in FIG. 3G.

In some embodiments, a Vehicle Track Interaction (VTI) System is used to measure car body acceleration, truck frame accelerations, and axle accelerations, which can assist in early identification of vehicle dynamics that might lead to rapid degradation of track and equipment. When vehicle dynamics are beyond a threshold limit, necessary inspections and repairs are implemented. The VTI exception data includes the information about exception mileposts, GPS coordinates, speed, date, exception type, and follow-up actions for the period from 2012 to 2016. There are eight VTI exception types, and the distribution of each type is listed in FIG. 3H.

Data Preprocessing and Cleaning

In some embodiments, raw data may be pre-processed and cleaned in order to build an integrated central database for developing and validating machine learning models.

In some embodiments, the data pre-processing and cleaning may include unifying the formats of the column names and value types of corresponding columns in each database, such as for the location-related columns.
Prefix: an up-to-3-letter coding system working as route identifiers.
Track Type: differentiate between single track and multiple tracks.
Start MP: Starting milepost of one segment, if available.
End MP: Ending milepost of one segment, if available.
Milepost: If available, used to identify points on the track.
Side: Including right side (R) and left side (L) to distinguish different sides of the track.

In some embodiments, the data pre-processing and cleaning may include detection of data duplication. One of the common issues in data analysis is duplicated data records. There are two common types of data duplications: (a) two data records (each row in the data file represents a data record) are exactly the same and (b) more than one record is associated with the same observation, but the values in the rows are not identical, which is so-called partial duplication. In some embodiments, to determine the duplicates, selecting the unique key is the first step for handling duplicate records. Selection of unique key varies with the databases. For the databases which are time-independent (meaning that this information is not time-stamped), such as curve degree and signal, a set of location information is used to determine the duplicates. For the databases which are time-dependent, such as the rail defect database and service failure database, time information can be used to determine the duplicates. Meanwhile, using the set of location information alone is likely to be not sufficient to identify data duplicates because of possible recurrence of rail defects or service failures at the same location. Table 3.14, Table 3.15, Table 3.16 and Table 317 show some examples of data duplicates in certain databases.

TABLE 3.14
Example of Partial Duplications in Curve Degree Database

| Prefix | Start MP | End MP | TrackType | Curve_Degrees | Curve_Elevation | Curve_Direction | Offset | Spiral_1 | Curve_Length_PARTIAL | Spiral_2 |
|---|---|---|---|---|---|---|---|---|---|---|
| ABC | 143.6 | 143.61 | SG | 10.17 | 2.5 | L | 2597 | 310 | 220 | 130 |
| ABC | 143.6 | 143.61 | SG | 7 | 2 | L | NaN | NaN | 80 | 130 |

TABLE 3.15
Example of Exact Duplication in Signal Database

| Prefix | Start MP | EndMP | Signal_Code |
|---|---|---|---|
| ABC | 801.5 | 801.51 | YL-S |
| ABC | 801.5 | 801.51 | YL-S |

TABLE 3.16
Example of Partial Duplication of Signal Database

| Prefix | Start MP | End MP | Signal Code | Signal |
|---|---|---|---|---|
| ABC | 323.6 | 323.61 | CP | 1 |
| ABC | 323.6 | 323.61 | YL | 0 |
| ABC | 323.61 | 323.62 | CP | 1 |
| ABC | 323.61 | 323.62 | YL | 0 |

TABLE 3.17
Example of Exact Duplication in Rail Defect Database

| Prefix | TrackType | Start MP | End MP | Side | Defect_Types | Date_Found | Defect_Size |
|---|---|---|---|---|---|---|---|
| ABC | SG | 175.2 | 175.21 | L | SDZ | Jul. 26, 2013 | 20 |
| ABC | SG | 175.2 | 175.21 | L | SDZ | Jul. 26, 2013 | 20 |

In some embodiments, different strategies for handling data duplications are listed below. Table 3.18 shows examples of a selection of unique keys and strategies for databases. For the databases which are not listed in Table 3.18, it has been verified that no duplicates exist.
Record Elimination: For exact duplications, there are two options for removing duplicates. One is dropping all duplicates and the other is to drop one of the duplicates.
Worst Case Scenario Selection: For a partial duplication, select the worst-case-scenario value. For instance, over the junction of two consecutive curves, it is possible that two different curve degrees may be recorded. In this case, assign the maximum curve degree to the junction (the connection point of two different curves).

TABLE 3.148
Strategies for Duplication

| | Unique Key to Identify | Deduplication |
|---|---|---|
| Database | Data Duplicate | Strategy |
| Curve | Prefix, track type, milepost, side | Greater curve degree |
| Signal | Prefix, milepost, signal code | Drop either one |
| Rail Defect | Prefix, track type, milepost, side, | Drop either one |
| | defect type, date found, defect size | |
| Service Failure | Prefix, track type, milepost, side, | Drop either one |
| | date found, failure type | |

In some embodiments, some databases may differentiate between the left and right rail of the same track. For example, the rail defect database can specify the side of the track where the rail defect occurred. Also, in some embodiments, the rail laid database can specify the rail laid date for each side of the rail. However, in some embodiments, some databases may not differentiate track sides, such as the track geometry exception database and the turnout database, however, these databases may also be configured to differentiate between track sides. In some embodiments, the pre-processing and cleansing may combine the data from two sides of a track. It is possible that two sides of the track have different characteristics. When combining the information from the two sides of the track, there are multiple possible values for each attribute. For example, there may be, e.g., 5 possible values, or any other suitable number of values, such as, e.g., 2, 3, 4, 5, 6, 7, 8, 9, 10 or more, 15 or more, 20 or more, or other suitable number of values to characterize each attribute. An example of five values may include the values of “Select either one”, “Sum”, “Mean”, “Minimum”, and “Maximum”. In some embodiments, the principle of selecting preferred value for the track is to set the track at the “worse condition”. For example, in terms of rail age, when combining right rail and left rail, the older rail age between right rail and left is selected, while for rail weight, the smaller rail weight is selected. This approach assigns more conservative attribute data to each segment. The details are listed in the Table B.1 in Appendix B.

Data Integration

In some embodiments, to develop the comprehensive database, all of the collected data from all sources except geographical information system (GIS) data may be trackable using a reference database (which is the track file). In some embodiments, the reference database may include the location information (route identifier, starting milepost, ending milepost, and track type), with or without information on any features affecting broken rail occurrence. The data information from each database which may be mapped into the comprehensive database is listed in Table 3.19. FIG. 3I also presents the multi-source data fusion process.

TABLE 3.19
Information from Each Database Involved in
the Integrated Database (Partial List)

| Database | Information |
|---|---|
| Service Failure | Failure found date, failure type, curvature or tangent, |
| | curve degree, rail weight, freight speed, annual traffic |
| | density, remediation action, remediation date |
| Rail Defect | Defect found date, defect type, remediation action |
| Geometry | Geometry defect type, geometry defect date, track class |
| Exception | reduced due to geometry exception, geometry exception |
| | priority, exception remediation action |
| VTI Exception | VTI type, VTI occurrence date, VTI priority, VTI critical |
| Tonnage | grinding date, number of car passes, |
| Grinding | grinding passes, grinding location |
| Ballast Cleaning | Ballast cleaning date, ballast cleaning location |
| Rail Laid | Rail weight, rail laid year, rail quality (new rail or r |
| | e-laid rail), joint rail or continuous welded rail |
| Track chart | Maximum allowable freight speed |
| Curve Degree | Curve degree, super-elevation, curve direction, |
| | offset, spiral |
| Grade | Grade (percent) |
| Turnout | Turnout direction, turnout size |
| Signal | Signal code |

In some embodiments, the minimum segment length available for most of the collected databases may include, e.g., 0.1 mile (528 ft). However, any other suitable minimum may be employed, such as, e.g., 0.125, 0.1667, 0.25, 0.5 miles or multiples thereof. In some embodiments, for a minimum segment length of 0.1 miles, there may be over 206,000 track segments, each 0.1 mile in length, representing an over 20,600 track-mile network. In some embodiments, supplementary attributes from other databases may be mapped into the reference database based on the location index as shown in FIG. 3J. This process is known as data integration. The location index includes information including prefix, track type, start MP, and End MP. In the reference database, each supplementary feature for one location represents information series may cover a given period, such as, for example, the period from 2011 to 2016.

In some embodiments, contradiction resolution may be performed. In some embodiments, a contradiction is a conflict between two or more different non-null values that are all used to describe the same property of the same entity. Contradiction is caused by different sources providing different values for the same attribute of the same entity. For example, tonnage data and rail defect data both provided the traffic information but may have different tonnage values for the same location. Data conflicts, in the form of contradictions, can be resolved by selecting the preference source based on the data source that is assumed to be more “reliable”. For example, both the curvature database and service failure database include location-specific curvature degree information. If there is information conflict on the degree of curvature, the information from the curvature database is used based on the assumption that this is a more “reliable” database for this data. The comprehensive database only retains the value of the preferred source. Table 3.20 shows the preferred data source for the attributes that have potential contradiction issues.

TABLE 3.20
Preferred Database for Each Attribute

| | | Preferred |
|---|---|---|
| Attribute | Database Including the Attribute | Database |
| Curve degree | Service failure, rail defect, VTI | Curve degree |
| | exception, curve degree | |
| Rail weight | Service failure, rail defect, rail laid | Rail laid |
| Freight speed | Service failure, rail defect, track chart | Track chart |
| Annual traffic | Service failure, rail defect, monthly | Monthly |
| | tonnage | Tonnage |

In some embodiments, missing values may be handled to resolve issues with missing data. Handling missing data is one important problem when overlaying information from different data sources to a reference dataset. Different solutions may be available depending on the cause of the data missing. For example, one reason for missing data in the integrated database is that there may be no occurrence of events at the specific location, for instance, grinding, rail defect, and service failures, etc. In some embodiments, blank cells may be filled with zeros for this type of missing data because they represent no observations of events of interest. In some embodiments, another reason for missing data is that there is a missing value in the source data. For this type of missing data, a preferred value may be selected to fill it. Take the speed information in the integrated dataset as an example. Approximately 0.1 percent of the track network has missing speed information. In some embodiments, the track segments with missing speed information may be filled with the mean speed of the whole railway network. Table 3.21 lists the preferred values for the missing values of each attribute.

TABLE 3.21
Preferred Values of Missing Information

| Preferred Value | Attribute |
|---|---|
| Mean value | Rail laid year, speed, grade, rail weight, monthly tonnage, |
| | number of car passes, grinding, ballast cleaning |
| Zero | Curve degree, curve elevation, spiral, turnout, |
| | turnout size, rail defect, service failure, track geometry |
| | exception, VTI exception, measure of VTI exception |
| Worse case | Signal, rail quality (new rail versus re-laid rail) |

In some embodiments, in the integrated database, two types of attributes (single-value attribute and stream attribute) may be mapped. A single-value attribute is defined as a time-independent attribute, such as rail laid year, curve degree, grade, etc. A stream attribute (aka time series data) may be defined as a set of the time-dependent data during a period. For most stream attributes, the period covers from 2011 to 2016, except for the attribute of vehicle-track interaction exception, which covers from 2012 to 2016. In some embodiments, timestamps may be defined with a unique time interval to extract shorter-period data streams. For example, twenty timestamps may be defined with a unique time interval of three months from Jan. 1, 2012. In order to achieve that, a time window may be introduced. A time window is the period between a start and end time (FIG. 3K). A set of data may be extracted through the time window moving across continuous streaming data.

In some embodiments, tumbling windows may be one common type of time windows, which move across continuous streaming data, splitting the data stream into finite sets of small data stream. Finite windows may be helpful for the aggregation of a data stream into one attribute with a single value. In some embodiments, tumbling window may be applied to split the data stream into finite sets.

In some embodiments, in a tumbling window, such as those shown in FIG. 3L, events are grouped in a single window based on time of occurrence. An event belongs to only one window. A time-based tumbling window has a length of T1. The first window (w1) includes events that arrive at the time T0 and T0+T1. The second window (w2) includes events that arrived between the time T0+T1 and T0+2T1. The tumbling window is evaluated every T1 and none of the windows overlap; each tumbling window represents a distinct time segment.

In some embodiments, the tumbling window may be employed to split the larger stream data into sets of small stream data (see, FIG. 3M and FIG. 3N). In some embodiments, the length of the tumbling window is set as half a year, however other lengths may be employed, such as, e.g., one month, two months, one quarter year, one half year, one year, and multiples thereof. Two features may be extracted by two consecutive tumbling windows as shown in FIG. 3M and FIG. 3N. Three timestamps may be assigned to location “Loci” as shown in FIG. 3M. For the three timestamps, the time-independent features are unchanged for “Loci”. Taking rail defect as an example, the counts of rail defects are grouped by the tumbling window. For timestamp “2013.1.1”, two tumbling windows are generated: Window 1 from 2012.7.1 to 2012.12.31 and Window 2 from 2012.1.1 to 2012.6.30. One feature about rail defect is the count number of rail defects that occurred in Window 1, which is from 2012.7.1 to 2012.12.31, and is denoted as “Defect_fh”. Another feature about rail defect is the count number of rail defects that occurred in Window 2, which is from 2012.1.1 to 2012.6.30, and is denoted as “Defect_sh”. In some embodiments, where there may be service failure which occurred after timestamp 2013.1.1, the lifetime may be calculated by the days between the timestamp and the date of the nearest (in terms of time of occurrence) service failure. In this example, the event index is set to 1, which represents that service failure may be observed after the timestamp. If there may be no service failure after timestamp 2013.1.1 (FIG. 3N), the lifetime may be calculated by the days between the timestamp and the end time of information stream “2016.12.31”. The event index is set to 0 which represents that service failure may be not observed after that specified timestamp.

### Exploratory Data Analysis

In some embodiments, exploratory data analyses (EDA) may be conducted to develop a preliminary understanding of the relationship between most of the variables outlined in the previous section and broken rail rate, which is defined as the number of broken rails normalized by some metric of traffic exposure. Because many other variables are correlated with traffic tonnage, broken rail frequency is normalized by ton-miles in order to isolate the effect of non-tonnage-related factors. The result of an example exploratory data analysis is summarized in Table 4.1.

TABLE 4.1
Summary of Exploratory Data Analysis Results

| Factor | Relationship with Broken Rail |
|---|---|
| | Rate (per Billion Ton-Miles) |
| Rail age (years) | Broken rail rate first increases and then decreases with |
| | increasing rail age. The turning point for rail age |
| | is equal to 40 years. |
| Rail weight | Broken rail rate decreases monotonously |
| (lbs/yard) | with increased rail weight. |
| Curve degree | A higher rate is associated with a higher curve degree. |
| Grade (percent) | Broken rail rate increases with grade magnitude |
| | increasing. |
| Maximum allowed | Higher broken rail rate is associated with higher |
| speed (MPH) | maximum allowable speed on track. |
| Rail quality | Re-laid rail has a higher broken rail rate |
| | than non-re-laid rail. |
| Traffic density | A higher broken rail rate is associated |
| (MGT) | with a lower annual traffic density. |
| Prior track | Broken rail rate increases in the presence of prior |
| geometry | track geometry exception defects. |
| exceptions | |
| Prior VTI | Broken rail rate increases in the presence of prior VTI |
| exceptions | exceptions. |
| Grinding | Broken rail risk initially decreases and then increases |
| | with increasing grinding passes. The turning point |
| | is at one rail grinding pass per year. |
| Ballast cleaning | Broken rail rate decreases with ballast cleaning. |

### Rail Age

In some embodiments, rates may be determined by dividing the total number of broken rails that had occurred in a certain category of rail age by the total ton-miles in that category. The broken rail rates may be calculated for each category of the rail age as set forth in Table 4.2. With increasing rail ages, the broken rail rate per billion ton-miles first increased and then decreased. According to this example data, the turning point of the rail age is at 40 years. In other words, rail aged around 40 years (e.g., 30-39 years, 40-49 years) has the greatest number of broken rails per billion ton-miles. The potential reason is that the rail age might have correlations with other variables, for example traffic tonnage and inspection and/or maintenance operations, which bring a compound effect together with rail age on broken rail rate.

TABLE 4.2
Broken Rail Rate (per Billion Ton-Miles) by Rail Age,
All Tracks on Mainlines, 2013 to 2016

| Rail age | Number of | Billion | Number of broken rails |
|---|---|---|---|
| (years) | broken rails | ton-miles | per billion ton-miles |
| 1-9 | 515 | 380.500 | 1.35 |
| 10-19 | 591 | 333.057 | 1.77 |
| 20-29 | 555 | 250.895 | 2.21 |
| 30-39 | 940 | 355.358 | 2.65 |
| 40-49 | 533 | 203.216 | 2.62 |
| 50-59 | 128 | 52.502 | 2.44 |
| 60+ | 16 | 8.844 | 1.81 |

### Rail Weight

In some embodiments, broken rail rates may be determined in terms of the rail weight as presented in Table 4.3. These example broken rail rates show that, all else being equal, a heavier rail with a larger rail weight is associated with a lower broken rail rate, measured by number of broken rails per billion ton-miles. Stress in rail is dependent on the rail section and weight. Smaller, lighter rail sections experience more stress under a given load and may be more likely to experience broken rails.

TABLE 4.3
Broken Rail Rate (per Billion Ton-Miles) by Rail Weight,
All Tracks on Mainlines, 2013 to 2016

| Rail weight | Number of | Billion ton- | Number of broken rails |
|---|---|---|---|
| (lbs/yard) | broken rails | miles | per billion ton-miles |
| 115 and below | 288 | 72.574 | 3.97 |
| 115-122 | 452 | 156.830 | 2.88 |
| 122-132 | 1,022 | 384.291 | 2.66 |
| 132-136 | 1,490 | 830.200 | 1.79 |
| 136 and above | 356 | 235.236 | 1.51 |

### Curve Degree

Curvature increases rail wear and causes additional shelling and defects that might increase the probability of broken rails. Accordingly, in some embodiments, broken rail rate by curve degree may be determined as presented with example data in Table 4.4. In this example data, tangent tracks had around 70 percent of broken rails, but the number of broken rails per billion ton-miles is smaller than curvatures. In terms of tracks with curves, the sharper curves involve higher broken rail rates.

TABLE 4.4
Broken Rail Rate (per Billion Ton-Miles) by Curve Degree,
All Tracks on Mainlines, 2013 to 2016

| Curve | Number of | Billion | Number of broken rails |
|---|---|---|---|
| degree | broken rails | ton-miles | per billion ton-miles |
| Tangent | 2,501 | 1,217.869 | 2.05 |
| 0-4 | 837 | 372.451 | 2.25 |
| 4-8 | 222 | 78.562 | 2.83 |
| 8 or more | 48 | 10.249 | 4.68 |

### Grade

In some embodiments, the effect of grade on broken rail rates may be determined. For example, the effect of grade in example data is illustrated in Table 4.5, in which the broken rail rate for each grade category (0-0.5 percent, 0.5-1.0 percent, and over 1.0 percent) is presented. This example data indicates that increasing grade percents have greater broken rail rates with the highest broken rail rate is on the tracks with the steepest slope (over 1.0 degree). Steep grade might increase longitudinal stress due to the amount of tractive effort and braking forces, thereby increasing broken rail probability.

TABLE 4.5
Broken Rail Rate (per Billion Ton-Miles) by Grade,
All Tracks on Mainlines, 2013 to 2016

| Grade | Number of | Billion | Number of broken rails |
|---|---|---|---|
| (percent) | broken rails | ton-miles | per billion ton-miles |
| 0-0.5 | 2,778 | 1,296.312 | 2.14 |
| 0.5-1.0 | 668 | 309.354 | 2.16 |
| 1.0+ | 162 1 | 73.465 | 2.21 |

### Rail Grinding

In some embodiments, the effects of rail grinding on broken rail rates may be determined. Rail grinding can remove defects and surface irregularities from the head of the rail, which lowers the probability of broken rails due to fractures originating in rail head. As described previously, there are preventive grinding and corrective grinding. Preventive grinding is normally applied periodically to remove surface irregularities, and corrective grinding with multiple passes each time is usually performed due to serious surface defects.

Example data presented in Table 4.6 shows that broken rail rate without preventive grinding passes (0 grinding pass) is higher than that with preventive grinding passes. This may indicate that preventive grinding passes can reduce broken rail probability compared with the case of no grinding. However, the broken rail rate associated with more than one grinding pass is higher than that associated with just one grinding pass. The multiple grinding passes, which might be scheduled as corrective grinding passes, are associated with higher broken rail rates. This is analogous to the chicken-and-egg problem. There are more defects, and therefore corrective grinding is used. Because there is no identification of the type of grinding (preventive versus corrective) in the database, the assumption and observation mentioned above need further scrutiny.

TABLE 4.6
Broken Rail Rate (per Billion Ton-Miles) by Grinding Passes,
All Tracks on Mainlines, 2013 to 2016

| Grinding | Number of | Billion | Number of broken rails |
|---|---|---|---|
| passes per year | broken rails | ton-miles | per billion ton-miles |
| 0 | 835 | 294.323 | 2.84 |
| 1 | 1,836 | 998.062 | 1.84 |
| 2+ | 937 | 386.744 | 2.42 |

### Ballast Cleaning

In some embodiments, the effects of ballast cleaning on broken rail rates may be determined. Ballast cleaning aims to repair or replace small worn ballasts with new ballasts. The example data presented in Table 4.7 shows that the broken rail rate without ballast cleaning is slightly higher than that with ballast cleaning. This potentially illustrates that proper ballast cleaning can improve drainage and track support, which may be reduce the probability of service failure.

TABLE 4.7
Broken Rail Rate (per Billion Ton-Miles) by Ballast Cleaning,
All Tracks on Mainlines, 2013 to 2016

| | | | Number of broken |
|---|---|---|---|
| Ballast | Number of broken | Billion ton- | rails per billion |
| cleaning | rails | miles | ton-miles |
| No | 3,151 | 1,454.465 | 2.17 |
| Yes | 457 | 224.665 | 2.03 |

### Maximum Allowed Track Speed

In some embodiments, the effects a maximum allowed track speed on broken rail rates may be determined. To further state the relationship between track speed and broken rail rate, broken rail rates may be calculated for each category of track speeds as illustrated in Table 4.8. The distribution indicates that broken rails on Class 4 or above track (speed above 40 mph) account for over half of the total number of broken rails but the broken rail rate, i.e. number of broken rails per billion ton-miles, is the lowest. Instead, the highest broken rate is associated with maximum track speed from 0 to 25 mph that is FRA track Class 1 and Class 2. In some embodiments, the maximum allowed track speed may also be correlated to other track characteristics, engineering and inspection and/or maintenance standards. Higher track class, associated with higher track quality, may be bear higher usage (higher traffic density), which requires more frequent inspection and/or maintenance operations accordingly.

TABLE 4.8
Broken Rail Rate (per Billion Ton-Miles) by Track Speed,
All Tracks on Mainlines, 2013 to 2016

| Track | | | | Number of |
|---|---|---|---|---|
| speed | FRA track | Number of | Billion ton- | broken rails per |
| (MPH) | class | broken rails | miles | billion ton-miles |
| 0-25 | Class 1 & 2 | 430 | 132.481 | 3.25 |
| 25-40 | Class 3 | 1,075 | 348.919 | 3.08 |
| 40-60 | Class 4 | 2,103 | 1,197.731 | 1.76 |

### Track Quality

In some embodiments, the effects of track quality on broken rail rates may be determined. Example data of broken rail rate with respect to track quality (new rail versus re-laid rail) is listed in Table 4.9. In terms of the number of broken rails, new rails may involve four times that of re-laid rails. However, after normalizing broken rail frequency by traffic exposure in ton-miles, the broken rail rate of re-laid track may be higher than that of new rails.

TABLE 4.9
Broken Rail Rate (per Billion Ton-Miles) By Track
Quality, All Tracks on Mainlines, 2013 to 2016

| Track | Number of | Billion ton- | Number of broken rails |
|---|---|---|---|
| quality | broken rails | miles | per billion ton-miles |
| New rail | 2,484 | 1,299.830 | 1.91 |
| Re-laid | 644 | 196.684 | 3.27 |
| rail | | | |

### Annual Traffic Density

In some embodiments, the effects of annual traffic density on broken rail rates may be determined. In some embodiments, the annual traffic density may measure in gross million tonnages (MGT) or any other suitable measurement. Table 4.10 lists example data of the broken rail rate in terms of the annual traffic density categories. In some embodiments, there is an approximately monotonic trend showing that higher annual traffic density is associated with lower broken rail rate. Rail tracks with higher traffic density (>20 MGT) have a smaller number of broken rails per billion ton-miles, which is around half of that on tracks with lower traffic density (<20 MGT). In some embodiments, the annual traffic density may be correlated with other factors, such as rail age or track class, thus explaining the effects on broken rail rate. For example, a track with higher annual traffic density is more likely to have higher FRA track class and correspondingly more or better track inspection and maintenance.

TABLE 4.10
Broken Rail Rate (per Billion Ton-Miles) By Annual
Traffic Density (MGT), All Tracks on Mainlines, 2013 to 2016

| Annual traffic | Number of | Billion | Number of broken rails |
|---|---|---|---|
| density (MGT) | broken rails | ton-miles | per billion ton-miles |
| 0-20 | 947 | 276.423 | 3.43 |
| 20-60 | 2,153 | 1,100.650 | 1.96 |
| 60+ | 508 | 302.055 | 1.68 |

### Track Geometry Exception

In some embodiments, the effects of track geometry exception on broken rail rates may be determined. An example distribution of broken rail rate by track geometry exception is presented in Table 4.11. In the example distribution, around 94 percent of broken rails occurred at locations which did not experience track geometry exceptions and covered 98 percent of the traffic volume in ton-miles. In contrast, around 6 percent of broken rails occurred at locations that experienced track geometry exceptions, which account for only 2 percent of traffic volume in ton-miles. In other words, the broken rail rate at locations with track geometry exceptions is approximately three times as high as that at locations without track geometry exceptions.

TABLE 4.11
Broken Rail Rate (per Billion Ton-Miles) By Presence of Track
Geometry Exceptions, All Tracks on Mainlines, 2013 to 2016

| Track geometry | Number of | Billion | Number of broken rails |
|---|---|---|---|
| exception | broken rails | ton-miles | per billion ton-miles |
| No | 3,403 | 1,644.923 | 2.07 |
| Yes | 205 | 34.207 | 5.99 |

Vehicle-Track Interaction Exception

In some embodiments, the effects of vehicle-track interaction exception on broken rail rates may be determined. Table 4.12 presents an example of the number of broken rails, traffic exposures, and service failure rate by vehicle-track interaction (VTI) exceptions and non VTI exceptions. In the example data, around 2.8 percent of broken rails occurred on tracks with at least one VTI exception, while these locations only have 0.3 percent of traffic volume in terms of ton miles. The broken rail rate with occurrence of vehicle-track interaction exceptions may be six times as that without occurrence of vehicle-track interaction exceptions.

TABLE 4.12
Broken Rail Rate (per Billion Ton-Miles) By Presence
of Vehicle-Track Interaction Exceptions,
All Tracks on Mainlines, 2013 to 2016

| | Number of | Billion | Failure rate |
|---|---|---|---|
| VTI | broken rails | ton-miles | (per billion ton-miles) |
| No | 3,507 | 1,670.842 | 2.10 |
| Yes | 101 | 8.289 | 12.18 |

### Correlation Between Input Variables

In some embodiments, a correlation between input variables may be measured by correlation coefficient to measure the strength of a relationship between two variables. The correlation coefficient may be determined by dividing the covariance by the product of the two variables' standard deviations.

$${ρ}_{{X}_{i} {X}_{j}} = \frac{cov [ {X}_{i} , {X}_{j} ]}{{σ}_{{X}_{i}} {σ}_{{X}_{j}}} = \frac{E [ ( {X}_{i} - E [ {X}_{i} ] ) ( {X}_{j} - E [ {X}_{j} ] ) ]}{{σ}_{{X}_{i}} {σ}_{{X}_{j}}} \qquad ( 4 - 1 )$$

Where:
βxᵢxⱼ=correlation coefficient
cov[Xᵢ, Xⱼ]=Covariance of variables Xᵢ and Xⱼ
E(X)=expected value (mean) of variable X
α_{X}_{ᵢ}=standard deviation of Xᵢ
α_{X}_{ⱼ}=standard deviation of Xⱼ
Xᵢ, Xⱼ=two measured values

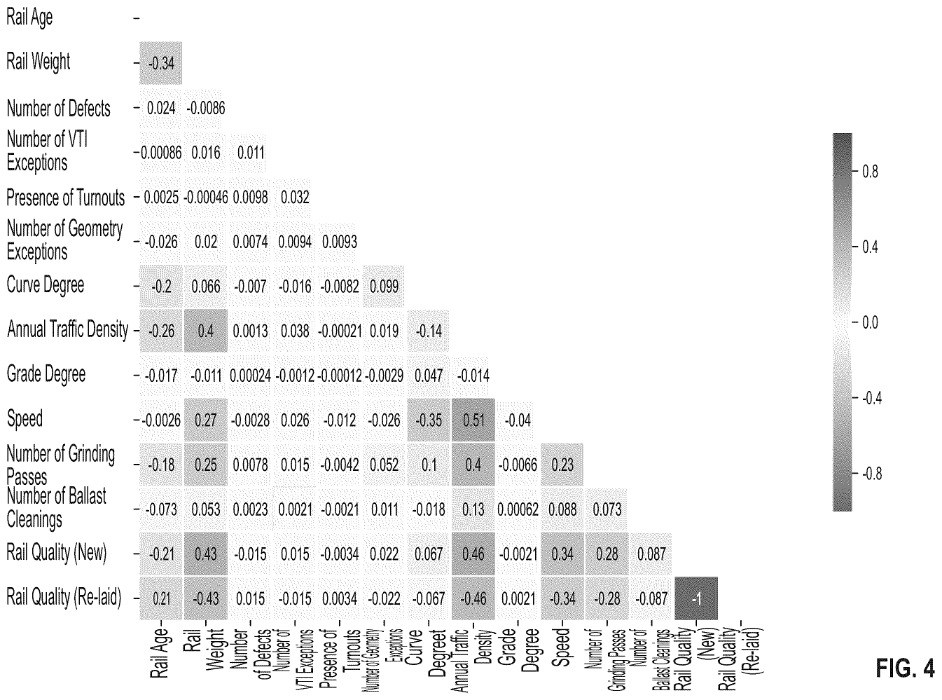

In some embodiments, the value of the correlation coefficient can vary between −1 and 1, where “−1” indicates a perfectly negative correlation that means that every time one variable increases, the other variable must decrease, and “1” indicates a perfectly positive linear correlation that means one variable increases with the other. 0 may indicate that there is no linear correlation between the two variables. FIG. 4 shows the correlation matrix between the variables.

In some embodiments, there is a positive relationship (correlation coefficient is 0.51) between these maximum allowable track speed and annual traffic density, which means higher annual traffic density is associated with higher maximum allowable track speed.

In some embodiments, annual traffic density may also correlate with rail quality (new rail versus re-laid rail). New rail is associated with higher annual traffic density (correlation coefficient is 0.46) while re-laid rail is associated with lower annual traffic density (correlation coefficient is −0.46).

In some embodiments, curve degree has a negative correlation with the maximum allowable track speed (correlation coefficient is −0.35). This represents that tracks with higher curve degrees are associated with lower maximum allowable track speeds.

In some embodiments, rail age and annual traffic density have a negative correlation (correlation coefficient is −0.26), which means the older rail is associated with lower annual traffic density.

### Track Segmentation

In some embodiments, a track segmentation process may be employed for broken rail prediction using machine learning algorithms.

### Fixed-Length Versus Feature-Based Segmentation

In some embodiments, there may be two types of strategies for the segmentation process: fixed-length segmentation and feature-based segmentation. fixed-length segmentation divides the whole network into segments with a fixed length. For feature-based segmentation, the whole network can be divided into segments with varying lengths. If fixed-length segmentation is applied and the small adjacent segments are combined, these combined segments may have different characteristics of certain influencing factors (e.g., traffic tonnage, rail weight) affecting broke rail occurrence. This combination may introduce potentially large variance into the database and further affect the prediction performance. For feature-based segmentation, segmentation features are used to measure the uniformity of adjacent segments. In some embodiments, adjacent segments may be grouped and combined under the condition that these adjacent segments embody similar features. Otherwise, these adjacent segments may be isolated. Feature-based segmentation can reduce the variances in the new segments.

In some embodiments, all features involved in the segmentation process can be divided into three categories: (1) track-layout-related features, (2) inspection-related features and (3) maintenance-related features, as illustrated in Table 5.1. The track-layout-related features may include information of rail and track, such as rail age, curve, grade, rail weight, etc. The track-layout-related features may be kept consistent on a relatively longer track milepost in general.

In some embodiments, the inspection-related features refer to the information obtained according to the measurement or inspection records, such as track geometry exceptions, rail defects, and VTI exceptions. These features may change with time.

In some embodiments, the rail defect information may be recorded when there is an inspection plan and the equipment or worker finds the defect(s). Also, it is possible the more inspections, the more defects might be found. This can lead to uncertainty for broken rail prediction. The maintenance-related features include grinding, ballast cleaning, tamping etc. Different types of inspection and/or maintenance action may have different influences on rail integrity.

As mentioned above, in some embodiments, there are two types of segmentation strategies: fixed-length segmentation and feature-based segmentation. Furthermore, there are two methods for feature-based segmentation: static-feature-based segmentation and dynamic-feature-based segmentation. The details may be introduced as follows.

TABLE 5.1
Track Segmentation Strategy

| | | Feature-based segmentation | |
|---|---|---|---|
| Segmen- | Fixed- | | Dynamic- |
| tation | length | Static-feature-based | feature-based |
| strategies | segmentation | segmentation | segmentation |
| Considered | None | Track-layout- | Track-layout-related |
| features | | related features | features, inspection- |
| | | | related features, |
| | | | inspection and/or |
| | | | maintenance- |
| | | | related features |
| Rules | The length | If the difference | The “best” segment |
| | of | between two adjacent | length is found |
| | the newly | 0.1-mile segments in | when a predefined |
| | emerged | feature values is beyond | loss function |
| | segment is | a given hreshold, these | is minimized |
| | fixed | two segments should | |
| | | belong to two different | |
| | | new segments, | |
| | | otherwise, these two | |
| | | 0.1-mile segments are | |
| | | merged into one | |
| | | segment | |

In some embodiments, during the segmentation process, the whole set of network segments are divided into different groups. For example, a 0.1-mile fixed length may be originally used in the data integration, or any other suitable fixed length as described above. Each group may be formed to maintain the uniformity on each segment. In some embodiments, aggregation functions are applied to assign the updated values to the new segment. Example aggregation functions are given in Table 5.2 with nomenclature given in Table 5.3. For example, the average value of nearby fixed length segments may be used for features such as the traffic density and speed and use the summation value for features such as rail defects, geometry defects and VTI.

TABLE 5.2
Feature Aggregation Function in Segmentation (Partial List)

| Features | Operation |
|---|---|
| Traffic density | Mean |
| Rail weight | Minimum |
| Rail age | Maximum |
| Rail defect | Sum |
| Service failure | Sum |
| Grinding | Mean |
| Ballast cleaning | Mean |
| Geometry defects | Sum |
| Speed | Mean |
| Curve | Maximum |
| Grade | Maximum |
| VTI | Sum |

TABLE 5.3
Aggregation Functions for Merging Sides

| | | Preferred |
|---|---|---|
| Attribute | Description | Value |
| Division | Location information: nine divisions in | Either one |
| | the database | |
| Subdivision | Location information | Either one |
| Prefix | A 3-alphabet coding system working as | Either one |
| | route identifiers | |
| Track_type | Single track or multiple tracks (SG, track | Either one |
| | 1, track 2, track 3, track 4) | |
| Rail_laid _year | The year when the rail may be laid | Minimum |
| Rail_weight | Rail weight measured as pounds per yard | Minimum |
| Rail_quality | Two possible categories: new rail and re- | Worse case |
| | laid rail | |
| Curve_degree | The curve degree posted at the location | Either one |
| Curve_direction | The curve direction posted at the location | Either one |
| Spiral_1 | The spiral length (feet) at the beginning | Either one |
| | of the curve | |
| Spiral_2 | The spiral length (feet) at the ending of | Either one |
| | the curve | |
| Super-elevation | Super-elevation between two rails due to | Either one |
| | the curve | |
| Grade_degree | The feet of rise per 100 feet of horizontal | Either one |
| | distance | |
| Speed | The maximum allowed speed (mph) at | Either one |
| | the location | |
| Signal | Whether track circuits may be set at the | Either one |
| | location (yes or no) | |
| Turnout_num | Total number of turnouts posted at the | Either one |
| | location | |
| Turnout_ | The total number of directions the track | Either one |
| direction_num | diverging into | |
| Ballast_time | The total number of ballast at the location | Either one |
| | in the particular time period | |
| Grinding_time | The total number of grinding passes at | Mean |
| | the location in the particular time period | |
| Service_ | The total number of service failure | Sum |
| failure_time | (including all types) occurred at the | |
| | location in the particular time period | |
| Car_passes_ | The number of cars passing at the | Mean |
| time | location in the particular time period | |
| Tonnages_time | The gross million tonnages (MGT) | Mean |
| | experienced at the location in the | |
| | particular time period | |
| Defect_type_ | The total number of rail defects with | Sum |
| time | specific type at the location in the | |
| | particular time period | |
| Geometry_ | The total number of geometry exception | Sum |
| type_time | defects with specific type at the location | |
| | in the particular time period | |
| Geometry_time | The total number of geometry exception | Sum |
| | defects (including all types) at the | |
| | location in the particular time period | |
| Geometry_ | The total number of geometry exception | Sum |
| priority_time | defects with the specific priority in the | |
| | particular time. Geometry exceptions are | |
| | automatically prioritized based on the | |
| | deviation of the measure from the class | |
| | of track being measured. | |
| Class reduced_ | Class reduction due to geometry | Maximum |
| time | exceptions in the particular time period. | |
| | It is calculated by the difference | |
| | between the original track class and the | |
| | updated track class. | |
| VTI_type_time | The total number of vehicle-track | Sum |
| | interaction exceptions with the specific | |
| | type in the particular time period | |
| Measure_VTI_ | The max measurements corresponding to | Maximum |
| type_time | different vehicle-track interaction | |
| | exception types in the particular time | |
| VTI_priority_ | The total number of vehicle-track | Mean |
| time | interaction exception with specific | |
| | priority in particular time period. | |

### Fixed-Length Segmentation

In some embodiments, the fixed-length segmentation is the segmentation strategy that uses the fixed length to merge consecutive fixed length segments compulsively, which ignores the variance of the features on these segments. This forced merge strategy can be understood as a moving average filtering along the rail line. In the example shown in FIG. 5A, there are a total of fifteen (15) fixed length segments. The values of two features, rail age and annual traffic density, are described by two lines. In the fixed-length segmentation, a pre-determined fixed segmentation length is set to a suitable multiple of the fixed-length, for example for fixed lengths of 0.1 miles, the fixed segmentation length may be, e.g., 0.3 miles. Therefore, in this example, three consecutive 0.1-mile segments are combined. For example, merged segment A-1 is composed of the original 0.1-mile segments 1 to 3. The rail ages of these three 0.1-mile segments are not identical, being 20, 20, and 24 years, respectively. The rail age assigned to the new merged segment A-1 may be determined as the mean value of the fixed-length segments (e.g. 21.3 years in the example of FIG. 5A).

In some embodiments, fixed-length segmentation is the most direct (easiest) approach for track segmentation and the algorithm is the fastest. However, in some embodiments, the internal difference of features can be significant but is likely to be neglected.

### Feature-Based Segmentation

In some embodiments, feature-based segmentation aims to combine uniform segments together. The uniformity may be defined by the internal variance or variance among the fixed length segments on the new segment. The uniformity is measured by the information loss which is calculated by the summation of the weighted variances on involved features. The formula shown below is used to calculate the information loss.

Loss(A)=Σ_{i∈[1,n]}wᵢ·std(Aᵢ) (5-1)

Where:
A: the feature matrix
n: number of involved features
Aᵢ: the i^{th} column of A
wᵢ: the weight associated with the i^{th} feature
std(Aᵢ): the standard deviation of the i^{th} column of A

In some embodiments, the loss function can be interpreted as follows: given multiple features, the weighted summation of the standard deviation of each feature may be calculated, then a value to represent the internal difference of records of one feature is obtained. In some embodiments, the smaller the value of the loss functions, the more uniform each new segment in the segmentation strategy can be, due to minimizing the internal variances of selected features on the same segmentation.

In some embodiments, the static-feature-based segmentation may use the track-layout-related (static) features to measure the information when combining consecutive segments to a new longer segment. In the feature-based segmentation, the information loss Loss(A) may be minimized (e.g., to zero or as close to zero as possible) when determining the length of newly merged segment. Therefore, feature-based segmentation is an adaptive and dynamic segmentation scheme in which a segment is assigned when at least one involved feature changes. The dynamic segmentation is an advanced type of feature-based segmentation strategy that uses an optimization model to minimize a predefined information loss in order to find the best segment length around a local milepost.

### Static-Feature-Based Segmentation

In some embodiments, in preparation for static-feature-based segmentation, segmentation features may be selected to determine the uniformity of the adjacent fixed length segments. A new segment is assigned when at least one involved feature changes. FIG. 5B shows an illustrative segmentation example. The selected segmentation features might be continuous or categorical. For categorical features, the uniformity is defined by whether the features among fixed length segments are identical. In some embodiments, for continuous features, a tolerance threshold may be used to define the uniformity. If the difference of continuous feature values of adjacent segments is smaller than the defined tolerance, uniformity may be deemed to exist. In some embodiments, for feature-based segmentation, e.g., 10% or other suitable percentage (e.g., 5%, 12.5%, 15%, 20%, 25%, etc.) of the standard deviation of differences of continuous features of the two consecutive fixed length segments is used as the tolerance. In the example as shown in FIG. 5B, two features, rail age and annual traffic density, are both continuous variables. In order to simplify the illustration of the segmentation process, it may be assumed that the differences of each value for each feature are beyond the tolerance. In the example, fifteen 0.1-mile segments are combined into seven new, longer segments. A new segment is assigned when any involved feature changes.

In some embodiments, static-feature-based segmentation is easy to understand, and the algorithm is easy to design. The internal difference of static rail information is also minimized. In some embodiments, when considering more features, the final merged segments can be more scattered with large number of segmentations. The difference of features within the same segment, such as inspection and/or maintenance and defect history, may be difficult to utilize in feature-based segmentation because they are point-specialized events (non-static).

### Dynamic-Feature-Based Segmentation

In some embodiments, a dynamic feature-based segmentation may be employed. Different from the above two segmentation strategies, dynamic-feature-based segmentation may include the segmentation strategy that uses an optimization model to minimize a predefined loss function to find the “best” segment length around a local milepost. In some embodiments, all features are used to calculate the information loss function to evaluate the internal difference of a segment. We can write the optimization model as

$$L = arg min Loss ( {A}^{n} ) \qquad ( 5 - 2 )$$

$$Loss ( A ) = {\sum }_{i ∈ [ 1 , m ]} {w}_{i} \cdot std ( {A}_{i}^{n} ) \qquad ( 5 - 3 )$$

Where:
Aⁿ: feature matrix with n rows (the number of 0.1-mile segments is n)
m: number of involved features
Aᵢⁿ: the i^{th} column of Aⁿ (i^{th} feature)
wᵢ: the weight associated with the i^{th} feature
std(Aᵢⁿ): the standard deviation of the i^{th} column of A

In some embodiments, with a fixed beginning milepost, find the best n that minimizes the loss function of Aⁿ. Aⁿ indicates a segment with length of n. The optimization model can be interpreted as: finding the best segment length to minimize the loss function, from all possible segment combinations. One example is illustrated in FIG. 5C. In some embodiments, to solve the optimization model, iteration algorithm may be used to optimize the segmentation and get the approximately optimal solution. In some embodiments, the loss function is also employed to find the best segment length. For the example shown in FIG. 5C, two features are involved for dynamic-feature-based segmentation, which are rail age and annual traffic density. The weights associated with the two features in the information loss function are assumed to be the same. To illustrate this type of segmentation, the minimum length of combined segment is set to 0.3 miles. It is shown that the minimum information loss is obtained at the original segment 8. Then the other segments are combined to develop another new segment.

In some embodiments, dynamic-feature-based segmentation takes all features (both time-independent or time-dependent) into consideration. The influence of the diversity of features can be controlled by changing the weights in the loss function. Dynamic-feature-based segmentation can also avoid the combined segments being too short. Therefore, this type of segmentation strategy might be more appropriate for network-scale broken rail prediction. In some embodiments, he computation may be time-consuming compared with fixed-length segmentation and static-feature-based segmentation. The development algorithm is more complex.

In some embodiments, to compare the performance of different segmentation strategies, numerical experiments may be conducted. In one example, the performance of three fixed-length segmentation setups, eight dynamic-feature-based segmentation setups, and one feature-based segmentation were tested and compared. In some embodiments, the area under the receiver operating characteristics (ROC) curve may be used as the metric. ROC is a graph showing the performance of a classification model at all classification thresholds. The area under the curve (AUC) measures the entire two-dimensional area underneath the entire ROC curve. AUC for the ROC curve may be a powerful evaluation metrics for checking any classification model's performance with two main advantages: firstly, AUC is scale-invariant and measures how well predictions are ranked, rather than their absolute values; and secondly, it is classification-threshold-invariant and measures the quality of the model's predictions irrespective of what classification threshold is chosen. In some embodiments, the higher the AUC, better the model is at predicting the classification problem.

In some embodiments, to compare the performance of different segmentation strategies, a machine learning classifier may be employed. For example, a Naïve Bayes classifier may be used as a reference model to evaluate the performance of a segmentation strategy. Naïve Bayes classifier can be trained quickly, however other any suitable classifier may be employed. In some embodiments, a Naïve Bayes classifier may have the added advantage for selection of the optimal segmentation strategy is fast computation speed. The segmented data selected by the Naïve Bayes method may later be applied in other machine learning algorithms.

An example of comparison result are shown in Table 5.4. U-0.2, U-0.5, and U-1.0 represent the fixed-length segmentation with constant segment length of 0.2 mile, 0.5 mile, and 1.0 mile, respectively. For the dynamic-feature-based segmentation, D-1 to D-8 represent eight alternative setups, in which varying feature weights in the loss function are assigned, respectively. In dynamic-feature-based segmentation, the involved features are categorized into four groups. Features in Group 1 are related to the number of car passes. Group 2 includes features which are associated with traffic density. Group 3 includes features which are related to the track layouts and rail characteristics, such as curve degree, rail age, rail weight etc. Features in Group 4 are associated with defect history and inspection and/or maintenance history, such as prior defect history and grinding passes. The feature weights assigned to each group in each dynamic-feature-based segmentation setups are in Table 5.5.

TABLE 5.4
Comparison of Different Segmentation Strategies

| | | | | Static | | | | | | | | |
|---|---|---|---|---|---|---|---|---|---|---|---|---|
| | Fixed-length | | | feature- | | | | | | | | |
| | segmentation | | | based | Dynamic-Feature-based segmentation | | | | | | | |
| | U-0.2 | U-0.5 | U-1.0 | segmentation | D-1 | D-2 | D-3 | D-4 | D-5 | D-6 | D-7 | D-8 |
| Average | 0.200 | 0.500 | 1.000 | 0.300 | 0.965 | 0.282 | 0.377 | 0.360 | 0.327 | 0.197 | 0.220 | 0.341 |
| segment | | | | | | | | | | | | |
| length | | | | | | | | | | | | |
| AUC | 0.705 | 0.704 | 0.700 | 0.813 | 0.832 | 0.777 | 0.821 | 0.793 | 0.796 | 0.825 | 0.827 | 0.804 |

TABLE 5.5
Feature Weights in Dynamic-Feature-based Segmentation

| | Group 1 | Group 2 | Group 3 | Group 4 |
|---|---|---|---|---|
| D-1 | 100 | 10 | 1 | 1 |
| D-2 | 1 | 1 | 1 | 1 |
| D-3 | 0 | 1 | 1 | 0 |
| D-4 | 1 | 0 | 0 | 0 |
| D-5 | 1 | 1 | 0 | 0 |
| D-6 | 10 | 5 | 1 | 1 |
| D-7 | 10 | 10 | 5 | 1 |
| D-8 | 20 | 20 | 1 | 1 |

As shown in Table 5.3, the dynamic-feature-based segmentation with the D-1 setup performs the best using the AUC as the metric. For the D-1 setup, features about number of car passes have the largest weight. Features about track and rail characteristics as well as features about defect history and inspection and/or maintenance history have the least weights in the loss function. The new segmented dataset includes approximately 664,000 segments including twenty timestamps. There are 37,162 segments experiencing at least one broken rail from 2012 to 2016, accounting for about 5.6% of the whole dataset. By comparison, in the original 0.1-mile dataset, there are 47,221 segments (1.1%) with broken rails among 4,143,600 segments.

### Broken Rail Prediction Model Development and Validation

In some embodiments, one or more machine learning algorithms may be employed to predict broken rail probability. To overcome challenges and develop an efficient, high-accuracy prediction model, an example of aspects of the embodiments of the present disclosure includes a customized Soft Tile Coding based Neural Network model (STC-NN) to predict the spatial-temporal probability of broken rail occurrence. Table 6.1 below presents nomenclatures, variables and operators use in the formulation of the STC-NN.

TABLE 6.1
Nomenclatures, Variables, and Operators

| Terminology | Explanation |
|---|---|
| STC-NN | Soft-Tile-Coding-based Neural Network |
| NN | Neural Network |
| MCP | Multi-Classification Problem |
| BCP | Binary Classification Problem |
| TPTR | Total Predictable Time Range, describing the upper |
| | time limit of the STC-NN model |
| FIR | Feeding Imbalance Ratio |
| IR | Imbalance Ratio |
| TPR | True positive rate |
| FPR | False positive rate |
| AUC | Area under receiver operating characteristics curve |
| Variable | Denotation |
| t | A variable representing a timestamp or a time range |
| T | Lifetime for the broken rail to be observed for one |
| | segment |
| m | The number of tiling for soft-tile-coding |
| n | The number of tiles in a tiling |
| dⱼ | The initial offset of the jth tiling |
| ΔT | The length of the time range of each tile |
| F(T\|m, n) | Tile-encoded vector of a lifetime T with parameter m |
| | and n |
| S(T\|m, n) | Soft-tile-encoded vector of a lifetime T with parameter |
| | m and n |
| θ | The weights of a neural network |
| g | An input feature set of one rail segment |
| p(g\|θ) | The output soft-tile-encoded vector of the STC-NN |
| | model with parameters θ, given input feature set g |
| G | {g₁, g₂, . . . , g_{N}} is a batch of input feature set |
| T | {T₁, T₂, . . . , T_{N}} is a batch of input lifetime |
| | corresponding to G |
| Pᵢⱼ | The output probability of the jth tile in the ith tiling. |
| rᵢⱼ(T) | The effective coverage ratio of the jth tile in the ith tiling |
| Pᵢ*ⱼ | The probability density of the jth tile in the ith tiling |
| | [symbol] [iΔT + dⱼ, (i + 1)ΔT + dⱼ) ∩ [0, T] [symbol] is the length of |
| tᵢⱼ(T) | intersection between time range of the jth tile in the ith |
| | tiling and the range t ϵ [0, T] |
| L(g, T\|θ, m, n) | The loss function of STC-NN model |
| α | The learning rate of training algorithm of STC-NN |
| | model |
| T₀ | A lifetime threshold used to cut out a lifetime into |
| | binary value |
| P₀ | A probability threshold used to cut out a cumulative |
| | probability into binary value |
| Lᵣ(Tᵢ\|T₀) | The binary label generated from a lifetime, given T₀ as |
| | the threshold |
| Lₚ(T\|P₀) | The binary label generated from P(t < T), given P₀ as |
| | the threshold |
| Operator | Denotation |
| P(t < T) | The cumulative probability of broken rail within t ϵ |
| | [0, T) |
| (a, b) | A mapping from vector a to vector b |
| [a, b], [a, b), | A range from a to b |
| (a, b] | |
| {•} | A set with discrete elements |
| [symbol] • [symbol] | An operator to obtain the length of a set with |
| | continuous values |

### Feature Engineering

In some embodiments, formulation of the STC-NN may include Feature Engineering, which may include feature creation, feature transformation, and feature selection. Feature creation focuses on deriving new features from the original features, while feature transformation is used to normalize the range of features or normalize the length-related features (e.g. number of rail defects) by segment length. Feature selection identifies the set of features that accounts for most variances in the model output.

### Feature Creation

In some embodiments, the original features in the integrated database may include:
Rail age (year), which is the number of years since the rail may be first laid
Rail weight (lbs/yard)
New rail versus re-laid rail
Curve degree
Curve length (mile)
Spiral (feet)
Super elevation (feet)
Grade (percent)
Allowed maximum operational speed (MPH)
Signaled versus non-signaled
Number of turnouts
Ballast cleaning (miles)
Grinding passes (miles)
Number of car passes
Gross tonnages
Number of broken rails
Number of rail defects (by type)
Number of track geometry exceptions (by type)
Number of vehicle-track interaction exceptions (by type)

### Feature Transformation

In some embodiments, a feature transformation process may be employed to generate features such as, e.g., Cross-Term Features, Min-Max Normalization of features, Categorization of Continuous Features, Feature Distribution Transformation, Feature Scaling by Segment Length and any other suitable features created via feature transformation.

In some embodiments, cross-term features may include interaction items. In some embodiments, cross-term features can be products, divisions, sums, or the differences between two or more features. In addition to finding the product of rail age and traffic tonnages, the products of rail age and curve degree, curve degree and traffic tonnage, rail age and track speed, and others are also created. The division between traffic tonnage and rail weight is calculated. In terms of the sums of some features, the aim is to combine sparse classes or sparse categories. Sparse classes (in categorical features) are those that have very few total observations, which might be problematic for certain machine learning algorithms, causing models to be overfitted. Taking rail defect types as an example, there are more than ten different types of rail defect recorded in the rail defect database. However, several rail defect types rarely occur, which belong to sparse classes. To avoid sparsity, we group similar classes together to form larger classes (with more observations). Finally, we can group the remaining sparse classes into a single “other” class. There is no formal rule for how many classes that each feature needs. The decision also depends on the size of the dataset and the total number of other features in the database. Later, for feature selection, we test all possible cross-term features originating from raw features in the database, and then select the optimal combination of features to improve the model performance. The creation of cross-term features is done based on the data structure and domain expertise. The selection of cross-term features is conducted based on model performance.

The range of values of features in the database may vary widely; for instance, the value magnitudes for traffic tonnage and curve degree can be very different. For some machine learning algorithms, objective functions may not work properly without normalization. Accordingly, in some embodiments, Min-Max normalization may be employed for feature normalization, which may enable each feature to contribute proportionately to the objective function. Moreover, feature normalization may speed up the convergences for gradient descent which are applied in various machine algorithm trainings. Min-max normalization is calculated using the following formula:

$${x}_{n e w} = \frac{x - min ( x )}{max ( x ) - min ( x )} \qquad ( 6 - 1 )$$

where x is an original value, and x_{new} is the normalized value for the same feature.

In some embodiments, there may be two types of features: categorical (e.g. signaled versus non-signaled) and continuous (e.g. traffic density). In some embodiments, continuous features may be transformed to categorical features. For instance, track speed is in the range of 0 to 60 mph, which can be categorized in accordance with track class, in the range of [0,10], [10,25], [25,40], [40-60], which designates track classes from 1 to 4, respectively.

In some embodiments, distributions of continuous features values may be tested, and some features may be identified as distributed skewed towards one direction. In some embodiments, transformation functions may be applied to transform the feature distribution into a normal distribution, in order to improve the performance of the prediction. For example, FIG. 6A plots the distributions of traffic tonnages before and after feature transformation. The distribution of raw traffic tonnages is distributed skewed towards smaller values. However, traffic tonnages are distributed approximately normally after logarithmic transformation.

In some embodiments, after network segmentation based on input features, the segment lengths may vary widely. Due to the aggregation function of summation during segmentation, the values of some features over the segments are proportional to segment lengths. In some embodiments, to avoid repeated consideration of the impact of segment length, feature scaling by segment length may applied to the related features, such as the total number of rail defects and track geometry exceptions over the segments. In this way, the density of some feature values by segment length may calculated. However, there are some segments with very small segment lengths. The density of the features for these short segments cannot represent the correct characteristics due to the randomness of occurrence.

### Feature Selection

Feature selection is the process in which a subset of features are automatically or manually selected from the set of original ones to optimize the model performance using defined criteria. With feature selection, features contributing most to the model performance may be selected. Irrelevant features may be discarded in the final model. Feature selection can also reduce the number of considered features and speed up the model training. One of the most prevalent criteria for feature selection is the area under the operating characteristics curve (aka. AUC).

In some embodiments, a machine learning algorithm called LightGBM (Light Gradient Boosting Model) may be used for feature selection considering its fast-computational speed as well as an acceptable model performance based on the AUC. In feature selection, there are thousands of possible combinations of features. It is impossible to scan all possible combinations of features to search for the optimal subset of features. In some embodiments, this optimization-based feature selection method, forward searching, backward searching and simulated annealing techniques are used in steps:

Step 1. In forward searching, select one feature each time to be added into the combination in order to maximally improve AUC, until the AUC is not improved further.

Step 2. Use backward searching to select one feature to be removed from the combination of features obtained from step 1, in order to maximally improve AUC, until AUC is not improved further.

Step 3. After step 2, make multiple loops between step 1 and step 2 until the AUC is not improved further.

Step 4. Because forward searching and backward searching select the features greedily, it is possible to result in a local optimal combination of features for forward searching and backward searching. The simulated annealing algorithm makes the local optima stand out amidst the combination of features. In this step, record the current combination of features with local optima and the corresponding AUC. Then, add a pre-defined potential feature which is not in the current combination and then repeat steps 1 to 4 until the AUC cannot be improved further. The pre-defined potential feature is selected based on the feature performance in step 1.

Step 5. First, create the cross-term features based on the combination of features obtained from step 4. After creating the cross-term features, repeat steps 1 to 4 until obtaining the optimal combination of current features. Due to the computational complexity of step 5, cross-term development is only conducted one time. In the process, we use an indicator N to represent whether creation of cross-term features has been conducted or not. If N is equal to “False”, then create cross-term features and repeat steps 1 to 4. If N is equal to “True”, then the optimal combination of features has been obtained and the process is complete.

In an example of feature selection in use as shown in FIG. 6B, the number of variables involved in the model (including dummy variables) is about 200. After feature selection, the top 10 variables are selected. FIG. 6B lists the 10 features chosen from the original 200 features.
Segment Length: The length of the segment (mile)
Traffic_Weight: The division between annual traffic density and rail weight (annual traffic density divided by rail weight)
Car_Pass_fh: The number of car passes in the prior first half year
Rail_Age: The year between the research year and the rail laid year
Defect_hf: The number of detected defects in the prior first half year
Curve Degrees: The curve degree
Turnout: The presence of turnout
Service_Failures_fh: The number of detected service failures in the prior first half year
Speed*Segment Length: The product of the maximum allowed track speed and the segment length
Age_Curve: The product of the rail and curve degree

In some embodiments, as shown in FIG. 6B, segment length shows the highest importance rate, and the ratio between annual traffic density and traffic weight is the second most important. Table 6.2 justifies the impacts of the important features on the broken rail probability. A comparison of the distribution of the important features among different tracks may be conducted. Two distributions of the important features are calculated, one for the top 100 track segments with the highest predicted broken rail probabilities, the other for the entire railway network.

In some embodiments, according to Table 6.2, the top 100 track segments (with highest estimated broken rail probabilities) have larger average lengths. The distributions of traffic/weight for the railway network and the top 100 track segments appear to be different, which reveals that track segments with larger traffic/weight are prone to having higher broken rail probabilities. The statistical distributions of the number of car passes and rail age also illustrate that higher broken rail probability is associated with higher rail age and more car passes on the track.

TABLE 6.2
Selected Features on Top 100 Segments versus the Whole Network

| | | | Traffic (MGT)/Rail | | Number of | | Rail Age | |
|---|---|---|---|---|---|---|---|---|
| | Segment Mileage | | Weight (lbs/yard) | | car passes | | (years) | |
| | | Top 100 | | Top 100 | | Top 100 | | Top 100 |
| | Network | Segments | Network | Segments | Network | Segments | Network | Segments |
| Mean | 0.20 | 3.24 | 0.16 | 0.32 | 247,435 | 465,958 | 25 | 36 |
| 25% | 0.04 | 1.44 | 0.04 | 0.18 | 85,097 | 277,319 | 11 | 32 |
| 50% | 0.10 | 2.62 | 0.14 | 0.32 | 225,740 | 474,450 | 25 | 38 |
| 75% | 0.21 | 4.15 | 0.14 | 0.42 | 356,337 | 641,610 | 36 | 44 |

### Overview of the Proposed STC-NN Algorithm

In some embodiments, to address the challenges of predicting broken rail occurrence by location and time, a Soft-Tile-Coding-Based Neural Network (STC-NN) is employed. As illustrated in FIG. 6C, the model framework includes five parts: (a) Dataset preparation; (b) Input features; (c) Encoder: soft-tile-coding of outcome labels; (d) Model architecture; and (e) Decoder: probability transformation.

In some embodiments, in part (a), dataset preparation, an integrated dataset may be developed which include input features and outcome variables. The outcome variables are continuous lifetimes, which may have a large range. The lifetime may be exact lifetime or censored lifetime. In some embodiments, the exact lifetime is defined as the duration time from the starting observation time to the occurrence time of the event of interest, while censored lifetime is the duration from the starting time to the ending observation time if no event occurs. In some embodiments, input features may be categorical or continuous variables. In some embodiments, for categorical features, one-hot encoding is applied to transform categorical features into a binary vector, in which only one element is 1 and the summation of the vector is equal to 1.

In some embodiments, to improve computational efficiency and model convergence for continuous features, min-max scaling may be employed to rescale the continuous features in the range from zero to one. Scaling the values of different features on the same magnitude efficiently avoids neuron saturation when randomly initializing the neural network. In other words, without scaling features, the coefficients of the features with larger magnitude may be smaller. The coefficients of features with smaller magnitude may be larger.

In some embodiments, in original datasets, the outcome variables may be continuous lifetime values. In some embodiments, a special soft-tile-coding method may be used to transform the continuous outcome into a soft binary vector. Similar to a binary vector, the summation of a soft binary vector is equal to one. The difference is that the soft binary indicates that the feature vector not only consists of the values of 0 and 1, but also of some decimal values such as 1/n (n=2, 3, . . . ). We refer to this kind of soft binary vector as a soft-tile-encoded vector in some embodiments.

In some embodiments, after the encoding process of input features and outcome variables, a customized Neural Network with a SoftMax layer is utilized to learn the mapping between the input features and the encoded output labels. Specifically, the output of the SoftMax layer corresponds to the encoded output label using the soft-tile-coding technique. The customized Neural Network with its output related to a soft-tile-encoded vector may be named as the STC-NN model.

In some embodiments, a decoder process for the soft-tile-coding may be employed. The decoding process may be a method that transforms a soft-tile-encoded vector into its probability along its original continuous lifetime. Instead of obtaining one output, the STC-NN algorithm may obtain a probability distribution of broken rail occurrence within any specified study period.

### Encoder: Soft-Tile-Coding

In some embodiments, tile-coding is a general tool used for function approximation. In some embodiments, the continuous lifetime is partitioned into multiple tiles. These multiple tiles may be used as multiple categories, and each category relates to a unique time range. In some embodiments, one partition of the lifetime is called one tiling. Generally, multiple overlapping tiles are used to describe one specific range of the lifetime. There is a finite number of tiles in a tiling. In each tiling, all tiles have the same length of time range, except for the last tile.

For a tile-coding with m tilings and each with n tiles, for each time moment T on the lifetime horizon, the encoded binary feature is denoted as F(T|m, n), and the element Fᵢⱼ(T) is described as:

$${F}_{i j} ( T ) = \{ \begin{matrix}1 , & T ∈ [ i Δ T - {d}_{j} , ( i + 1 ) Δ T - {d}_{j} ) \\ 0 , & otherwise\end{matrix} ; \qquad ( 6 - 2 )$$

$$i = 1 , 2 , … , n ; j = 1 , 2 , … , m$$

where ΔT is the length of the time range of each tile, and dⱼ is the initial offset of each tiling.

FIG. 6D illustrates two examples for tile-coding of two lifetime values at time (a) and (b) with three tilings (m=3) which include four tiles (n=4). It is found that time (a) is located in the tile-1 for tiling-1, and in the tile-2 for both tiling-2 and tiling-3. The encoded vector of time (a) is given by (1,0,0,0 | 0,1,0,0 |0,1,0,0)^{T}. Similarly, for time (b) we get (0,0,1,0 | 0,1,0,1 |0,0,0,1)^{T}.

In some embodiments, a specific lifetime value may be encoded into a binary vector using tile-coding if an event occurs. However, in some situations, no events occur during the observation time and the event of interest is assumed to happen in the future. In this case, the censored lifetime may be obtained, and the exact lifetime may be unavailable. The other types of tile-coding functions may not be capable of encoding this censored data. To address this issue, the soft-tile-coding function is implemented.

In some embodiments, the soft-tile-coding function is applied to transform the continuous lifetime range into a soft-binary vector, which is a vector whose value is in range [0, 1]. When the event of interest is not observed before the end of observation, the lifetime value is censored, and exact lifetime is not observed. Although the exact lifetime for the event may be unknown, the event of interest does not occur within the observation time period. Similarly, whether the event may happen in the future is unknown, beginning at the current ending observation time. By using soft-tile-coding, this information can be leveraged to build a model and achieve better prediction performance. In some embodiments, the mathematical process is as follows:

For a soft-tile-coding with m tilings, each with n tiles, given a time range T∈ [T₀, ∞) on the timeline, the encoded binary feature is denoted as S(T|m, n), and the element Sᵢⱼ(T) is described as:

$${S}_{i j} ( T ) = \{ \begin{matrix}1 / {k}_{j} , & i \geq n - {k}_{j} + 1 \\ 0 , & otherwise\end{matrix} ; \qquad ( 6 - 3 )$$

$$i = 1 , 2 , … , n ; j = 1 , 2 , … , m$$

Where:

$${k}_{j} = {arg max}_{j} {F}_{j} ( {T}_{0} ) \qquad ( 6 - 4 )$$

and Fⱼ(T₀) is the encoded binary feature vector of the jth tiling using tile-coding.

One example of soft-tile-coding with three tilings (m=3), each of which include four tiles (n=4), is illustrated in FIG. 6E. It is found that the time T is located in the tile-3, tile-3, and tile-4 for tiling-1, tiling-2, and tiling-3, respectively. The soft-tile-encoded vector is given as (0, 0, 0. 5, 0. 5 | 0, 0, 0. 5, 0. 5 | 0, 0, 0, 1)^{T}. In comparison, the tile-encoded vector is (0, 0, 1, 0 |0, 0, 1, 0 |0, 0, 0, 1)^{T}.

### Architecture of STC-NN Model

### Forward Architecture of STC-NN Model

In some embodiments, as presented in FIG. 6F, the forward architecture of STC-NN model is mainly based on a Neural Network. There may be multiple processes to get from the input features to the output probability of event occurrence over time. In some embodiments, there may be three main parts of the model: (1) a neural network, (2) a SoftMax layer with multiple SoftMax functions, and (3) a decoder: probability transformation. The input of the model is transformed into a vector with values in range [0, 1]. The input vector is denoted as g={gᵢ∈[0, 1]|i=1, 2, . . . M}. The hidden layers are densely connected with a nonlinear activation function specified by the hyperbolic tangent, tanh(•).

There are m×n output neurons of the neural network, which connect to a SoftMax layer with m SoftMax functions. Each SoftMax function is bound with n neurons. The mapping from the input g to the output of the SoftMax layer can be written as p(g|θ), where θ is the parameter of the NN. According to Definition 2, p(g|θ) is a soft-tile-encoded vector with parameter m and n.

In some embodiments, the soft-tile-encoded vector p(g|θ) is an intermediate result and can be transformed into probability distribution by a decoder.

### Backward Architecture of STC-NN Model

In some embodiments, the backward architecture of the STC-NN model for training is presented in FIG. 6G. Given a feature set as input, we can obtain a soft-tile-encoded vector after the SoftMax layer. Instead of going further for probability transformation, in the training process the soft-tile-encoded vector is used as the final output and a loss function can be defined as Eq. (6-5):

$$ℒ ( g , T \vert θ , m , n ) = \frac{1}{2} {‖ p ( g \vert θ ) - F ( T \vert m , n ) ‖}^{2} \qquad ( 6 - 5 )$$

where, p(g|θ) is the output of the STC-NN model, given input g with parameters θ. F(T|m, n) is a tile-encoded vector if the feature set g relates to an observed lifetime T; otherwise, F(T|m, n)=S(T|m, n), which is a soft-tile-encoded vector if the feature set g relates to an unknown lifetime during the observation period with length T.

Given a training dataset with batch size of N, denoted as {G={g₁, g₂, . . . , g_{N}}, T={T₁, T₂, . . . , T_{N}}}, the overall loss function can be written as:

$$ℒ ( G , T \vert θ , m , n ) = \frac{1}{2} {\sum }_{i = 1}^{N} {‖ p ( {g}_{i} \vert θ ) - F ( {T}_{i} \vert m , n ) ‖}^{2} \qquad ( 6 - 6 )$$

In some embodiments, the training process is given as an optimization problem—finding the optimal parameters θ*, such that the loss function [symbol] (G,T|θ,m,n) is minimized, which is written as Eq. (6-7).

$${θ}^{*} = {arg min}_{θ} ℒ ( G , T \vert θ , m , n ) \qquad ( 6 - 7 )$$

In some embodiments, the optimal solution of θ* can be estimated using the stochastic gradient descent (SGD) algorithm, which is achieved by randomly picking one record {gᵢ, Tᵢ} from the dataset, and following the updated process using Eq. (6-8):

$$θ ← θ - α \cdot \frac{\partial p ( {g}_{i} \vert θ )}{\partial θ} \cdot ( p ( {g}_{i} \vert θ ) - F ( {T}_{i} \vert m , n ) ) ; \qquad ( 6 - 8 )$$

$$i = 1 , 2 , … , N$$

where α is the learning rate and ∂p(gᵢ|θ)/∂θ is the gradient (first-order partial derivative) of the output soft-tile-encoded vector to parameter θ. In some embodiments, the calculation of the gradients ∂p(gᵢ|θ)/∂θ is based on the chain rule from the output layer backward to the input layer, which is known as the error back propagation. In some embodiments, a mini-batch gradient descent algorithm is employed instead of a pure SGD algorithm to balance the computation time and convergence rate, however any suitable gradient descent algorithm may be employed.

### Training Algorithm of STC-NN Model

In some embodiments, different from the training algorithms commonly used for typical NNs, the training algorithm of STC-NN is customized to deal with the skewed distribution in the database. For a rare event, the dataset recording it can be highly imbalanced (i.e. more non-observed events than the observed events of interest due to their rarity). In some embodiments, the overall occurrence probability of broken rail has been found to be about 4.34%. According to Definition 3, the IR of the broken rail dataset is about 22:1.

In some embodiments, to enhance the performance of the STC-NN model, instead of feeding the data randomly, a constraint may be utilized for fed model data (training data) in the training process. The definition of Feeding Imbalance Ratio (FIR) is described below.

For example, if FIR=1, it means that we feed each mini-batch of data with half including events and the other half without events. When FIR=22, the ratio between non-event and event in the dataset fed into the model is the same as the original dataset. If the FIR is too large, the dataset fed into the model may be imbalanced, and it may be hard to learn the feature combination related to the event occurrence. However, if the FIR is too small, the features related to the event are well learned by the model, but it may lead to a problem of over-estimated probability of the event occurrence. The pseudo code of the training algorithm is presented as follows:

Input:

| | |
|---|---|
| [symbol] | FIR, batch_size, n_epoch, m, n, α |
| [symbol] | Training dataset: (G, T); |
| [symbol] | The numbers of layers and neurons of neural network; |

Initialize:

| | |
|---|---|
| [symbol] | Initialize a neural network p(* \|0); |
| [symbol] | Split the (G, T) into (G, T)⁺ and (G, T)⁻ according to broken rail occurrence; |

Main:
For_in range (n_epoch), do

```
(G, T)⁺ = (G, T)⁺.shuffle( )
(G, T)⁻ = (G, T)⁻.shuffle( )
For_in range (round(size((G, T)⁺)/batch_size)), do
  (G, T)ᵢ⁺ = (G, T)⁺.next_batch(batch_size)
  (G, T)ᵢ⁻ = (G, T)⁻.next_batch( FIR* batch_size)
  Fᵢ⁺ = tile_coding(Tᵢ⁺)
  Sᵢ⁻ = soft_tile_coding(Tᵢ⁻)
  (G, F)ᵢ = shuffle(concat(Gᵢ⁺, Gᵢ⁻), concat(Fᵢ⁺, Sᵢ⁻))
  Update the parameter θ of p(* |θ) given mini-batch (G, F)ᵢ.
End For
```

End For
Output: The neural network p(* |θ).

Note: all superscript + and − indicate records with and without broken rails, respectively.

### Decoder: Probability Transformation

In some embodiments, the decoder of soft-tile-coding may be used to transform a soft-tile-encoded vector into a probability distribution with respect to lifetime. Given the input of a feature set g, soft-tile-encoded output p(g|θ)={pᵢⱼ|i=1, . . . n; j=1, . . . m} may be obtained through the forward computation of the STC-NN model. Since p(g|θ) is an encoded vector, a decoder-like operation may be used to transform it into values with practical meanings. In some embodiments, the decoder of soft-tile-coding may be defined according to Definition 5 described above and as follows:
Definition 5: Soft-tile-coding decoder. Given a lifetime value T∈[0, ∞), and a soft-tile-encoded vector p={pᵢⱼ|=1, . . . n; j=1, . . . m}, the occurrence probability P(t<T) may be estimated as:

$$P ( t < T ) = \frac{1}{m} {\sum }_{i = 1}^{m} {\sum }_{j = 1}^{n} {p}_{i j}^{*} \cdot {r}_{i j} ( T ) \qquad ( 6 - 9 )$$

where, m and n are the number of tilings and tiles respectively; p*ᵢⱼ and rᵢⱼ(T) are the probability density and effective coverage ratio of the j-th tile in the i-th tiling, respectively. The value of p*ᵢⱼ can be calculated using pᵢⱼ divided by the length of time range of the corresponding tile. Note that there is no meaning for time t<0, so the length of the first tile of each tiling should be reduced according to the initial offset dⱼ, and we get p*ᵢⱼ as follows.

$${p}_{i j}^{*} = \{ \begin{matrix}{p}_{i j} / Δ T , & i > 1 \\ {p}_{i j} / ( Δ T - {d}_{j} ) , & i = 1\end{matrix} \qquad ( 6 - 10 )$$

In some embodiments, the effective coverage ratio rᵢⱼ(T) can be calculated according to Eq. (6-11):

$${r}_{i j} ( T ) = \{ \begin{matrix}{t}_{i j} ( T ) / ΔT , & i > 1 \\ {t}_{i j} ( T ) / ( Δ T - {d}_{j} ) , & i = 1\end{matrix} \qquad ( 6 - 11 )$$

where, tᵢⱼ(T)= [symbol] [iΔT+dⱼ, (i+1)ΔT+dⱼ)∩[0, T]] [symbol] is the length of intersection between time range of the jth tile in the i^{th} tiling and the range t∈[0, T]. The operator [symbol] • [symbol] is used to obtain the length of time range.

In some embodiments, according to Definitions 2 and 5, it may be verified that P(t=0)=0 and P(t<T|T→∞)=1. And P(t<T) can be interpreted as the accumulative probability of event occurrence within the lifetime T. An example of the soft-tile-coding decoder is given in FIG. 6H. The vector p is the output of the STC-NN model and the red rectangles on the tiles are tᵢⱼ(T).

In some embodiments, there is an upper time limit when the essential parameter n and ΔT are determined. In some embodiments, Definition 6 may specify the total predictable time range of the STC-NN model.

In some embodiments, the TPTR of the STC-NN model is defined as TPTR=(n−1)ΔT, where n is the number of tiles in each tiling and ΔT is the length of each tile. In some embodiments, n tiles in each tiling cover the lifetime range between starting observation time and maximum failure time among all the research data. Normally, the failure has not been observed till the ending observation time which is called as censored data in survival analysis. Therefore, the maximum failure time among all the data should be infinite. The first n−1 tiles are set with a fixed and finite time length of ΔT which covers the observation period. The last tile covers the time period t>(n−1)ΔT which is beyond the observation. No additional information about the failure time is provided by the last tile for the prediction. In some embodiments, therefore, the effective total predictable time range (TPTR) equals (n−1)ΔT.

### Model Development

In some embodiments, after the dataset is prepared, the dataset may be split into the training dataset and test dataset according to different timestamps. In some embodiments, the data from 2012 to 2014 are used for training, while the data from 2015 and 2016 are used as a test dataset to present the result.

In some embodiments, the STC-NN model is developed and trained with the training dataset. In some embodiments, an example of the default parameters of the STC-NN model are presented in Table 6.3. There are 50 tilings, each with 13 tiles. The length of each tile ΔT is 90 days, which means the TPTR of the STC-NN model is 3 years. Furthermore, the parameters of the training process are presented in Table 6.3. Note that in some embodiments the learning rate is set to be 0.1 initially, and then decreases by 0.001 for each epoch of training.

TABLE 6.3
Parameter Setting of STC-NN Model

| Parameter | Value |
|---|---|
| m | 50 |
| n | 13 |
| ΔT | 90 days |
| dⱼ | Randomly generated from a uniform |
| | distribution between [0, ΔT) |
| FIR | 1 |
| batch_size | 128 |
| n_epoch | 20 |
| α | 0.1, decreasing by 0.001 for each epoch of training. |
| Hidden layers | 2 layers, each with 200 neurons. |
| of NN | |

### Cumulative Probability and Probability Density

In some embodiments, 100 segments may be randomly selected from the test dataset to illustrate the output of the STC-NN model as shown in FIG. 6I where Jan indicates January 1st; Jul indicates July 1st; plot (a) shows a cumulative probability with timestamp January 1st; plot (b) shows cumulative probability with timestamp July 1st; plot (c) shows a probability density with timestamp January 1st; plot (d) shows a probability density with timestamp July 1st. The left two plots (a) and (c) show the cumulative probability and probability density respectively with timestamp (starting observation time) January 1, and the right two, (b) and (d), show these with the timestamp July 1. In some embodiments, the overall length of the time axis is 36 months which equals to the total predictable time range. As shown in FIGS. 6I(a) and 6I(b), the slope of the cumulative probability curve varies in terms of time axis. The time-dependent slope of cumulative probability is measure in the probability density in terms of time axis which are plotted as FIG. 6I(c) and FIG. 6I(d). The probability density is a wave-shaped curve which represents the fluctuation periodically. In FIG. 6I(c) and FIG. 6I(d), the peaks of the probability density curve occur regularly with a time circle which is proved to be one year.

In some embodiments, the probability density represents the hazard rate or broken rail risk with respective to the time axis. FIGS. 6I(c) and 6.9(d) state that the broken rail risk varies in one year and the highest broken rail risk is associated with a time moment in one year. With the timestamp being same, the probability density curves of different segments have the same shape. The values of the probability density given a time moment are different which is due to the variant characteristics associated with different segments.

### Illustrative Comparison Between Two Typical Track Segments

In some embodiments, two example segments are selected from the test dataset to illustrate details of the cumulative probability and probability density. In some embodiments, some main features for the two selected segments are listed in Table 6.4. In some embodiments, there may be over one hundred features (raw features and their transformations or combinations). However, in the example of Table 6.4 only some of the most determinative features for the output are shown. The table shows that Segment A is 0.3 miles in length with 135 lbs/yard rail and it has been in service for 18.7 years, while Segment B is 0.5 miles in length with 122 lbs/yard rail and its age is 37 years. As for the broken rail occurrence, compared to Segment A where no broken rail may be observed, there is a broken rail found at Segment B in 341 days with the starting observation date of Jan. 1, 2015.

TABLE 6.4
Comparison of Two Segments from the Test Dataset

| Features | Segment A | Segment B |
|---|---|---|
| Division | D1 | D1 |
| Prefix | AAA | BBB |
| Track type | Single track | Single track |
| Starting observation date | Jan. 1, 2015 | Jan. 1, 2015 |
| Rail weight (lbs/yard) | 135 | 122 |
| Rail age (years) | 18.7 | 37 |
| Curve or not | With curve | With curve |
| Annual traffic density | 25.12 MGT | 23.57 MGT |
| Segment Length (miles) | 0.3 | 0.5 |
| Broken rail occurrence | None found in | Found in |
| | two years | 341 days |

In some embodiments, using the trained STC-NN model, the broken rail occurrence probabilities of these two segments are predicted and the results are presented in FIG. 6J, where pink lines represent the prediction with January 1st as the starting observation time (timestamp), and blue lines represent the prediction with July 1st as the starting observation time (timestamp). The top two figures show the cumulative probability and probability density of Segment A, while the bottom two show the cumulative probability and probability density for Segment B. The blue and pink curves represent the timestamps of January 1st and July 1st, respectively.

In some embodiments, some assumptions and parameters are generated during the development of the STC-NN Classifier. Thus, in some embodiments, sensitivity analysis is performed to test the reasonability of the model setting.

### Training Step Analysis

In some embodiments, training step in neural network is an important parameter that may affect the model performance on both the training data and test data. In some embodiments, in the sensitivity analysis of training step, the range of test training step is from 50 to 500. FIG. 6K plots the according values of AUC for one season and one year during the test of training step. In some embodiments, the AUC for one season and one year increases as the training step increases for the training data, while the AUC for test data decreases as the training step increases.

In some embodiments, the possible reason for this is that more training step increases the complexity of the classifier model and is further increasing the performance of the classifier on the training data. However, the complexity of the model affects the generalization of the model. The more complex the model is, the less generalized the model is. Less generalizability of the model may result in an overfitting problem, leading to decreased model performance for the testing data.

### Sensitivity Analysis of Model Parameters

In some embodiments, many of the parameters presented have significant influence on the performance of the STC-NN model. In some embodiments, the model parameters can be divided into three groups according to their functions: (1) soft-tile-coding of the output label: number of tilings m, number of tiles in each tiling n, length of each tile ΔT, the initial offset of each tiling dⱼ; (2) the FIR used in the training algorithm; and (3) the nonlinear function approximation using neural network: the training step n_epoch, learning rate a, the batch size batch_size and the number of hidden layers and neurons.

In some embodiments, since a part of the STC-NN model is a neural network with multiple layers, so the influence of n_epoch, a, batch_size and the numbers of hidden layers and neurons can be tuned similarly as commonly used neural networks. For illustrative convenience, the influence of the parameters of soft-tile-coding and the FIR during the training process is examined.

In some embodiments, for soft-tile-coding, the number of tilings m should be large enough so that the decoded probability can be smooth. Otherwise, the probability density may become stair-stepping. Especially, when m=1, the STC-NN model degenerates into a model for the Multi-Classification Problem (MCP). The ΔT and n together influence the TPTR. Firstly, some embodiments determine TPTR according to the maximal lifetime observed from the training dataset. Secondly, some embodiments give a proper value of ΔT and, finally, calculate the number of tiles needed to keep TPTR unchanged. In an extreme condition, if we use ΔT=TPTR, n=2 and m=1, the STC-NN model degenerates into a model for the Binary Classification Problem (BCP).

To analyze the influence of FIR on the performance of the STC-NN model, a replication experiment is carried out, where the training algorithm is executed 10 times to evaluate the AUC of each FIR in {1, 2, 3, 4, 5, 7, 10, 15, 22}. The results are presented using box-plot, as shown in FIG. 6L, where the red notch is the median value, and the upper and lower limit of the blue box show the 25% and 75% percentile, respectively. Figures (a), (b) and (c) in FIG. 6L are related to one-month, one-season and one-year time prediction period, respectively. It shows that the AUCs decrease and the variance of AUCs gets larger if we use larger FIR values, indicating that the prediction accuracy becomes lower and the result becomes more unstable when the mini-batch of data fed into the dataset is more imbalanced. When the value of FIR equals 22, which is the exact IR of the training dataset, most of the AUCs are less than 0.8, and some even become less than 0.7 within the one-year time scope. The large variance indicates that the performance is unstable, and the results may be hard to repeat. In contrast, if we set FIR to be 1, the AUCs outperform all those with FIR>1 and the variance is very small as well, indicating that the result is more stable and repeatable.

### Model Validation

### Model Performance by Prediction Period

In some embodiments, for a given observation time T₀, the reference label Lᵣ(Tᵢ|T₀) may be given as follows:

$${L}_{r} ( {T}_{i} \vert {T}_{0} ) = \{ \begin{matrix}1 , & {T}_{i} < {T}_{0} \\ 0 & otherwise\end{matrix} ; \qquad ( 6 - 12 )$$

$$i = 1 , 2$$

where Tᵢ is the lifetime of the i-th segment from the test dataset. Eq. (6-12) can be interpreted as a binary operator that labels Tᵢ as 1 if Tᵢ is less than T₀, otherwise labelling it as 0.

In some embodiments, given the same observation time T₀, the cumulative probability at time T₀ can be determined as its predicted probability. When given a specific threshold P₀∈[0, 1], the predicted probability can be transferred into a binary vector as shown in Eq. (6-13).

$${L}_{p} ( {T}_{0} \vert {P}_{0} ) = \{ \begin{matrix}1 , & P ( t < {T}_{0} ) > {P}_{0} \\ 0 , & otherwise\end{matrix} \qquad ( 6 - 13 )$$

In some embodiments, once Lᵣ(Tᵢ|T0) and Lₚ(T₀|P₀) have been obtained, the prediction can be made as a binary classification, and the true positive rate (TPR), false positive rate (FPR), and the confusion matrix may be calculated. In some embodiments, by testing the results with different values of P₀∈[0, 1], a sequence of TPRs and FPRs can be determined, and the AUC for a specific T₀ may be estimated.

FIG. 6P shows a comparison of the cumulative probability over time between the segments with (blue color line) and without (red color line) broken rails, respectively for some embodiments of the present disclosure. In some embodiments, the four sub-figures from (a) to (d) show the cumulative probabilities at half-year, one-year, two-years and 2.5-years, respectively. For a short-term period, such as one-half year, the red curve (without observed broken rails) and blue curve (with observed broken rails) are separated. As the prediction period gets longer, the cumulative probability curves overlap for the blue and red, making it difficult to separate the two curves. It is this characteristic that leads to the decreasing trend of AUCs over time, as shown in FIG. 6P(b). In some embodiments, for long term prediction, the input feature set changes during the ‘long term’ as time-dependent factors such as traffic, rail age, geometry defects and some other inspection and/or maintenance are highly time-variant.

### Comparison Between Empirical and Predicted Number of Broken Rails

In some embodiments, to illustrate the model performance, this research also compares the empirical number of broken rails and predicted number of broken rails in one year on the network level. As FIG. 6Q shows, the total empirical numbers of broken rails in 2015 and 2016 are 823 and 844. In some embodiments, the predicted number of broken rails for 2015 and 2016 are 768 and 773 correspondingly. The errors for 2015 and 2016 are 6.7 percent and 8.4 percent, respectively.

### Model Application

### Network Scanning to Identify Locations with High Broken Rail Probabilities

In some embodiments, the prediction model can be used to screen the network and identify locations which are more prone to broken rail occurrences. In some embodiments, the results can be displayed via a curve in FIG. 6R. The x-axis represents the percentage of network scanned, while the y-axis is the percent of correctly “captured” broken rails, if scanning such scale of subnetwork. For example, if the broken rail prediction model (e.g. STC-NN as described above) is used to predict the probability of broken rails in one month, a majority of broken rails (e.g., over 71%) in one month (the percentage is weighted by segment length) may be determined by focusing on a minority (e.g., 30%) of network mileage. Without a model to identity broken-rail-prone locations, a naïve rule (which assumes that broken rail occurrence is random on the network) might be screening 71% of network mileage to find the same percentage of broken rails.

TABLE 6.5
Percentage of Captured Broken Rails Versus Percentage of
Network Screening with Prediction Period as One Month

| Percentage of | Percentage of “Captured” |
|---|---|
| Network | Broken Rails (Percentage is |
| Screening | Weighted by Segment Length) |
| 10% | 36.5% |
| 15% | 46.2% |
| 20% | 54.9% |
| 25% | 64.3% |
| 30% | 71.8% |
| 35% | 77.6% |
| 40% | 83.8% |

### GIS Visualization

In some embodiments, the developed broken rail prediction model can be applied to identify a shortlist of segments that may have higher broken rail probabilities. In some embodiments, this information may be useful for the railroad to prioritize the track inspection and inspection and/or maintenance activities. In addition, the analytical results can be visualized on a Geometric Information System (GIS) platform. FIG. 6S visualizes the predicted broken rail probability based on the categories of the probabilities (e.g., extremely low, low, medium, high, extremely high).

FIG. 6T shows that the 30 percent of the screened network mileage to identify the locations with relatively higher broken rail probabilities. As summarized in Table 6.6, the model is able to identify over 71% of broken rails (weighted by segment length) by performing a screening of 30% of network, which is marked in red (FIG. 6U).

### Partial Features of Top 20 Segments with High Predicted Probability of Broken Rails

In some embodiments, with ranking the predicted broken rail probability in one year, a list of locations with higher probabilities of broken rails may be identified, Table 6.7 lists the partial important features of the top 20 segments with high predicted probability of broken rails.

TABLE 6.6
Feature Information of Top 20 Segments

| | Annual | | | | | |
|---|---|---|---|---|---|---|
| | Traffic | Rail | Rail | | | |
| Segment | Density | Age | Weight | Speed | Curve | |
| ID | (MGT) | (Year) | (lbs/yard) | (MPH) | Degree | Probability |
| 1 | 53.26 | 21.01 | 135 | 50 | 0.94 | 0.392 |
| 2 | 60.26 | 38.93 | 139 | 50 | 0.35 | 0.379 |
| 3 | 58.90 | 10.66 | 136 | 50 | 0.27 | 0.379 |
| 4 | 38.73 | 30.38 | 135 | 60 | 0.25 | 0.378 |
| 5 | 70.17 | 1.48 | 136 | 60 | 0.11 | 0.377 |
| 6 | 73.83 | 27.35 | 133 | 57 | 0.24 | 0.377 |
| 7 | 57.36 | 40.17 | 139 | 50 | 0.34 | 0.377 |
| 8 | 59.83 | 2.40 | 136 | 50 | 0.34 | 0.376 |
| 9 | 59.27 | 36.96 | 140 | 50 | 0.25 | 0.374 |
| 10 | 44.93 | 18.95 | 135 | 38 | 1.43 | 0.370 |
| 11 | 70.90 | 31.22 | 136 | 58 | 0.00 | 0.370 |
| 12 | 58.43 | 31.45 | 134 | 50 | 0.32 | 0.370 |
| 13 | 74.78 | 22.48 | 134 | 40 | 1.13 | 0.369 |
| 14 | 78.91 | 34.98 | 122 | 57 | 0.00 | 0.369 |
| 15 | 55.33 | 26.71 | 135 | 50 | 0.44 | 0.369 |
| 16 | 56.34 | 23.60 | 137 | 50 | 0.18 | 0.368 |
| 17 | 62.45 | 11.51 | 136 | 46 | 1.00 | 0.368 |
| 18 | 63.21 | 21.33 | 135 | 50 | 0.41 | 0.368 |
| 19 | 67.88 | 15.91 | 135 | 50 | 1.19 | 0.368 |
| 20 | 85.87 | 18.67 | 135 | 58 | 0.73 | 0.368 |

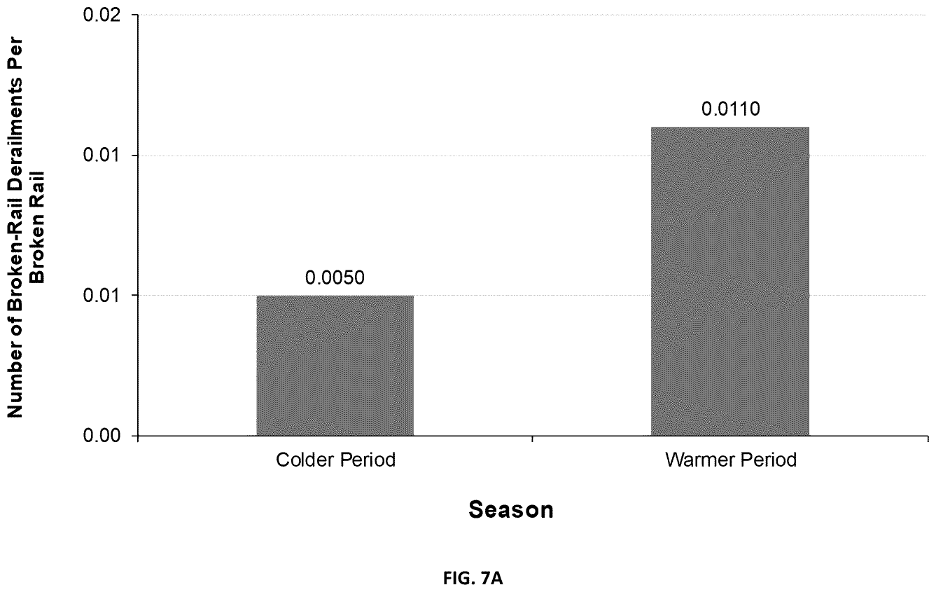

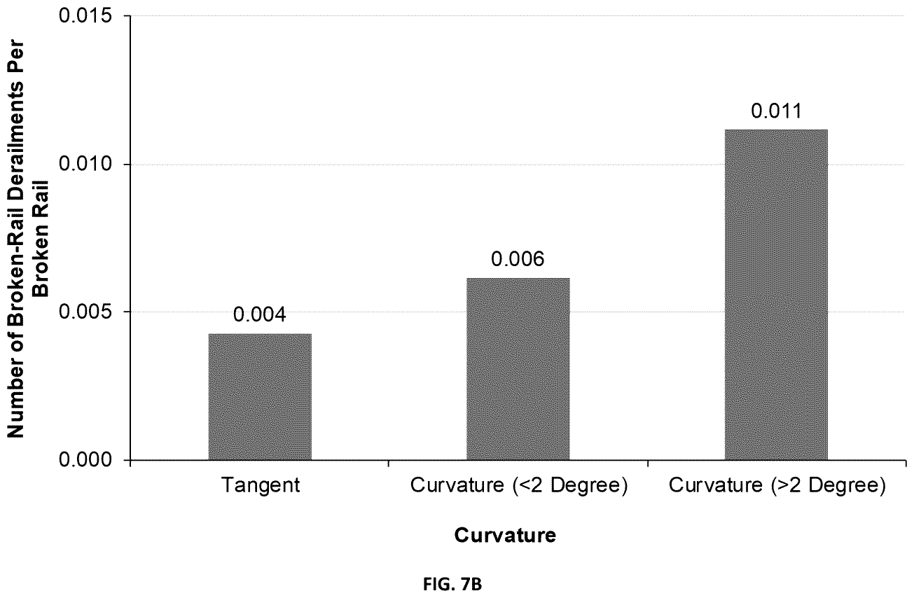

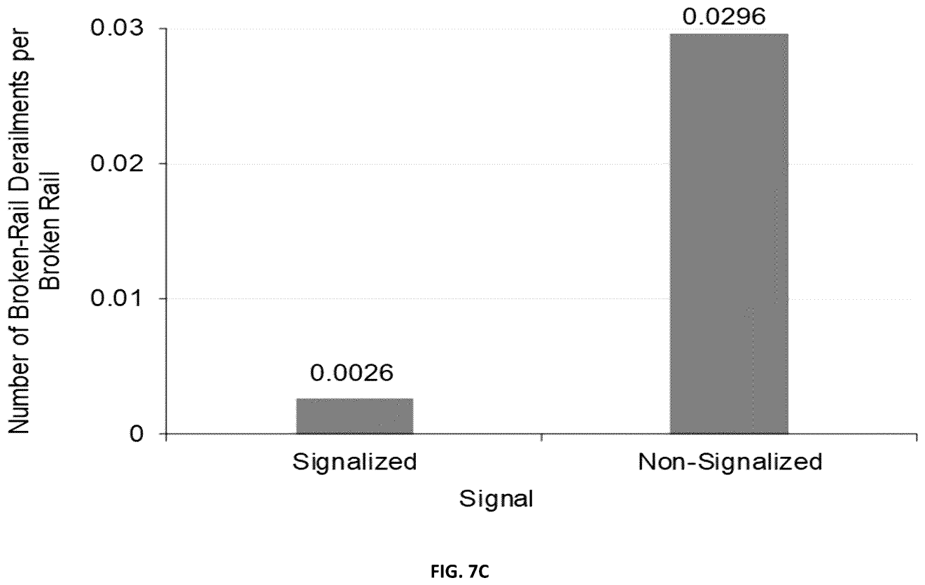

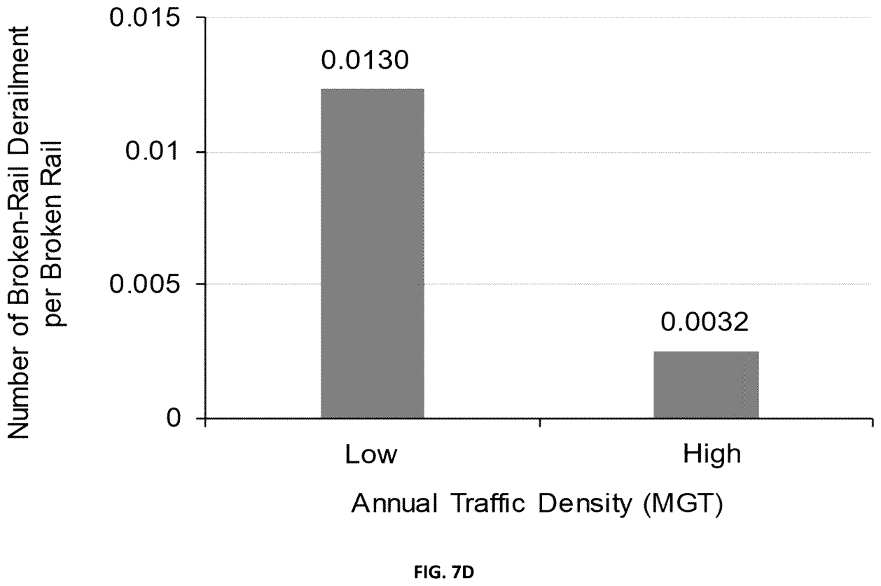

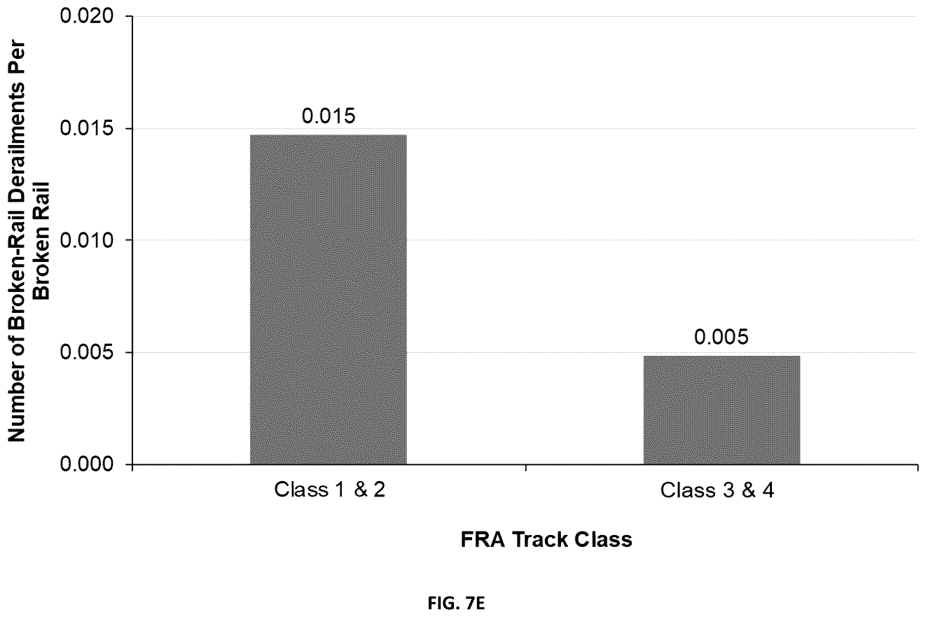

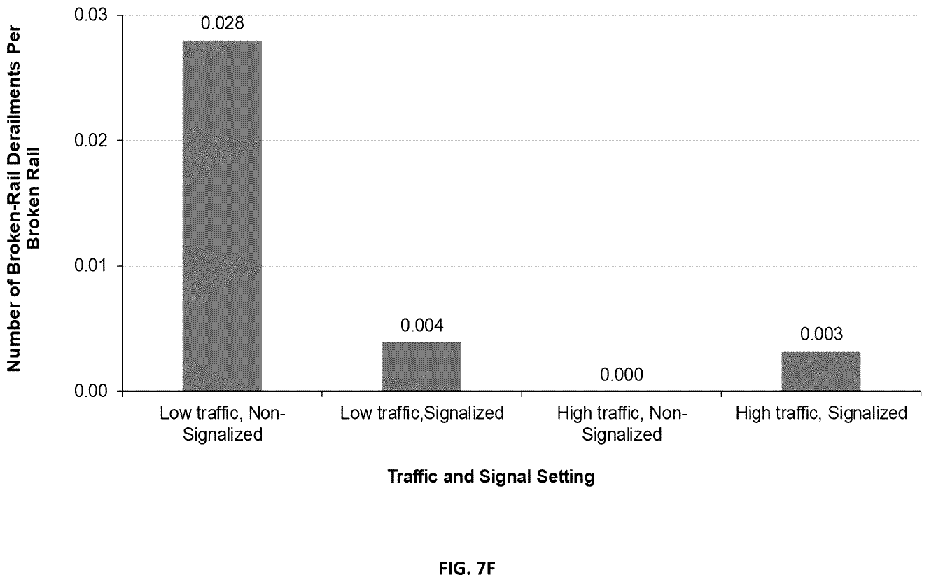

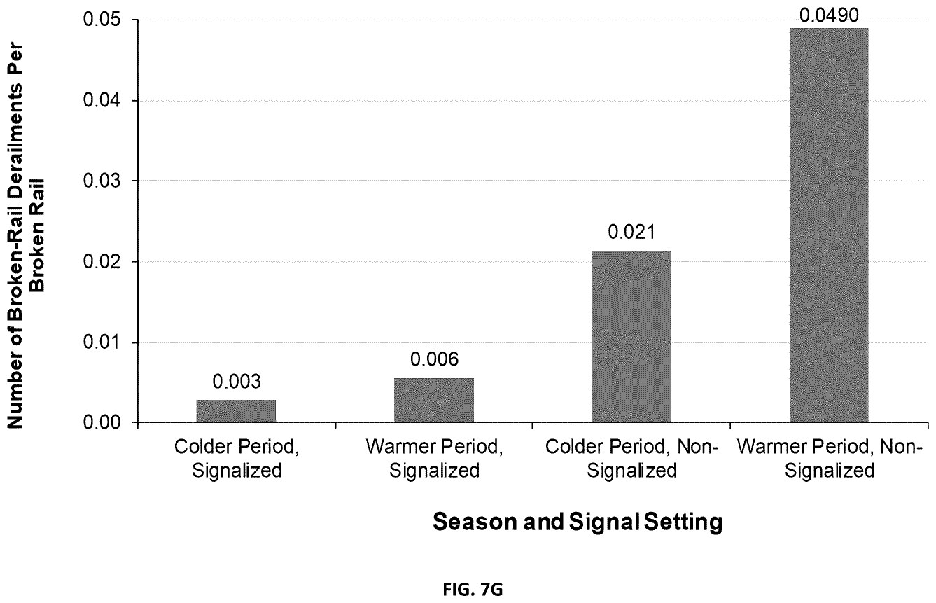

FIGS. 7A through 7G show broken rail derailment statistics for model validation in accordance with illustrative embodiments of the present disclosure.

FIG. 7A depicts a broken-rail derailment rate per broken rail by season in accordance with illustrative embodiments of the present disclosure.

FIG. 7B depicts a number of broken-rail derailments per broken rail by curvature in accordance with illustrative embodiments of the present disclosure.

FIG. 7C depicts a number of broken-rail derailments per broken rail by signal setting in accordance with illustrative embodiments of the present disclosure.

FIG. 7D depicts a broken-rail-caused derailment rate per broken rail by annual traffic density in accordance with illustrative embodiments of the present disclosure.

FIG. 7E depicts a broken-rail-caused derailment rate per broken rail in terms of FRA Track Class in accordance with illustrative embodiments of the present disclosure.

FIG. 7F depicts a number of broken-rail derailments per broken rail by annual traffic density level and signal setting in accordance with illustrative embodiments of the present disclosure.

FIG. 7G depicts a number of broken-rail derailments per broken rail by season and signal setting in accordance with illustrative embodiments of the present disclosure;

### Broken Rail-Caused Derailment Severity Estimation

### Data Description

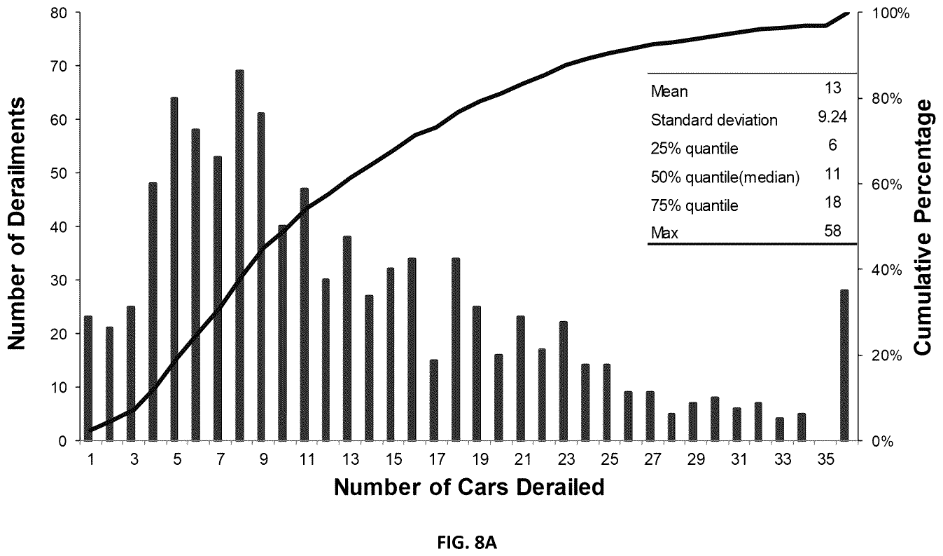

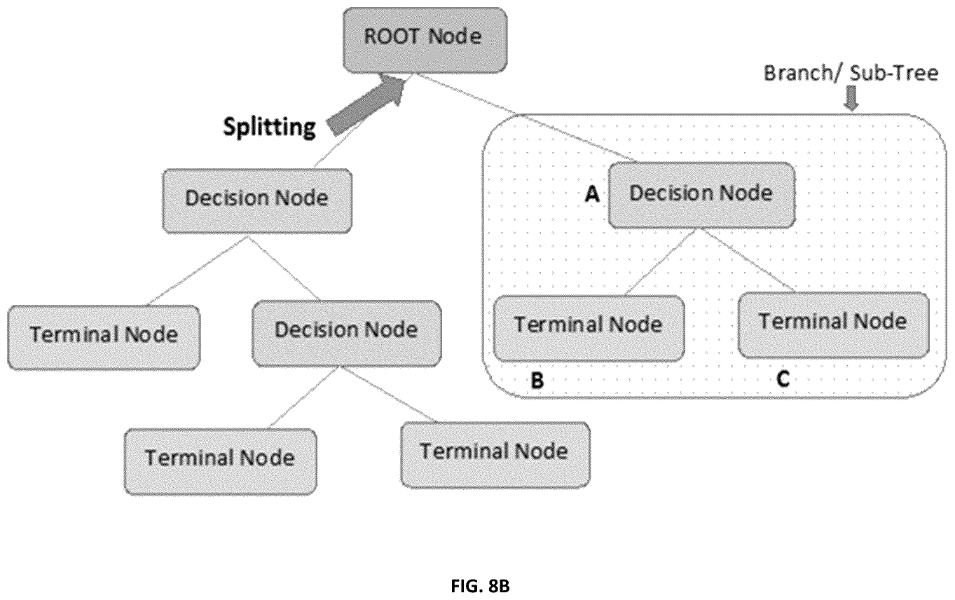

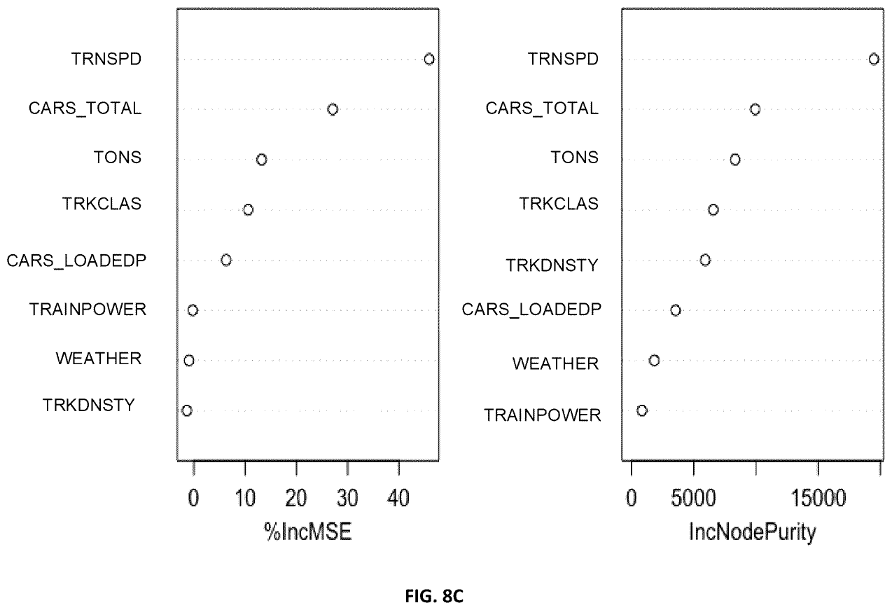

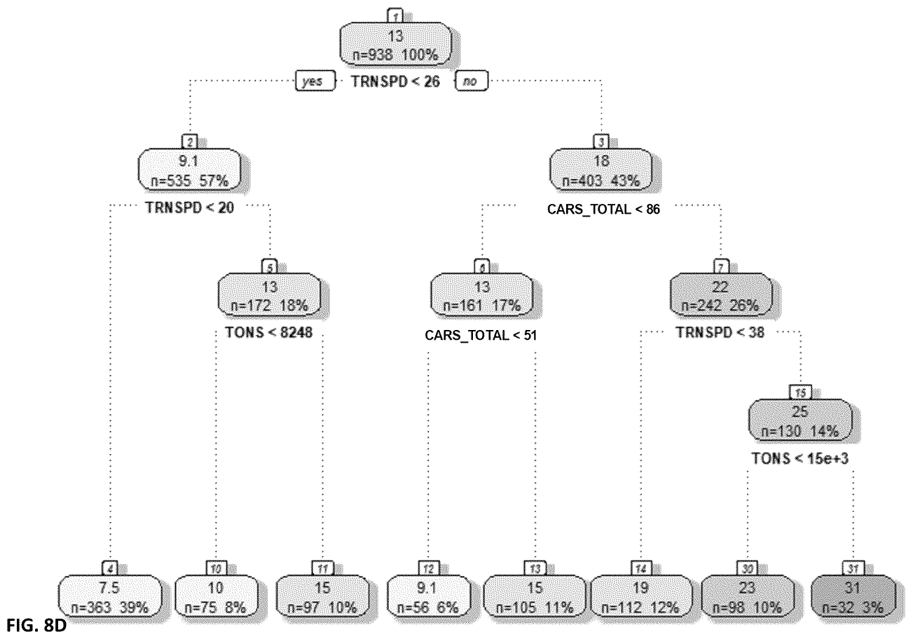

In some embodiments, broken rail-caused freight train derailment data on the main line of a Class I railroad from 2000 to 2017 is employed for severity estimated. In this period data may be collected on 938 Class I broken-rail-caused freight-train derailments on mainlines in the United States. Herein, the generic use of “cars” refers to all types of railcars (laden or empty), unless otherwise specified. Using the collected broken-rail-caused freight train derailment data, the distribution of the number of cars derailed is plotted in FIG. 8A.

In some embodiments, the response variable may be the total number of railcars derailed (both loaded and empty railcars) in one derailment. Several factors affect train derailment severity. In some embodiments, the following predictor variables (Table 8.1) may be identified for statistical analyses. For example, train derailment speed is the speed of train operation when the accident occurs.

TABLE 8.1
Predictor Variables in Severity Prediction Model

| | | Type of |
|---|---|---|
| Variable Name | Definition | Variable |
| TONS | Gross tonnage | Continuous |
| TRNSPD | Train derailment speed (MPH) | Continuous |
| CARS_TOTAL | Total number of cars | Continuous |
| CARS_LOADEDP | Proportion of loaded cars | Continuous |
| TRAINPOWER | Distribution of train power | Categorical |
| | (distributed or non-distributed) | |
| WEATHER | Weather conditions (clear, | Categorical |
| | cloudy, rain, fog, snow, etc.) | |
| TRKCLAS | FRA track class | Categorical |
| TRKDNSTY | Annual track density | Continuous |

### Decision Tree Model

In some embodiments, a machine learning algorithm is employed for the severity estimation. While any suitable machine learning algorithm may be employed, an example embodiment utilizes a decision tree. A decision tree is a type of supervised learning algorithm that splits the population or sample into two or more homogeneous sets based on the most significant splitter/differentiator in input variables and can cover both classification and regression problem in machine learning.

In some embodiments, FIG. 8B presents the structure of a simplified decision tree. Decision Node A is the parent node of Terminal Node B and Terminal Node C. In comparison with other regression methods and other advanced machine learning methods, decision tree has several advantages:
It is simple to understand, interpret, and visualize.
Decision trees implicitly perform variable screening or feature selection. They can identify the most significant variables and relations between two or more variables at a fast-computational speed.
They can handle both numerical and categorical data. They can also handle multi-output problems.
Nonlinear relationships between parameters do not affect tree performance.
It requires less data cleaning compared to some other modeling techniques. It is not influenced by outliers and missing values to a fair degree.

For example, compared to the Zero-Truncated Negative Binomial, the decision tree method does not require the same prerequisites but can still exclude the impacts from the nonlinear relationship between parameters. KNN (K-nearest neighbors algorithm) is one commonly used machine learning algorithms, but it can only be used in the classification problems. Instead, decision tree is applicable for both continuous and categorical inputs. Random forest, gradient boosting, and artificial neural network (ANN) are three other machine learning algorithms. In particular, random forest and gradient boosting are two advanced algorithms based upon decision tree methods and aim to overcome some limitations in decision tree, such as overfitting. However, in some embodiments, due to the sizes of datasets of broken-rail-caused derailments are analyzed, the advantages of these advanced machine learning methods may not be significant. In fact, the prediction accuracy of decision tree is comparable to other methods such as random forest, gradient boosting, and artificial neural network based on the data in some embodiments. In some embodiments, the preliminary testing results indicate that decision tree, random forest, gradient boosting, and artificial neural network all have similar prediction accuracy in terms of MSE (Mean Square Error) and MAE (Mean Absolute Error). Moreover, the features of decision tree, such as being simple to understand and visualize, and being a fast way to identify most significant variables, may be highlighted.

In some embodiments, there are many specific algorithms to build a decision tree, such as CART (Classification and Regression Trees) using Gini Index as a metric, ID3 (Iterative Dichotomiser 3) using Entropy function and Information gain as metrics. Among these, CART with Gini Index and ID3 with Information gain are the most commonly used. In some embodiments, the development of a derailment severity prediction model is based upon the CART algorithm. The Gini impurity is a measure of how often a randomly chosen element from the set may be incorrectly labeled, if it may be randomly labeled according to the distribution of labels in the subset. The Gini impurity can be computed by summing the probability pᵢ of an item with label i being chosen, multiplied by the probability of wrongly categorizing that item (1−pᵢ). It reaches its minimum (zero) when all cases in the node fall into a single target category. To compute Gini impurity for a set of items with J classes, support i∈{1, 2, . . . , J}, and let pᵢ be the fraction of items labeled with class i in the set.

$${l}_{G} ( p ) = {{\sum }^{J}}_{i = 1} {p}_{i} {\sum }_{k \neq i} {p}_{k} = {{\sum }^{J}}_{i = 1} {p}_{i} ( 1 - {p}_{i} ) = {{\sum }^{J}}_{i = 1} ( {p}_{i} - {p}_{i}^{2} ) = {{\sum }^{J}}_{i = 1} {p}_{i} - {{\sum }^{J}}_{i = 1} {p}_{i}^{2} = 1 - {{\sum }^{J}}_{i = 1} {p}_{i}^{2} \qquad ( 8 - 1 )$$

Where I_{G}(p) is the Gini impurity; pᵢ is the probability of an item with label i being chosen; J is the classes of a set of items.

In some embodiments, the importance of each predictor in the database is identified and two measures of variable importance, Mean Decrease Accuracy (% IncMSE) and Mean Decrease Gini (IncNodePurity), are reported. Mean Decrease Accuracy (% IncMSE) is based upon the average decrease of prediction accuracy when a given variable is excluded from the model. Mean Decrease Gini (IncNodePurity), measures the quality of a split for every variable of a tree by means of the Gini Index. For both measures, the higher value represents greater importance of a variable in the broken-rail-caused train derailment severity (FIG. 8C). Both metrics indicate that train speed (TRNSPD), number of cars in one train (CARS TOTAL), and gross tonnage per train (TONS) are the three most significant variables impacting broken-rail-caused train derailment severity.

In some embodiments, a decision tree has been developed for the training data (FIG. 8D). The response variable in the developed decision tree is the number of derailed cars. Three independent variables are employed in the built decision tree: TRNSPD (train derailment speed); CARS TOTAL (number of cars in one train); and TONS (gross tonnage). It indicates these three factors have significant impacts on the freight train derailment severity, in terms of number of cars derailed, while other variables (e.g., proportion of loaded cars, distribution of train power, weather condition, FRA track class, and annual track density) are statistically insignificant in the developed decision tree. In some embodiments, using the developed decision tree model, for a broken rail-caused freight train derailment with a speed lower than 20 mph, the expected number of cars derailed is 7.5. Also, if a 100-car freight train traveling at 30 mph derails due to broken rails, the expected number of cars derailed is 19.

In some embodiments, to further validate the accuracy and practicability of the developed decision tree, selected broken-rail-caused accidents of one Class I railroad in the last several years are listed in Table 8.2. The table lists the historical information of the accident, such as train speed (TRNSPD), gross tonnage (TONS), total number of cars in one train (CARS TOTAL), number of derailed cars, as well as the estimated number of derailed cars via the decision tree model.

TABLE 8.2
Selected Broken Rail-Caused Derailments on One Class I
Railroad and Estimated Derailment Severity

| | Gross | Train | Total number | Observed | Estimated |
|---|---|---|---|---|---|
| | tonnage | speed | of cars | number of | number of |
| No | (Tons) | (MPH) | in one train | derailed cars | derailed cars |
| 1 | 5,000 | 9 | 56 | 6 | 7 |
| 2 | 7,229 | 25 | 59 | 6 | 10 |
| 3 | 9,873 | 24 | 82 | 21 | 15 |
| 4 | 3,284 | 28 | 34 | 14 | 15 |
| 5 | 4,217 | 34 | 54 | 22 | 15 |
| 6 | 8,190 | 16 | 65 | 12 | 7 |
| 7 | 21,297 | 39 | 152 | 31 | 31 |
| 8 | 5,448 | 43 | 73 | 23 | 15 |
| 9 | 14,107 | 23 | 107 | 17 | 15 |
| 10 | 2,300 | 15 | 25 | 4 | 7 |
| 11 | 2,272 | 37 | 24 | 11 | 9 |
| 12 | 5,764 | 47 | 86 | 29 | 23 |
| 13 | 14,847 | 33 | 111 | 27 | 19 |
| 14 | 21,118 | 10 | 152 | 9 | 7 |
| 15 | 13,869 | 13 | 141 | 11 | 7 |
| 16 | 4,866 | 10 | 50 | 8 | 7 |
| 17 | 15,000 | 7 | 152 | 13 | 7 |
| 18 | 6,649 | 23 | 96 | 2 | 10 |
| 19 | 13,689 | 15 | 190 | 15 | 7 |
| Average | | | | 14.8 | 12.3 |

### Broken Rail-Caused Derailment Risk Model

In some embodiments, the broken rail prediction model as well as the model to estimate the severity of a broken-rail derailment associated with specific input variables may be integrated to estimate broken-rail derailment risk.

In some embodiments, the definition of risk includes two elements—uncertainty of an event and consequence given occurrence of an event. As for broken-rail derailment risk, it may be calculated through multiplying the broken-rail derailment probability by the broken-rail derailment severity, given specific variables, which is illustrated as follows:

Risk(D·B)=P(D·B)*S(D·B) (9-1)

Where
Risk(D·B)=broken-rail derailment risk,
P(D·B)=the probability of broken-rail derailment,
S(D·B)=the severity of broken-rail derailment given specific variables,
D=derailment,
B=broken rail.

In some embodiments, because broken rail derailment is a rare event with a very low probability, its limited sample size does not support a direct estimation of broken rail derailment probability based on input variables.

In some embodiments, however, using Bayes' Theorem, broken rail derailment probability (P(D·B)) can be calculated by:

P(D·B)=P(D|B)*P(B) (9-2)

Where:
P(D|B)=probability of broken-rail derailment given a broken rail, which can be estimated by the statistical relationship between broken-rail derailment and broken rail, given specific variables;
P(B)=probability of broken rails, which can be estimated by the broken rail prediction model.

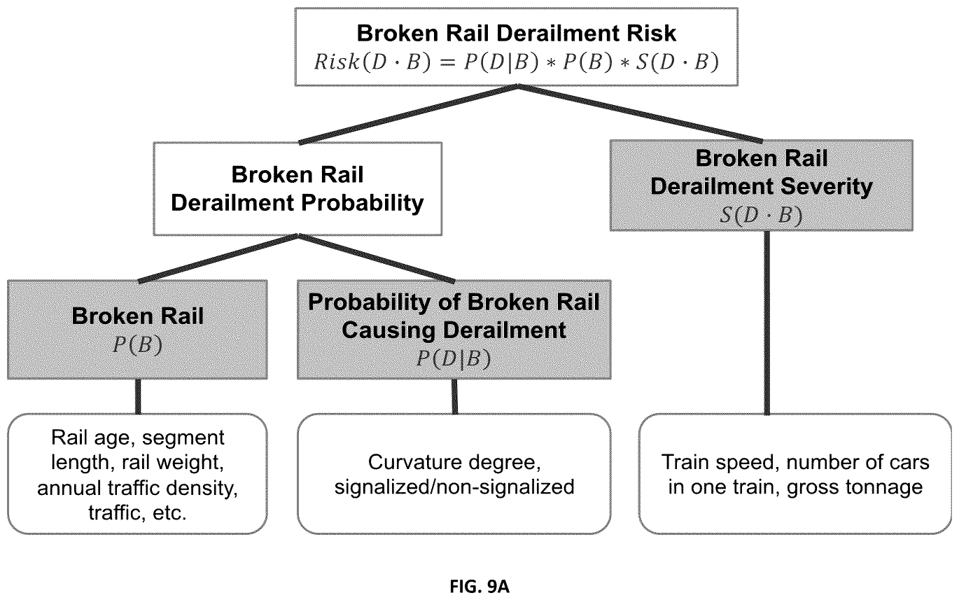

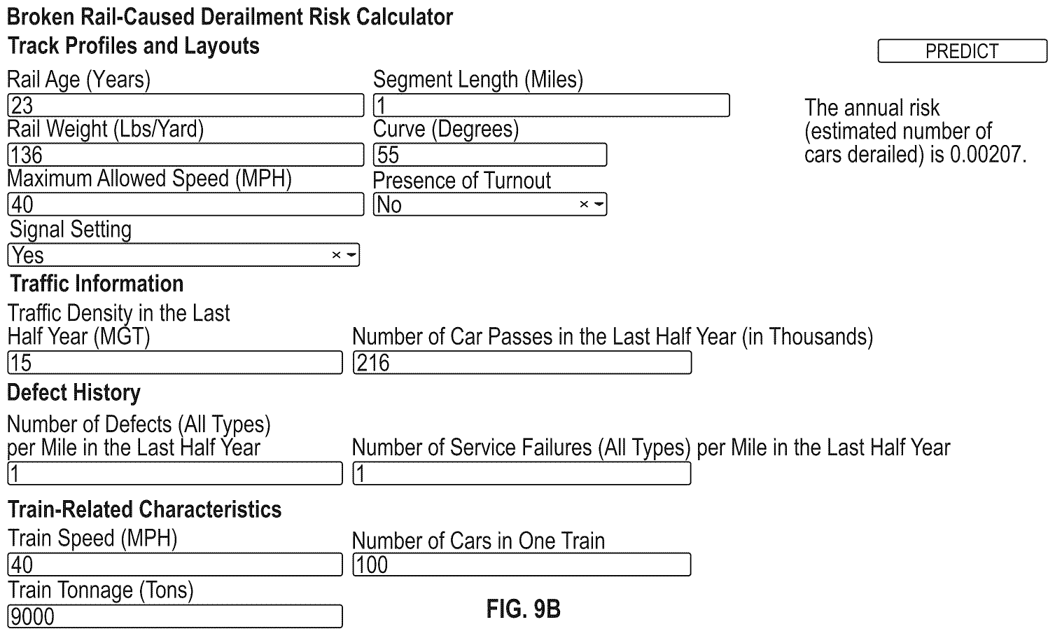

In some embodiments, in order to estimate the broken-rail derailment risk, calculation steps are illustrated in FIG. 9A:
Step 1: Use broken rail prediction model to estimate the probability of broken rail P(B).
Step 2: Estimate the probability of broken-rail derailment given a broken rail P(DIB), then calculate the probability of broken-rail derailment P(D·B).
Step 3: Based on the decision tree model, estimate the severity of broken-rail derailment (S(D·B)=) given specific variables.
Step 4: Calculate the broken-rail derailment risk Risk(D·B).

In some embodiments, a step-by-step calculation example is used to illustrate the application of the broken rail derailment risk model. For illustrative convenience, a 0.2-mile signalized segment is used, with characteristics regarding rail age, traffic density, curve degree and others. More details of the example segment are summarized in Table 9.1. To calculate the severity given a broken-rail derailment on the segment, the train characteristics are also considered (Table 9.2).

TABLE 9.1
Selected Characteristics of the Track Segment

| | |
|---|---|
| Rail age (years) | 23 |
| Segment length (miles) | 1 |
| Rail weight (lbs/yard) | 136 |
| Annual traffic density (MGT) | 30 |
| Annual number of car passes | 432,000 |
| Curve degree | 5.5 |
| Speed | 40 mph |
| Number of rail defects (all types) in last year | 2 |
| Number of service failures in last year | 1 |
| Signalized/Non-signalized | Signalized |
| Presence of turnout | No |

TABLE 9.2
Train-Related Characteristics

| | |
|---|---|
| Train operational speed (MPH) | 40 |
| Number of cars in one train | 100 |
| Gross tonnage | 9,000 |

In some embodiments, the calculation steps mentioned in Section 9.1 may be used in this example:
Step 1: Use the broken rail prediction model, the probability of broken rail on this track segment is estimated to be 0.015, P(B)=0.015;
Step 2: For curvature and signaled track segment, the estimated probability of derailment given a broken rail is 0.006, P(D|B)=0.006. The estimated probability of broken-rail derailment on this particular track segment is calculated by P(D|B)*P(B)=0.006*0.015=0.00009;
Step 3: Use the decision tree model to estimate the average number of derailed cars per derailment on this track segment based on the given variables. The calculation procedure is illustrated in FIG. 9A. The estimated number of derailed cars given a broken-rail derailment on the track segment, with train speed 40 MPH, number of cars in one train is 100, and gross tonnages is 9,000;
Step 4: The annual expected number of derailed cars is estimated to be Risk(D·B)=0.00009*23=0.00207.

In some embodiments, to illustrate broken-rail derailment risk calculation by segment, a web-based computer tool is being developed. As shown in FIG. 9B, with the input covering one real-world 0.2-mile segment's diverse characteristics regarding rail age, traffic density, curve degree and others, the broken-rail derailment risk can be calculated and displayed.

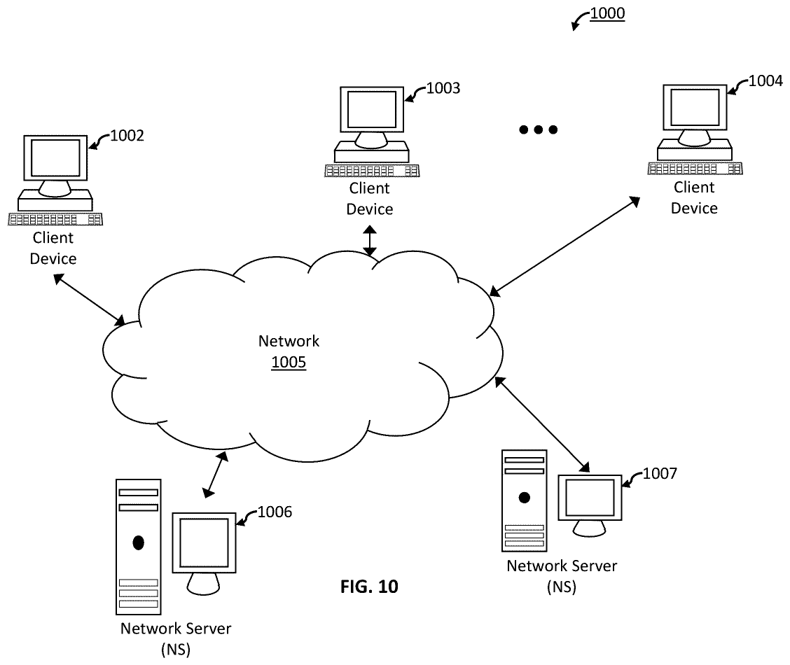

FIG. 10 depicts a block diagram of an exemplary computer-based system and platform 1000 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 1000 may be configured to manage a large number of members and concurrent transactions, as detailed herein. In some embodiments, the exemplary computer-based system and platform 1000 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 10, member computing device 1002, member computing device 1003 through member computing device 1004 (e.g., clients) of the exemplary computer-based system and platform 1000 may include virtually any computing device capable of receiving and sending a message over a network (e.g., cloud network), such as network 1005, to and from another computing device, such as servers 1006 and 1007, each other, and the like. In some embodiments, the member devices 1002-1004 may be personal computers, multiprocessor systems, microprocessor-based or programmable consumer electronics, network PCs, and the like. In some embodiments, one or more member devices within member devices 1002-1004 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 1002-1004 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 1002-1004 may include may run one or more applications, such as Internet browsers, mobile applications, voice calls, video games, videoconferencing, and email, among others. In some embodiments, one or more member devices within member devices 1002-1004 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 1002-1004 may be specifically programmed by either Java, .Net, QT, C, C++ and/or other suitable programming language. In some embodiments, one or more member devices within member devices 1002-1004 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 1005 may provide network access, data transport and/or other services to any computing device coupled to it. In some embodiments, the exemplary network 1005 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 1005 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 1005 may include and implement, as an alternative or in conjunction with one or more of the above, a WiMAX architecture defined by the WiMAX forum. In some embodiments and, optionally, in combination of any embodiment described above or below, the exemplary network 1005 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 1005 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 1005 may also include mass storage, such as network attached storage (NAS), a storage area network (SAN), a content delivery network (CDN) or other forms of computer or machine readable media.

In some embodiments, the exemplary server 1006 or the exemplary server 1007 may be a web server (or a series of servers) running a network operating system, examples of which may include but are not limited to Microsoft Windows Server, Novell NetWare, or Linux. In some embodiments, the exemplary server 1006 or the exemplary server 1007 may be used for and/or provide cloud and/or network computing. Although not shown in FIG. 10, in some embodiments, the exemplary server 1006 or the exemplary server 1007 may have connections to external systems like email, SMS messaging, text messaging, ad content providers, etc. Any of the features of the exemplary server 1006 may be also implemented in the exemplary server 1007 and vice versa.

In some embodiments, one or more of the exemplary servers 1006 and 1007 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 1001-1004.

In some embodiments and, optionally, in combination of any embodiment described above or below, for example, one or more exemplary computing member devices 1002-1004, the exemplary server 1006, and/or the exemplary server 1007 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

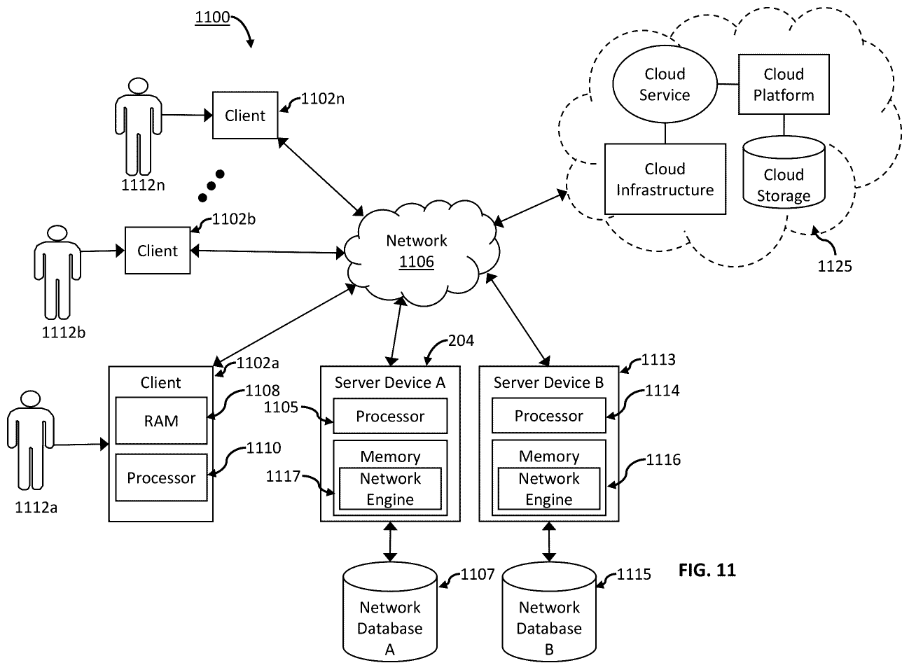

FIG. 11 depicts a block diagram of another exemplary computer-based system and platform 1100 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 1102a, member computing device 1102b through member computing device 1102n shown each at least includes a computer-readable medium, such as a random-access memory (RAM) 1108 coupled to a processor 1110 or FLASH memory. In some embodiments, the processor 1110 may execute computer-executable program instructions stored in memory 1108. In some embodiments, the processor 1110 may include a microprocessor, an ASIC, and/or a state machine. In some embodiments, the processor 1110 may include, or may be in communication with, media, for example computer-readable media, which stores instructions that, when executed by the processor 1110, may cause the processor 1110 to perform one or more steps described herein. In some embodiments, examples of computer-readable media may include, but are not limited to, an electronic, optical, magnetic, or other storage or transmission device capable of providing a processor, such as the processor 1110 of client 1102a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 1102a through 1102n may also comprise a number of external or internal devices such as a mouse, a CD-ROM, DVD, a physical or virtual keyboard, a display, or other input or output devices. In some embodiments, examples of member computing devices 1102a through 1102n (e.g., clients) may be any type of processor-based platforms that are connected to a network 1106 such as, without limitation, personal computers, digital assistants, personal digital assistants, smart phones, pagers, digital tablets, laptop computers, Internet appliances, and other processor-based devices. In some embodiments, member computing devices 1102a through 1102n may be specifically programmed with one or more application programs in accordance with one or more principles/methodologies detailed herein. In some embodiments, member computing devices 1102a through 1102n may operate on any operating system capable of supporting a browser or browser-enabled application, such as Microsoft™ Windows™, and/or Linux. In some embodiments, member computing devices 1102a through 1102n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 1102a through 1102n, user 1112a, user 1112b through user 1112n, may communicate over the exemplary network 1106 with each other and/or with other systems and/or devices coupled to the network 1106. As shown in FIG. 11, exemplary server devices 1104 and 1113 may include processor 1105 and processor 1114, respectively, as well as memory 1117 and memory 1116, respectively. In some embodiments, the server devices 1104 and 1113 may be also coupled to the network 1106. In some embodiments, one or more member computing devices 1102a through 1102n may be mobile clients.

In some embodiments, at least one database of exemplary databases 1107 and 1115 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

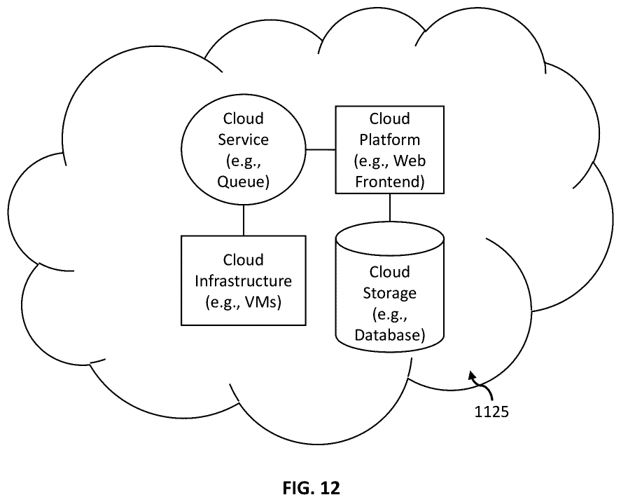

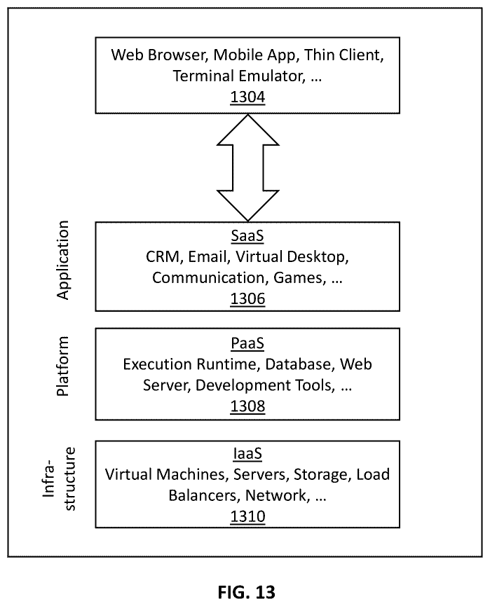

In some embodiments, the exemplary inventive computer-based systems/platforms, the exemplary inventive computer-based devices, and/or the exemplary inventive computer-based components of the present disclosure may be specifically configured to operate in a cloud computing/architecture 1125 such as, but not limiting to: infrastructure a service (IaaS) 1310, platform as a service (PaaS) 1308, and/or software as a service (SaaS) 1306 using a web browser, mobile app, thin client, terminal emulator or other endpoint 1304. FIGS. 12 and 13 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

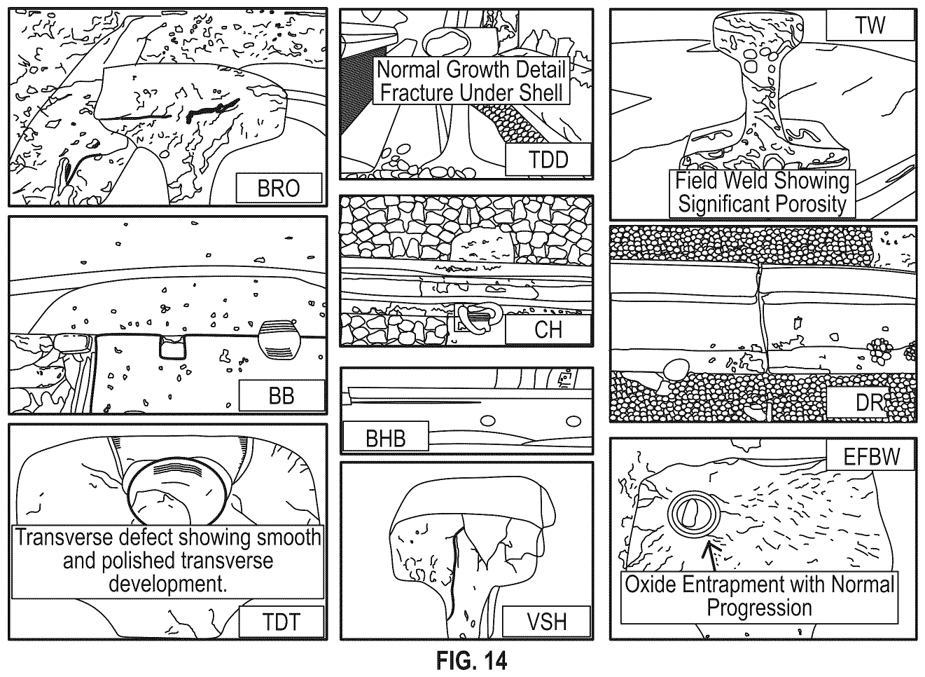

FIG. 14 depicts examples of the top 10 types of service failures.

### Example—Extreme Gradient Boosting Algorithm for Infrastructure Degradation Prediction

In some embodiments, an Extreme Gradient Boosting Algorithm may be employed to generate the predictions for infrastructure degradation and infrastructure degradation-related failures. In some embodiments, for a given data set with n examples and m features D={(xᵢ,yᵢ)}(|D|=n, Xᵢ∈□ₘ,yᵢ∈□), a tree ensemble model used M additive functions to predict the output.

$${\hat{y}}_{i} = ϕ ( {X}_{i} ) = {\sum }_{m = 1}^{M} {f}_{m} ( {X}_{i} ) , {f}_{m} ∈ F \qquad ( C - 1 )$$

where F={f(X)=ω_{q(x)}}(q:□^{m}→T,ω∈□^{T}) is the space of classification and regression trees.

Here q represents the structure of each tree that maps an example to the corresponding leaf index. T is the number of leaves in the tree. Each fₘ corresponds to an independent tree structure q and leaf weights ω. ωᵢ represents score on the i-th leaf. With a decision rule (given by q), the final prediction can be determined by summing up the score in the corresponding leaves (given by ω). The final predicted score ŷᵢ can be obtained by summing up all the scores of the M trees. For binary classification problem, use logistic transformation to assign a probability to the positive class which is shown as Eq. (C-2).

$$P ( positive \vert {X}_{i} ) = \frac{1}{1 + {e}^{- {\hat{y}}_{i}}} \qquad ( C - 2 )$$

In some embodiments, to learn the set of functions used in the model, the following regularized objective may be minimized, which includes loss term and regularization.

$$ℓ ( ϕ ) = {\sum }_{i} l ( {y}_{i} , {\hat{y}}_{i} ) + {\sum }_{m} Ω ( {f}_{m} ) \qquad ( C - 3 )$$

Where

$$Ω ( f ) = γ T + \frac{1}{2} λ {‖ ω ‖}^{2} \qquad ( C - 4 )$$

Here l is a differentiable convex loss function that measures the difference between the prediction ŷᵢ and the target ŷᵢ. Logarithmic loss function is a binary classification loss function which may be used as an evaluation metric. The logarithmic loss function is calculated by Eq. (C-5).

l(yᵢ,ŷᵢ)=yᵢ log(pᵢ)+(1−yᵢ)log(1−pᵢ) (C-5)
where

$${p}_{i} = \frac{1}{1 + {e}^{- {\hat{y}}_{i}}} ,$$

then the logarithmic loss function is

$$l ( {y}_{i} , {\hat{y}}_{i} ) = {y}_{i} log ( \frac{1}{1 + {e}^{- {\hat{y}}_{i}}} ) + ( 1 - {y}_{i} ) log ( \frac{{e}^{- {\hat{y}}_{i}}}{1 + {e}^{- {\hat{y}}_{i}}} ) \qquad ( C - 6 )$$

In some embodiments, the second term Q of the regularized objective penalizes the complexity of the model. The additional regularization term (penalty term) helps to smooth the final learnt weights to avoid over-fitting. In the additional regularization term, γ and λ are the specified parameters. T is the number of leaves in the tree, and ω is used to represent score on the i-th leaf.

In some embodiments, the model is trained in an additive manner. Formally, let ŷᵢ^{(m)} be the prediction of the i-th instance at the m-the iteration, we may need to add fin to minimize the following objective.

$${ℓ}^{( m )} = {\sum }_{i = 1}^{n} l ( {y}_{i} , {\hat{y}}_{i}^{( m - 1 )} + {f}_{m} ( {X}_{i} ) ) + Ω ( {f}_{m} ) \qquad ( C - 7 )$$

After Taylor expansion approximation,

$${ℓ}^{( m )} ▯ {\sum }_{i = 1}^{n} [ l ( {y}_{i} , {\hat{y}}_{i}^{( m - 1 )} ) + {g}_{i} {f}_{m} ( {X}_{i} ) + \frac{1}{2} {h}_{i} {f}_{m}^{2} ( {X}_{i} ) ) ] + Ω ( {f}_{m} ) \qquad ( C - 8 )$$

Where:

$${g}_{i} = \frac{\partial l ( {y}_{i} , {\hat{y}}^{( m - 1 )} )}{\partial {\hat{y}}^{( m - 1 )}} and {h}_{i} = \frac{{\partial }^{2} l ( {y}_{i} , {\hat{y}}^{( m - 1 )} )}{\partial {\hat{y}}^{( m - 1 )}}$$

are first and second order gradient statistics on the loss function. In some embodiments, the constant terms l(yᵢ, ŷᵢ^{(m-1)}) can be removed to obtain the following simplified objective at step m.

$$▯ {\sum }_{i = 1}^{n} [ {g}_{i} {f}_{m} ( {X}_{i} ) + \frac{1}{2} {h}_{i} {f}_{m}^{2} ( {X}_{i} ) ] + Ω ( {f}_{m} ) \qquad ( C - 9 )$$

Define Iⱼ={i|q(Xᵢ)=j} as the instance set of leaf j. Expand Ω and rewrite Eq. (C-9) as follows

$$\begin{matrix}= {\sum }_{i = 1}^{n} [ {g}_{i} {f}_{m} ( {X}_{i} ) + \frac{1}{2} {h}_{i} {f}_{m}^{2} ( {X}_{i} ) ] + γ T + \frac{1}{2} λ {\sum }_{j = 1}^{T} {ω}_{j}^{2} \\ = {\sum }_{j = 1}^{T} [ ( {\sum }_{i ∈ {I}_{j}} {g}_{i} ) {ω}_{j} + \frac{1}{2} ( {\sum }_{i ∈ {I}_{j}} {h}_{i} + λ ) {ω}_{j}^{2} ] + γ T\end{matrix} \qquad ( C - 10 )$$

For a fixed structure q(X), we can compute the optimal weight ω*ⱼ of leaf j by

$${ω}_{j}^{*} = - \frac{{\sum }_{i ∈ {I}_{j}} {g}_{i}}{{\sum }_{i ∈ {I}_{j}} {h}_{i} + λ} \qquad ( C - 11 )$$

and calculate the corresponding optimal value by

$${ℓ}^{{▯}^{( m )}} ( q ) = - \frac{1}{2} {\sum }_{j = 1}^{T} \frac{{( {\sum }_{i ∈ {I}_{j}} {g}_{i} )}^{2}}{{\sum }_{i ∈ {I}_{j}} {h}_{i} + λ} + γ T \qquad ( C - 12 )$$

In some embodiments, Eq. (C-12) can be used as a scoring function to measure the quality of a tree structure q. This score is like the impurity score for evaluating decision trees, except that it is derived for a wider range of objective functions.

In some embodiments, it is impossible to test all the alternatives of tree structures q. In some embodiments, the tree is grown greedily, starting from tree with depth 0. For each leaf node of the tree, try to add a split. Assume that I_{L} and I_{R} are the instance sets of left and right nodes after the split. Letting I=I_{L} [symbol] I_{R}, Then the loss reduction after the split is given by

$${ℓ}_{split} = \frac{1}{2} [ \frac{{( {\sum }_{i ∈ {I}_{L}} {g}_{i} )}^{2}}{{\sum }_{i ∈ {I}_{L}} {h}_{i} + λ} + \frac{{( {\sum }_{i ∈ {I}_{R}} {g}_{i} )}^{2}}{{\sum }_{i ∈ {I}_{R}} {h}_{i} + λ} - \frac{{( {\sum }_{i ∈ I} {g}_{i} )}^{2}}{{\sum }_{i ∈ I} {h}_{i} + λ} ] - γ \qquad ( C - 13 )$$

The optimal split candidate can be obtained by maximizing [symbol] ₛₚₗᵢₜ.

TABLE C
1 Pseudo Code of Extreme Gradient Boosting
Algorithm: Extreme Gradient Boosting

```
  Input: Dataset D.
    A loss function L.
    The number of iterations M.
    The minimum split loss γ.
    The weight of regularization term λ.
    The number of terminal leaf T.
  Initialize ŷᵢ⁽⁰⁾ = f₀(Xᵢ) = 0
  for m = 1, 2, . . . , M do
    ${g}_{i} = \frac{\partial ℓ ( {y}_{i} , {\hat{y}}^{( m - 1 )} )}{\partial {\hat{y}}^{( m - 1 )}}$
    ${h}_{i} = \frac{{\partial }^{2} ℓ ( {y}_{i} , {\hat{y}}^{( m - 1 )} )}{\partial {\hat{y}}^{( m - 1 )}}$
    Determine the structure Iⱼ = {i|q(Xᵢ) = j}ⱼ₋₁^{T} by selecting splits
    which maximize
    $Gain = \frac{1}{2} [ \frac{{G}_{L}^{2}}{{H}_{L} + λ} + \frac{{G}_{R}^{2}}{{H}_{R} + λ} - \frac{{( {G}_{L} + {G}_{R} )}^{2}}{( {H}_{L} + {H}_{R} + λ )} ] - γ$
    Determine the optimal leaf weights {ω*ⱼ}ⱼ₋₁^{T} for the learned
    structure by
    ${ω}_{j}^{*} = arg {min}_{{ω}_{j}} ( {\sum }_{j = 1}^{T} [ ( {\sum }_{i ∈ {I}_{j}} {g}_{i} ) {ω}_{j} + \frac{1}{2} ( {\sum }_{i ∈ {I}_{j}} {h}_{i} + λ ) {ω}_{j}^{2} ] + γ T )$
    ${\hat{f}}_{m} ( {X}_{i} ) = {\sum }_{j = 1}^{T} {\sum }_{i ∈ {I}_{j}} {ω}_{j}^{*} q ( {X}_{j} )$
    ŷᵢ^{m} = ŷᵢ^{(m-1)} + \hat{f}ₘ(Xᵢ)
  end for
  Output: ŷᵢ = Σₘ₋₁^{M} \hat{f}ₘ(Xᵢ)
    $P ( positive \vert {X}_{i} ) = \frac{1}{1 + {e}^{- {\hat{y}}_{i}}}$
```

In some embodiments, there are multiple parameters involved in extreme gradient boosting algorithm. In some embodiments, as for number of rounds for boosting, the number is set to 1000 since increasing number of rounds beyond that number has little effect for our dataset. The other involved parameters other than number of rounds are tuned by Bayesian optimization to choose the optimal values respectively. The optimal values for the parameters which are different from the default value in the package are listed in Table C. 2. The optimal values for other parameters are found to be close to default values recommended in the package.

TABLE C.2
Hyper-parameter Setup

| Hyper-parameter | Setup Value |
|---|---|
| Number of rounds | 1,000 |
| Maximum depth of each tree | 12 |
| Minimum loss reduction for every split | 7 |
| Maximum delta at each step | 7.5 |
| Minimum weight for each child node | 13 |
| Subsampling ratio for each tree | 0.9 |
| Feature sampling for each tree | 0.45 |

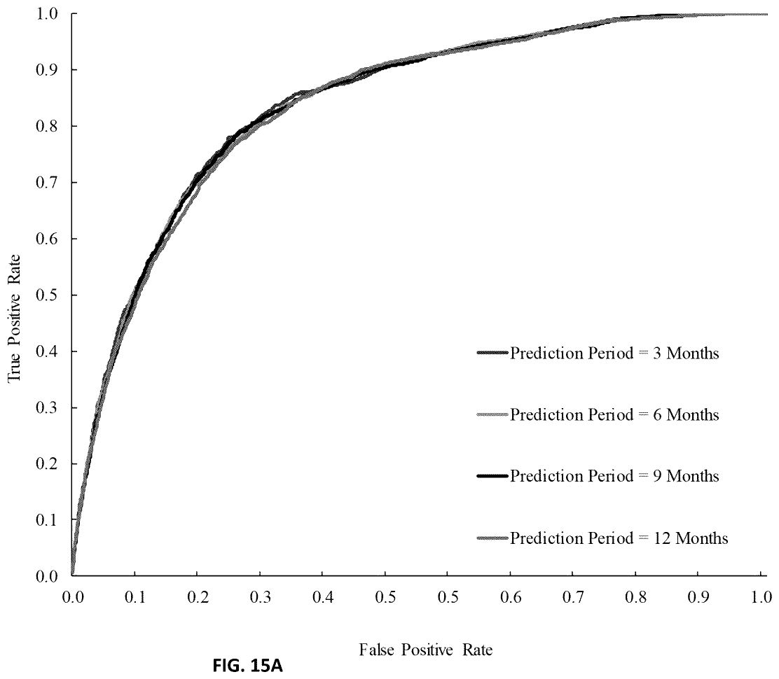

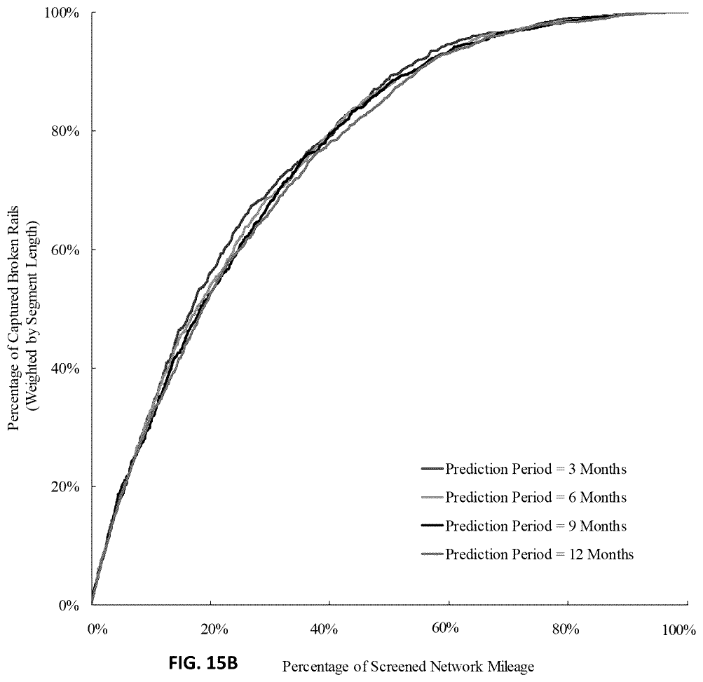

In some embodiments, FIG. 15A depicts a Receiver Operating Characteristics (ROC) curve with respective to different prediction periods for an extreme gradient boosting algorithm

TABLE C.3
Area Under ROC Curve (AUC)

| Prediction Period | AUC |
|---|---|
| 3 Months | 0.84 |
| 6 Months | 0.84 |
| 9 Months | 0.84 |
| 12 Months | 0.83 |

In some embodiments, FIG. 15B depicts a network screening curve with respective to different prediction periods for the extreme gradient boosting algorithm. Table C.4 presents Percentage of Network Screening versus Percentage of Captured Broken Rails Weighted by Segment Length with Prediction Period 12 Months while Table C.5 presents Feature Information of Top 100 Segments.

TABLE C.4
Percentage of Network Screening versus
Percentage of Captured Broken Rails Weighted by
Segment Length with Prediction Period 12 Months

| Percentage of Screened | Percentage of Captured Broken Rails |
|---|---|
| Network Mileage | (Weighted by Segment Length) |
| 10% | 31.7% |
| 20% | 52.7% |
| 30% | 66.6% |
| 40% | 78.1% |
| 50% | 86.0% |

TABLE C.5
Feature Information of Top 100 Segments

| | Annual | | | | | |
|---|---|---|---|---|---|---|
| | Traffic | Rail | Rail | | | |
| Segment | Density | Age | Weight | Speed | Curve | |
| ID | (MGT) | (Year) | (lbs/yard) | (MPH) | Degree | Probability |
| 1 | 75.52 | 16.04 | 136 | 40 | 2.27 | 0.614 |
| 2 | 50.82 | 13.95 | 136 | 33 | 2.13 | 0.599 |
| 3 | 65.02 | 9.87 | 132 | 60 | 0.00 | 0.523 |
| 4 | 77.39 | 17.44 | 136 | 33 | 2.06 | 0.499 |
| 5 | 60.66 | 22.01 | 136 | 50 | 0.00 | 0.498 |
| 6 | 67.88 | 15.91 | 135 | 50 | 1.19 | 0.494 |
| 7 | 57.67 | 23.07 | 136 | 47 | 1.43 | 0.471 |
| 8 | 74.78 | 19.38 | 136 | 39 | 1.32 | 0.470 |
| 9 | 44.93 | 18.95 | 135 | 38 | 1.43 | 0.465 |
| 10 | 54.01 | 24.65 | 134 | 35 | 1.92 | 0.463 |
| 11 | 42.46 | 36.02 | 132 | 50 | 0.00 | 0.460 |
| 12 | 85.87 | 18.67 | 135 | 58 | 0.73 | 0.445 |
| 13 | 67.24 | 16.63 | 136 | 60 | 0.35 | 0.436 |
| 14 | 59.83 | 2.40 | 136 | 50 | 0.34 | 0.435 |
| 15 | 42.37 | 23.38 | 135 | 30 | 1.85 | 0.431 |
| 16 | 45.34 | 32.52 | 133 | 60 | 0.15 | 0.428 |
| 17 | 48.83 | 33.02 | 132 | 60 | 0.00 | 0.428 |
| 18 | 47.68 | 25.14 | 136 | 40 | 1.59 | 0.422 |
| 19 | 71.26 | 9.14 | 136 | 30 | 5.31 | 0.422 |
| 20 | 85.58 | 33.82 | 134 | 60 | 0.00 | 0.420 |
| 21 | 46.96 | 23.01 | 136 | 60 | 0.03 | 0.418 |
| 22 | 46.76 | 18.64 | 136 | 60 | 0.59 | 0.417 |
| 23 | 56.34 | 23.60 | 137 | 50 | 0.18 | 0.409 |
| 24 | 57.36 | 40.17 | 139 | 50 | 0.34 | 0.409 |
| 25 | 58.88 | 39.39 | 136 | 50 | 0.39 | 0.404 |
| 26 | 78.91 | 34.98 | 122 | 57 | 0.00 | 0.403 |
| 27 | 53.26 | 21.01 | 135 | 50 | 0.94 | 0.401 |
| 28 | 50.55 | 26.23 | 124 | 30 | 2.09 | 0.400 |
| 29 | 46.42 | 25.18 | 134 | 30 | 0.62 | 0.400 |
| 30 | 35.11 | 48.03 | 122 | 50 | 0.27 | 0.399 |
| 31 | 48.69 | 24.62 | 135 | 60 | 0.11 | 0.393 |
| 32 | 35.84 | 26.49 | 138 | 27 | 2.37 | 0.392 |
| 33 | 36.65 | 26.79 | 124 | 40 | 2.03 | 0.391 |
| 34 | 57.54 | 18.73 | 135 | 42 | 0.76 | 0.390 |
| 35 | 75.02 | 19.51 | 136 | 34 | 0.92 | 0.390 |
| 36 | 39.59 | 15.40 | 136 | 35 | 1.59 | 0.387 |
| 37 | 77.05 | 19.16 | 136 | 37 | 1.42 | 0.386 |
| 38 | 79.92 | 30.23 | 136 | 60 | 0.68 | 0.385 |
| 39 | 41.66 | 22.93 | 133 | 40 | 1.47 | 0.385 |
| 40 | 41.91 | 20.80 | 136 | 33 | 2.13 | 0.383 |
| 41 | 26.76 | 42.75 | 131 | 50 | 0.00 | 0.379 |
| 42 | 65.67 | 12.71 | 136 | 45 | 1.39 | 0.378 |
| 43 | 46.78 | 27.51 | 136 | 49 | 0.99 | 0.375 |
| 44 | 37.44 | 30.83 | 131 | 58 | 0.00 | 0.374 |
| 45 | 44.99 | 26.13 | 133 | 59 | 0.17 | 0.373 |
| 46 | 49.76 | 4.26 | 136 | 25 | 2.83 | 0.372 |
| 47 | 55.88 | 9.12 | 135 | 50 | 0.14 | 0.368 |
| 48 | 67.81 | 26.37 | 129 | 60 | 0.25 | 0.368 |
| 49 | 55.19 | 17.40 | 136 | 50 | 0.09 | 0.366 |
| 50 | 70.17 | 1.48 | 136 | 60 | 0.11 | 0.360 |
| 51 | 51.16 | 50.43 | 115 | 50 | 0.06 | 0.360 |
| 52 | 65.39 | 15.97 | 136 | 38 | 2.08 | 0.359 |
| 53 | 41.46 | 23.87 | 132 | 35 | 1.30 | 0.357 |
| 54 | 40.18 | 29.34 | 133 | 60 | 0.00 | 0.357 |
| 55 | 32.85 | 33.02 | 131 | 60 | 0.00 | 0.356 |
| 56 | 74.69 | 0.39 | 136 | 50 | 0.17 | 0.356 |
| 57 | 43.24 | 29.67 | 136 | 59 | 0.17 | 0.353 |
| 58 | 36.48 | 35.85 | 128 | 54 | 0.50 | 0.352 |
| 59 | 70.90 | 31.22 | 136 | 58 | 0.00 | 0.352 |
| 60 | 31.64 | 41.58 | 125 | 55 | 0.00 | 0.351 |
| 61 | 40.98 | 22.61 | 135 | 35 | 2.62 | 0.349 |
| 62 | 27.65 | 29.19 | 115 | 50 | 0.87 | 0.349 |
| 63 | 54.89 | 35.32 | 139 | 50 | 0.42 | 0.346 |
| 64 | 54.33 | 11.33 | 136 | 50 | 0.03 | 0.346 |
| 65 | 41.30 | 21.94 | 133 | 40 | 1.98 | 0.345 |
| 66 | 20.69 | 36.50 | 132 | 60 | 0.06 | 0.345 |
| 67 | 55.33 | 26.71 | 135 | 50 | 0.44 | 0.344 |
| 68 | 35.65 | 38.62 | 132 | 48 | 0.39 | 0.342 |
| 69 | 74.37 | 7.80 | 136 | 60 | 0.06 | 0.342 |
| 70 | 59.60 | 23.30 | 133 | 30 | 1.34 | 0.342 |
| 71 | 75.45 | 22.01 | 136 | 50 | 0.00 | 0.342 |
| 72 | 58.94 | 18.01 | 136 | 60 | 0.00 | 0.341 |
| 73 | 41.93 | 11.27 | 136 | 33 | 2.86 | 0.340 |
| 74 | 37.50 | 41.13 | 123 | 50 | 0.26 | 0.339 |
| 75 | 42.74 | 21.44 | 136 | 40 | 1.61 | 0.338 |
| 76 | 41.51 | 14.75 | 136 | 35 | 2.11 | 0.336 |
| 77 | 15.18 | 53.04 | 115 | 1641 | 0.01 | 0.335 |
| 78 | 72.16 | 28.72 | 136 | 58 | 0.70 | 0.335 |
| 79 | 45.46 | 35.15 | 133 | 45 | 0.78 | 0.332 |
| 80 | 64.29 | 7.81 | 135 | 37 | 1.28 | 0.332 |
| 81 | 41.18 | 17.62 | 135 | 40 | 1.15 | 0.332 |
| 82 | 48.96 | 33.02 | 132 | 60 | 0.00 | 0.329 |
| 83 | 56.54 | 11.83 | 138 | 50 | 0.83 | 0.329 |
| 84 | 47.03 | 13.59 | 137 | 40 | 1.26 | 0.327 |
| 85 | 55.21 | 31.02 | 136 | 59 | 0.00 | 0.326 |
| 86 | 38.67 | 48.03 | 132 | 60 | 0.00 | 0.326 |
| 87 | 25.41 | 31.17 | 134 | 59 | 0.54 | 0.325 |
| 88 | 39.67 | 19.89 | 134 | 45 | 1.99 | 0.324 |
| 89 | 78.07 | 21.49 | 136 | 45 | 0.21 | 0.322 |
| 90 | 17.12 | 28.42 | 130 | 41 | 0.14 | 0.321 |
| 91 | 51.94 | 33.01 | 132 | 35 | 2.44 | 0.319 |
| 92 | 78.45 | 18.98 | 136 | 49 | 0.69 | 0.318 |
| 93 | 53.59 | 11.71 | 141 | 60 | 0.17 | 0.318 |
| 94 | 31.56 | 33.02 | 131 | 60 | 0.05 | 0.317 |
| 95 | 67.82 | 25.99 | 132 | 60 | 0.36 | 0.316 |
| 96 | 19.13 | 40.03 | 127 | 47 | 0.00 | 0.315 |
| 97 | 37.72 | 35.18 | 126 | 50 | 0.30 | 0.315 |
| 98 | 74.78 | 22.48 | 134 | 40 | 1.13 | 0.310 |
| 99 | 74.68 | 7.56 | 136 | 50 | 0.09 | 0.310 |
| 100 | 42.40 | 27.70 | 139 | 50 | 0.23 | 0.310 |

### Example—Random Forest Algorithm for Infrastructure Degradation Prediction

In some embodiments, a Random Forest Algorithm may be employed to generate the predictions for infrastructure degradation and infrastructure degradation-related failures.

Given data on a set of N units as the training data, D={(X₁, Y₁), . . . , (X_{N}, Y_{N})}, where Xᵢ, i=1, 2, . . . N, is a vector of features and Yᵢ is either the corresponding class label which is categorical variables or activity of interests. Random Forest is an ensemble of M decision trees {T₁(Xᵢ), . . . , T_{M} (Xᵢ)}, where Xᵢ={xᵢ¹, xᵢ², . . . , xᵢ^{p}} is a p-dimensional vector of molecular descriptors or features associated with the i-th training unit. In some embodiments, the ensemble produces M outputs {Ŷᵢ¹=T₁(Xᵢ), . . . , Ŷᵢ^{M}=T_{M} (Xᵢ)} where Ŷᵢ^{m}, m=1, 2, . . . , M is the prediction for a cell by the m-th decision tree. Outputs of all decision trees are aggregated to produce one final prediction, Ŷᵢ, for the i-th training unit. For classification problems, Ŷᵢ is the class predicted by the majority of M decision trees. In some embodiments, in regression it is the average of the individual predictions associated with each decision tree. The training algorithm procedures are described as follows.
Step 1: from the training data of N units, randomly sample, with repair or replacement, n sub-samples as a bootstrap sample.
Step 2: for each bootstrap sample, grow a tree with the modification: at each node, choose the best split among a randomly selected subset f of f′ features rather than the set F of all features. Here f′ is essentially the only tuning parameter in the algorithm. The tree is grown to the maximum size until no further splits are possible and not pruned back.
Step 3: repeat the above steps until total number of M decision trees are built.

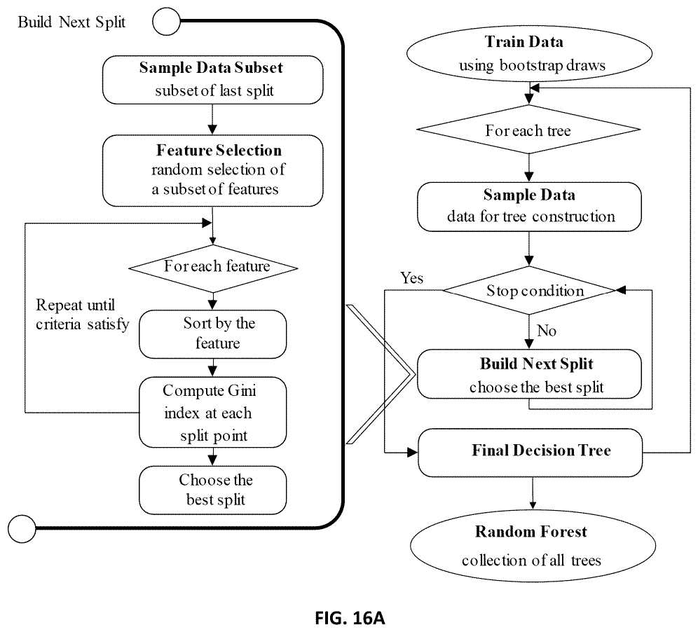

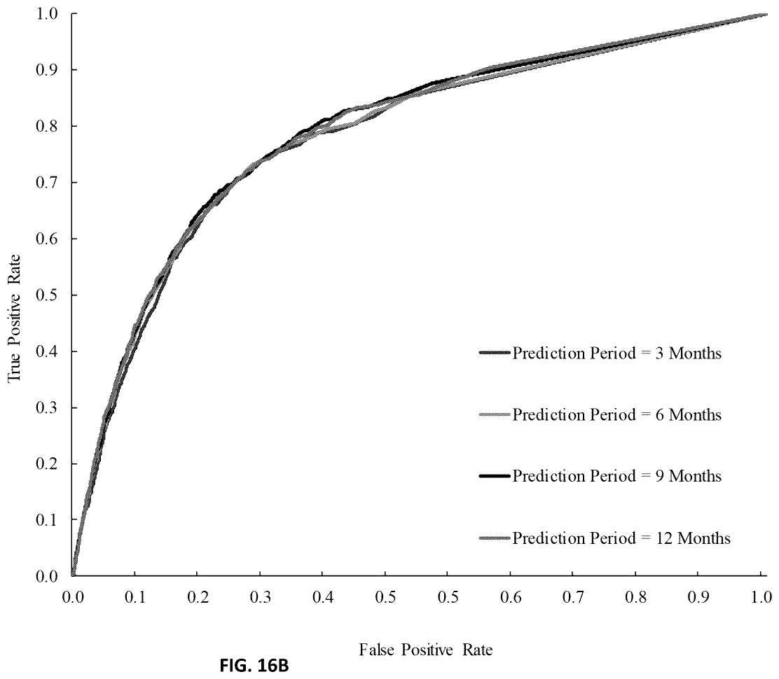

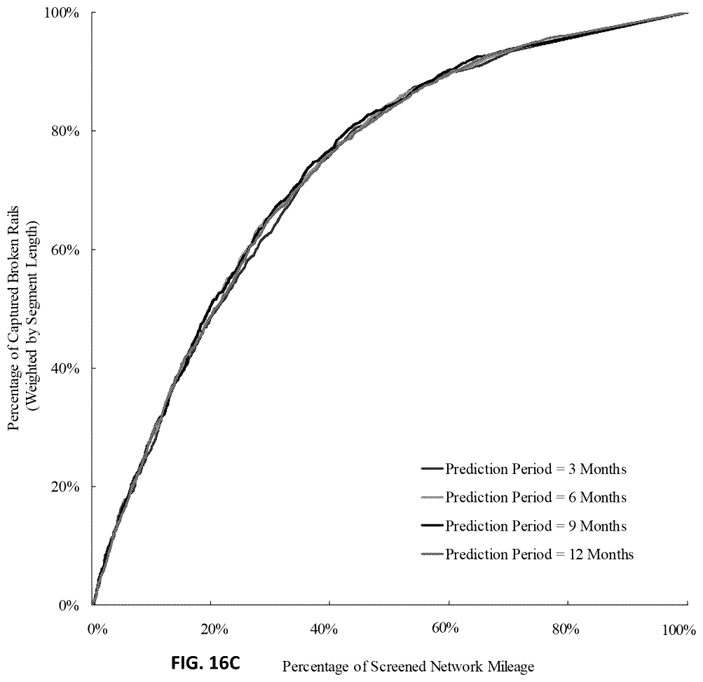

In some embodiments, the advantage of Random Forest can be summarized: 1. Improve the stability and accuracy compared with boosted algorithm; 2. Reduce variance; 3. In noisy data environments, bagging outperforms boosted algorithms. Random forests are an ensemble algorithm which has been proven to work well in many classification problems as depicted in the schematic of FIG. 16A.

TABLE D
1 Pseudo Code of Random Forest
Algorithm: Random Forest

```
  Input: Dataset D ← {(X₁, y₁), (X₂, y₂), . . . , (Xₙ, yₙ)}.
    Feature set F.
    The number of trees in forest M.
  Initialize tree set H = Ø
  for m = 1,2, . . . , M do
    D^{(m)} ← A bootstrap sample from D
    Do while inherent stopping criteria
      d ← Data subset of last split
      f ← Feature subset of F
      Choose the best split based on Gini index
    End do
    hₘ ← The learned tree m
    Ŷᵢ^{m} = hₘ (Xᵢ)
    H = H [symbol]   {hₘ}
  end for
  Output
    $For regression problem , {\hat{Y}}_{i} = \frac{1}{M} {\sum }_{m = 1}^{N} {\hat{Y}}_{i}^{m}$
    For classification problem, Ŷᵢ = majority ({Ŷᵢ^{m}, m = 1, 2, . . . ,
    M })
```

In some embodiments, parameters in Random Forest are either to increase the predictive power of the model or to make it easier to train the model. The optimal values for the parameters which are different from the default value in the package are listed in Table D.2.

TABLE D.2
Hyper-Parameter Setup

| Hyper-parameter | Setup Value |
|---|---|
| Number of estimators | 1,000 |
| Maximum depth of each tree | 12 |
| Minimum samples required to split | 4 |
| bootstrap | True |
| Maximum features | 8 |
| Criterion | Gini |

FIG. 16B depicts the ROC curve for the Random Forest algorithm of some embodiments, with Table D.3 presenting the AUC.

TABLE D.3
Area Under ROC Curve (AUC)

| Prediction Period | AUC |
|---|---|
| 3 Months | 0.78 |
| 6 Months | 0.78 |
| 9 Months | 0.79 |
| 12 Months | 0.79 |

FIG. 16C depicts the network screen curve for the Random Forest algorithm of some embodiments, with Table D.4 presenting the percentage of captured broken rails based on the percentage of screen network mileage. Table D.5 presents the feature information for the top 100 segments of an exemplary dataset.

TABLE D.4
Percentage of Network Screening versus Percentage
of Captured Broken Rails Weighted by Segment
Length with Prediction Period 12 Months

| Percentage of Screened | Percentage of Captured Broken Rails |
|---|---|
| Network Mileage | (Weighted by Segment Length) |
| 10% | 28.0% |
| 20% | 48.7% |
| 30% | 65.4% |
| 40% | 76.0% |
| 50% | 83.6% |

TABLE D.5
Feature Information of Top 100 Segments

| | Annual | | | | | |
|---|---|---|---|---|---|---|
| | Traffic | Rail | Rail | | | |
| Segment | Density | Age | Weight | Speed | Curve | |
| ID | (MGT) | (Year) | (lbs/yard) | (MPH) | Degree | Probability |
| 1 | 7.46 | 65.04 | 132 | 40 | 0.95 | 0.862 |
| 2 | 44.47 | 36.02 | 122 | 40 | 2.10 | 0.858 |
| 3 | 33.32 | 23.90 | 136 | 25 | 3.30 | 0.791 |
| 4 | 79.38 | 2.56 | 136 | 30 | 1.33 | 0.687 |
| 5 | 12.94 | 44.03 | 132 | 60 | 0.00 | 0.654 |
| 6 | 6.91 | 31.02 | 122 | 33 | 0.00 | 0.654 |
| 7 | 36.23 | 18.67 | 137 | 55 | 0.81 | 0.653 |
| 8 | 79.34 | 10.17 | 136 | 35 | 0.96 | 0.651 |
| 9 | 49.32 | 23.86 | 134 | 34 | 2.66 | 0.648 |
| 10 | 36.50 | 46.03 | 122 | 60 | 0.13 | 0.645 |
| 11 | 41.20 | 16.27 | 136 | 60 | 0.00 | 0.643 |
| 12 | 51.15 | 18.01 | 136 | 50 | 0.00 | 0.643 |
| 13 | 69.31 | 4.96 | 136 | 60 | 0.97 | 0.640 |
| 14 | 31.47 | 17.60 | 136 | 60 | 0.00 | 0.640 |
| 15 | 4.76 | 1.78 | 136 | 10 | 2.28 | 0.631 |
| 16 | 10.85 | 21.02 | 132 | 49 | 0.31 | 0.631 |
| 17 | 59.38 | 44.03 | 122 | 60 | 0.00 | 0.629 |
| 18 | 27.09 | 22.09 | 134 | 40 | 1.64 | 0.629 |
| 19 | 0.00 | 21.01 | 136 | 10 | 4.50 | 0.628 |
| 20 | 25.16 | 19.89 | 133 | 40 | 3.07 | 0.627 |
| 21 | 25.16 | 26.02 | 132 | 40 | 0.05 | 0.627 |
| 22 | 7.79 | 42.47 | 122 | 40 | 0.20 | 0.627 |
| 23 | 66.68 | 1.00 | 136 | 50 | 0.00 | 0.625 |
| 24 | 5.97 | 54.04 | 115 | 40 | 1.17 | 0.624 |
| 25 | 28.05 | 34.02 | 122 | 30 | 0.74 | 0.624 |
| 26 | 8.19 | 34.02 | 127 | 40 | 0.42 | 0.621 |
| 27 | 41.65 | 19.11 | 138 | 40 | 0.13 | 0.621 |
| 28 | 0.46 | 32.02 | 100 | 25 | 0.00 | 0.619 |
| 29 | 0.03 | 28.62 | 134 | 30 | 2.81 | 0.616 |
| 30 | 0.03 | 28.62 | 134 | 30 | 2.71 | 0.616 |
| 31 | 6.92 | 26.69 | 125 | 40 | 2.02 | 0.616 |
| 32 | 39.98 | 20.65 | 135 | 40 | 1.30 | 0.614 |
| 33 | 58.35 | 4.82 | 136 | 50 | 0.21 | 0.611 |
| 34 | 49.20 | 7.95 | 141 | 60 | 0.00 | 0.551 |
| 35 | 35.34 | 36.63 | 133 | 28 | 0.20 | 0.532 |
| 36 | 15.37 | 48.42 | 115 | 50 | 0.00 | 0.527 |
| 37 | 15.89 | 44.03 | 132 | 60 | 0.00 | 0.517 |
| 38 | 31.65 | 52.04 | 122 | 55 | 0.26 | 0.510 |
| 39 | 30.80 | 37.02 | 132 | 60 | 0.14 | 0.504 |
| 40 | 58.75 | 47.03 | 132 | 60 | 0.00 | 0.503 |
| 41 | 41.21 | 25.12 | 132 | 50 | 0.11 | 0.487 |
| 42 | 3.36 | 21.91 | 132 | 25 | 3.69 | 0.473 |
| 43 | 9.54 | 37.02 | 122 | 43 | 0.22 | 0.471 |
| 44 | 64.11 | 9.95 | 136 | 60 | 0.00 | 0.465 |
| 45 | 6.40 | 53.04 | 115 | 50 | 0.00 | 0.464 |
| 46 | 7.46 | 53.37 | 132 | 40 | 0.00 | 0.462 |
| 47 | 9.36 | 45.15 | 115 | 45 | 0.44 | 0.461 |
| 48 | 40.00 | −0.82 | 136 | 50 | 0.00 | 0.461 |
| 49 | 42.29 | 33.02 | 122 | 35 | 1.97 | 0.459 |
| 50 | 53.26 | 21.01 | 135 | 50 | 0.94 | 0.458 |
| 51 | 60.25 | 6.46 | 136 | 45 | 1.50 | 0.458 |
| 52 | 48.56 | 40.03 | 139 | 60 | 0.04 | 0.458 |
| 53 | 49.33 | 45.03 | 132 | 60 | 0.00 | 0.457 |
| 54 | 58.88 | 39.39 | 136 | 50 | 0.39 | 0.455 |
| 55 | 18.25 | 35.02 | 122 | 55 | 0.39 | 0.453 |
| 56 | 27.17 | 28.56 | 129 | 50 | 0.00 | 0.452 |
| 57 | 17.89 | 23.83 | 135 | 40 | 1.36 | 0.452 |
| 58 | 1.87 | 70.05 | 90 | 10 | 0.00 | 0.451 |
| 59 | 39.13 | 49.03 | 132 | 50 | 0.20 | 0.451 |
| 60 | 7.69 | 44.03 | 115 | 40 | 0.16 | 0.449 |
| 61 | 67.88 | 37.02 | 132 | 60 | 0.11 | 0.447 |
| 62 | 72.90 | 31.02 | 136 | 60 | 0.00 | 0.446 |
| 63 | 29.59 | 35.02 | 132 | 60 | 0.00 | 0.446 |
| 64 | 18.26 | 35.02 | 122 | 55 | 0.05 | 0.444 |
| 65 | 8.18 | 48.03 | 112 | 50 | 0.10 | 0.443 |
| 66 | 49.44 | 40.03 | 132 | 50 | 0.00 | 0.442 |
| 67 | 72.01 | 17.48 | 134 | 60 | 0.48 | 0.440 |
| 68 | 55.12 | −0.07 | 136 | 60 | 0.00 | 0.440 |
| 69 | 8.17 | 34.02 | 127 | 40 | 0.88 | 0.439 |
| 70 | 27.52 | 3.33 | 136 | 25 | 2.39 | 0.438 |
| 71 | 20.69 | 9.58 | 136 | 40 | 1.00 | 0.437 |
| 72 | 28.32 | 2.29 | 136 | 35 | 0.50 | 0.437 |
| 73 | 0.18 | 32.02 | 132 | 25 | 0.00 | 0.436 |
| 74 | 36.21 | 15.30 | 136 | 46 | 0.91 | 0.436 |
| 75 | 20.11 | 24.96 | 133 | 35 | 1.23 | 0.430 |
| 76 | 5.67 | 26.02 | 115 | 60 | 0.00 | 0.429 |
| 77 | 34.62 | 33.02 | 122 | 55 | 0.00 | 0.428 |
| 78 | 34.38 | 36.02 | 122 | 55 | 0.00 | 0.428 |
| 79 | 34.45 | 33.02 | 122 | 55 | 0.00 | 0.428 |
| 80 | 32.75 | 4.00 | 136 | 20 | 3.00 | 0.428 |
| 81 | 35.67 | 33.02 | 127 | 50 | 0.00 | 0.425 |
| 82 | 35.56 | 33.02 | 127 | 50 | 0.00 | 0.425 |
| 83 | 27.19 | 37.02 | 122 | 55 | 0.08 | 0.425 |
| 84 | 19.83 | 38.42 | 133 | 50 | 0.51 | 0.423 |
| 85 | 22.86 | 27.70 | 137 | 50 | 0.95 | 0.422 |
| 86 | 9.05 | 17.05 | 135 | 60 | 1.97 | 0.422 |
| 87 | 36.65 | 26.79 | 124 | 40 | 2.03 | 0.422 |
| 88 | 11.41 | 11.48 | 115 | 45 | 0.45 | 0.422 |
| 89 | 35.11 | 48.03 | 122 | 50 | 0.27 | 0.420 |
| 90 | 54.33 | 11.33 | 136 | 50 | 0.03 | 0.418 |
| 91 | 26.28 | 39.02 | 122 | 43 | 0.36 | 0.417 |
| 92 | 5.26 | 21.01 | 132 | 40 | 0.26 | 0.415 |
| 93 | 75.52 | 16.04 | 136 | 40 | 2.27 | 0.409 |
| 94 | 63.01 | 21.01 | 136 | 50 | 0.00 | 0.407 |
| 95 | 93.55 | 25.92 | 136 | 50 | 0.00 | 0.407 |
| 96 | 9.00 | 27.74 | 131 | 56 | 0.43 | 0.407 |
| 97 | 38.28 | 23.86 | 134 | 50 | 0.37 | 0.406 |
| 98 | 57.54 | 18.73 | 135 | 42 | 0.76 | 0.406 |
| 99 | 6.80 | 33.02 | 122 | 55 | 0.00 | 0.402 |
| 100 | 9.38 | 40.03 | 122 | 50 | 0.00 | 0.402 |

### Example—Light Gradient Boosting Machine Algorithm for Infrastructure Degradation Prediction

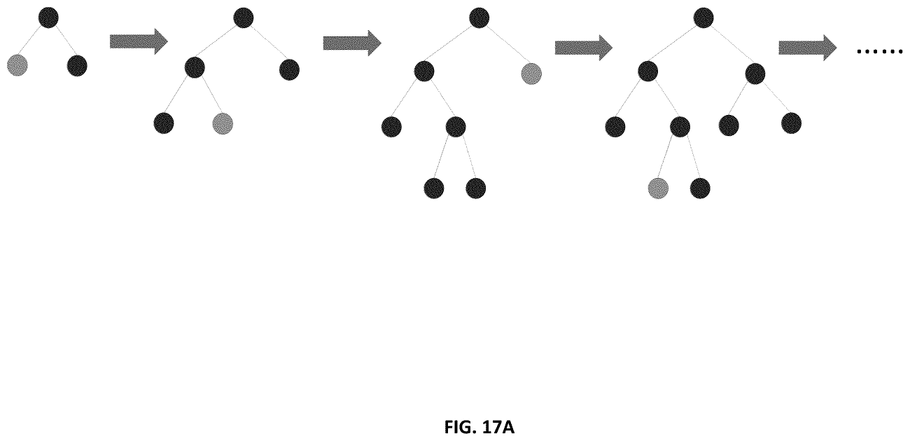

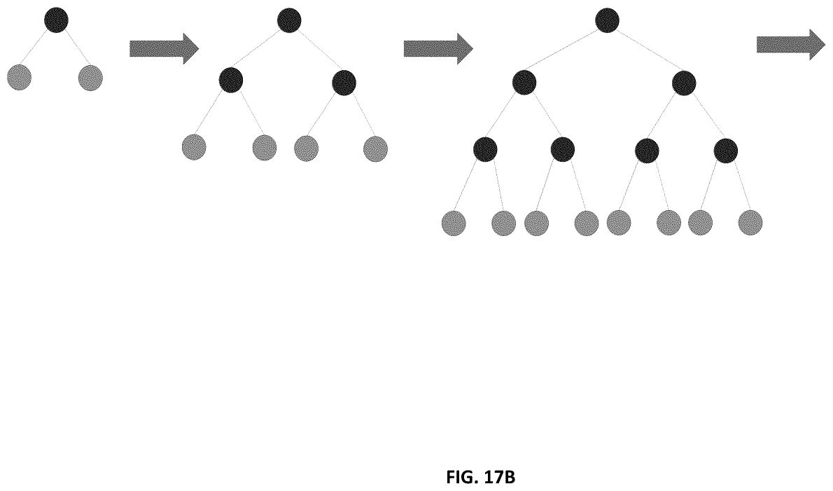

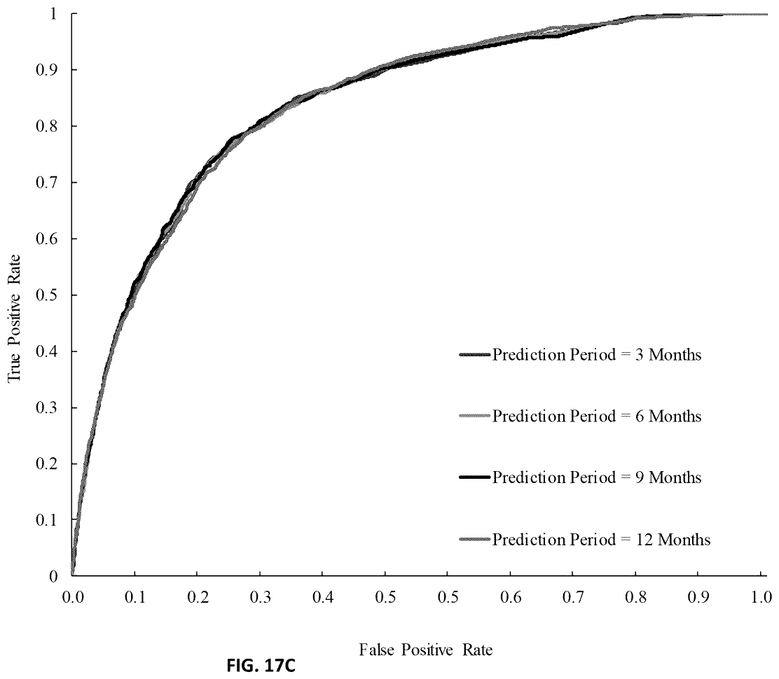

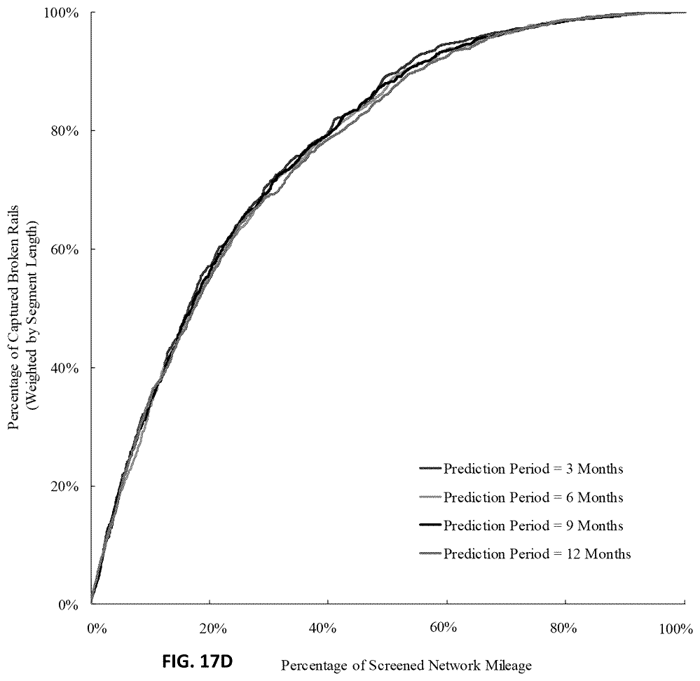

In some embodiments, a light gradient boosting machine (LightGBM) algorithm may be employed to generate the predictions for infrastructure degradation and infrastructure degradation-related failures. In some embodiments, LightGBM is a Gradient boosting decision tree (GBDT) implementation to tackle the time consumption issue when handling big data. GBDT is a widely used machine learning algorithm, due to its efficiency, accuracy, and interpretability. Conventional implementation of GBDT may, for every feature, survey all the data instances to estimate the information gain of all the possible split points. Therefore, the computational complexities may be proportional to the number of feature as well as the number of instances. LightGBM combines Gradient-based One-Side Sampling (GOSS) and Exclusive Feature Bundling (EFB) with gradient boosting decision tree algorithm to tackle large data problem. In some embodiments, LightGBM, which is based on the decision tree algorithm, splits the tree leaf wised with the best fit whereas other boosting algorithms split the tree depth-wise or level-wise. Therefore, when growing on the same leaf in LightGBM, the leaf-wise algorithm (FIG. 17A) can reduce more loss than the level-wise algorithm (FIG. 17B) and hence results in much better accuracy which can rarely be achieved by any of the existing boosting algorithms.

In some embodiments, GOSS has the ability to reduce the number of data instances, while EFB reduces the number of features. During down-sample data instances for GOSS, in order to retain the accuracy of information gain estimation, instances with large gradients are kept, and randomly drop those instances with small gradients. It is hypothesized that instances with larger gradients may contribute more to the information gain. In some embodiments, due to the sparsity of feature space in big data, EFB is a designed nearly loss-less approach to reduce the number of effective features. Specifically, in a spare feature space, many features are mutually exclusive which can be bundled effectively. Through a greedy algorithm, an efficient method can be solved with the objective function to reduce the optimal bundling problem. EFB algorithm can bundle many exclusive features to the much fewer dense features, which can effectively avoid unnecessary computation for zero feature values.

In some embodiments, the optimal values for the parameters of LightGBM which are different from the default value in the package are listed in Table E. 1.

TABLE E.1
Hyper-Parameter Setup

| Hyper-parameter | Setup Value |
|---|---|
| Number of rounds | 100 |
| Subsampling ratio for each tree | 0.8 |
| Maximum depth of each tree | 5 |
| Lambda 12 | 0.01 |
| Feature sampling for each tree | 0.8 |
| Number of leaves | 96 |
| Learning rate | 0.05 |

FIG. 17C depicts the ROC curve for the Light Gradient Boosting Machine algorithm of some embodiments, with Table E.2 presenting the AUC.

TABLE E.2
Area Under ROC Curve (AUC)

| Prediction Period | AUC |
|---|---|
| 3 Months | 0.83 |
| 6 Months | 0.83 |
| 9 Months | 0.83 |
| 12 Months | 0.84 |

FIG. 17D depicts the network screen curve for the Light Gradient Boosting algorithm of some embodiments, with Table E.3 presenting the percentage of captured broken rails based on the percentage of screen network mileage. Table E.4 presents the feature information for the top 100 segments of an example dataset.

TABLE E.3
Percentage of Network Screening versus Percentage
of Captured Broken Rails Weighted by
Segment Length with Prediction Period 12 Months

| Percentage of Screened | Percentage of Captured Broken Rails |
|---|---|
| Network Mileage | (Weighted by Segment Length) |
| 10% | 34.6% |
| 20% | 55.0% |
| 30% | 69.0% |
| 40% | 78.6% |
| 50% | 86.2% |

TABLE E.4
Feature Information of Top 100 Segments

| | Annual | | | | | |
|---|---|---|---|---|---|---|
| | Traffic | Rail | Rail | | | |
| Segment | Density | Age | Weight | Speed | Curve | |
| ID | (MGT) | (Year) | (lbs/yard) | (MPH) | Degree | Probability |
| 1 | 67.88 | 15.91 | 135 | 50 | 1.19 | 0.593 |
| 2 | 53.26 | 21.01 | 135 | 50 | 0.94 | 0.575 |
| 3 | 43.22 | 36.02 | 132 | 60 | 0.01 | 0.571 |
| 4 | 76.70 | 20.19 | 136 | 40 | 0.83 | 0.549 |
| 5 | 46.42 | 25.18 | 134 | 30 | 0.62 | 0.507 |
| 6 | 39.64 | 22.92 | 133 | 40 | 1.85 | 0.504 |
| 7 | 59.83 | 2.40 | 136 | 50 | 0.34 | 0.491 |
| 8 | 50.82 | 13.95 | 136 | 33 | 2.13 | 0.487 |
| 9 | 45.34 | 32.52 | 133 | 60 | 0.15 | 0.468 |
| 10 | 57.67 | 23.07 | 136 | 47 | 1.43 | 0.466 |
| 11 | 75.52 | 16.04 | 136 | 40 | 2.27 | 0.465 |
| 12 | 40.96 | 26.98 | 133 | 30 | 0.60 | 0.460 |
| 13 | 50.79 | 31.70 | 134 | 37 | 1.31 | 0.459 |
| 14 | 57.23 | 11.85 | 136 | 50 | 0.33 | 0.448 |
| 15 | 63.16 | 15.55 | 136 | 21 | 0.41 | 0.447 |
| 16 | 55.33 | 26.71 | 135 | 50 | 0.44 | 0.444 |
| 17 | 24.00 | 52.03 | 132 | 30 | 0.00 | 0.440 |
| 18 | 38.73 | 30.38 | 135 | 60 | 0.25 | 0.437 |
| 19 | 57.36 | 40.17 | 139 | 50 | 0.34 | 0.428 |
| 20 | 85.58 | 33.82 | 134 | 60 | 0.00 | 0.425 |
| 21 | 62.45 | 11.51 | 136 | 46 | 1.00 | 0.424 |
| 22 | 78.07 | 21.49 | 136 | 45 | 0.21 | 0.412 |
| 23 | 54.33 | 11.33 | 136 | 50 | 0.03 | 0.406 |
| 24 | 54.89 | 35.32 | 139 | 50 | 0.42 | 0.400 |
| 25 | 49.76 | 4.26 | 136 | 25 | 2.83 | 0.399 |
| 26 | 57.54 | 18.73 | 135 | 42 | 0.76 | 0.398 |
| 27 | 58.77 | 25.95 | 134 | 50 | 0.30 | 0.395 |
| 28 | 42.74 | 21.44 | 136 | 40 | 1.61 | 0.390 |
| 29 | 44.93 | 18.95 | 135 | 38 | 1.43 | 0.383 |
| 30 | 36.25 | 13.01 | 136 | 28 | 0.79 | 0.382 |
| 31 | 41.66 | 22.93 | 133 | 40 | 1.47 | 0.380 |
| 32 | 33.51 | 32.02 | 136 | 60 | 0.14 | 0.377 |
| 33 | 35.65 | 38.62 | 132 | 48 | 0.39 | 0.376 |
| 34 | 65.02 | 9.87 | 132 | 60 | 0.00 | 0.375 |
| 35 | 36.49 | 30.71 | 129 | 60 | 0.74 | 0.375 |
| 36 | 41.51 | 14.75 | 136 | 35 | 2.11 | 0.374 |
| 37 | 58.90 | 10.66 | 136 | 50 | 0.27 | 0.374 |
| 38 | 49.58 | 35.69 | 132 | 50 | 0.29 | 0.372 |
| 39 | 41.91 | 20.80 | 136 | 33 | 2.13 | 0.365 |
| 40 | 38.67 | 48.03 | 132 | 60 | 0.00 | 0.365 |
| 41 | 36.65 | 26.79 | 124 | 40 | 2.03 | 0.362 |
| 42 | 77.05 | 19.16 | 136 | 37 | 1.42 | 0.362 |
| 43 | 48.89 | 44.03 | 137 | 30 | 0.00 | 0.360 |
| 44 | 55.21 | 31.02 | 136 | 59 | 0.00 | 0.359 |
| 45 | 47.03 | 13.59 | 137 | 40 | 1.26 | 0.358 |
| 46 | 67.81 | 26.37 | 129 | 60 | 0.25 | 0.357 |
| 47 | 58.88 | 39.39 | 136 | 50 | 0.39 | 0.353 |
| 48 | 91.67 | 35.02 | 122 | 60 | 0.00 | 0.351 |
| 49 | 65.67 | 3.01 | 136 | 52 | 1.72 | 0.349 |
| 50 | 78.91 | 34.98 | 122 | 57 | 0.00 | 0.348 |
| 51 | 74.68 | 7.56 | 136 | 50 | 0.09 | 0.348 |
| 52 | 34.96 | 22.87 | 133 | 45 | 1.09 | 0.348 |
| 53 | 41.30 | 21.94 | 133 | 40 | 1.98 | 0.347 |
| 54 | 70.21 | 4.11 | 136 | 28 | 2.00 | 0.347 |
| 55 | 54.01 | 24.65 | 134 | 35 | 1.92 | 0.346 |
| 56 | 42.03 | 23.16 | 128 | 35 | 2.96 | 0.345 |
| 57 | 40.18 | 29.34 | 133 | 60 | 0.00 | 0.344 |
| 58 | 55.19 | 17.40 | 136 | 50 | 0.09 | 0.343 |
| 59 | 70.90 | 31.22 | 136 | 58 | 0.00 | 0.342 |
| 60 | 85.87 | 18.67 | 135 | 58 | 0.73 | 0.339 |
| 61 | 35.11 | 48.03 | 122 | 50 | 0.27 | 0.338 |
| 62 | 35.11 | 41.94 | 140 | 47 | 0.00 | 0.338 |
| 63 | 47.68 | 25.14 | 136 | 40 | 1.59 | 0.338 |
| 64 | 35.78 | 41.03 | 132 | 50 | 0.09 | 0.337 |
| 65 | 42.74 | 3.96 | 134 | 50 | 0.02 | 0.333 |
| 66 | 74.69 | 0.39 | 136 | 50 | 0.17 | 0.331 |
| 67 | 41.17 | 23.58 | 136 | 40 | 1.31 | 0.330 |
| 68 | 46.68 | 28.23 | 133 | 50 | 0.21 | 0.325 |
| 69 | 32.19 | 27.02 | 132 | 50 | 0.01 | 0.324 |
| 70 | 43.24 | 29.67 | 136 | 59 | 0.17 | 0.324 |
| 71 | 81.86 | 11.35 | 136 | 24 | 2.06 | 0.323 |
| 72 | 41.93 | 11.27 | 136 | 33 | 2.86 | 0.323 |
| 73 | 24.13 | 19.72 | 131 | 49 | 1.19 | 0.323 |
| 74 | 67.76 | 2.00 | 136 | 50 | 0.00 | 0.321 |
| 75 | 55.49 | 16.48 | 135 | 30 | 1.04 | 0.321 |
| 76 | 22.82 | 40.89 | 124 | 50 | 0.81 | 0.319 |
| 77 | 71.87 | 18.86 | 136 | 40 | 0.94 | 0.318 |
| 78 | 40.72 | 23.92 | 136 | 50 | 0.00 | 0.318 |
| 79 | 22.12 | 38.55 | 122 | 55 | 0.16 | 0.318 |
| 80 | 53.59 | 11.71 | 141 | 60 | 0.17 | 0.317 |
| 81 | 43.81 | 37.80 | 132 | 59 | 0.18 | 0.317 |
| 82 | 59.04 | 25.21 | 136 | 40 | 2.02 | 0.316 |
| 83 | 41.65 | 11.52 | 139 | 40 | 1.78 | 0.316 |
| 84 | 38.56 | 48.03 | 132 | 60 | 0.00 | 0.316 |
| 85 | 33.45 | 4.43 | 124 | 55 | 0.00 | 0.315 |
| 86 | 67.82 | 25.99 | 132 | 60 | 0.36 | 0.313 |
| 87 | 39.63 | 25.22 | 129 | 50 | 0.67 | 0.313 |
| 88 | 58.79 | 25.77 | 136 | 50 | 0.17 | 0.310 |
| 89 | 74.78 | 22.48 | 134 | 40 | 1.13 | 0.310 |
| 90 | 32.05 | 35.38 | 124 | 50 | 0.50 | 0.309 |
| 91 | 39.67 | 19.89 | 134 | 45 | 1.99 | 0.307 |
| 92 | 36.29 | 37.80 | 134 | 47 | 1.50 | 0.306 |
| 93 | 46.78 | 27.51 | 136 | 49 | 0.99 | 0.306 |
| 94 | 78.45 | 18.98 | 136 | 49 | 0.69 | 0.306 |
| 95 | 34.33 | 35.85 | 133 | 60 | 0.23 | 0.304 |
| 96 | 70.17 | 1.48 | 136 | 60 | 0.11 | 0.302 |
| 97 | 21.77 | 32.11 | 128 | 50 | 0.62 | 0.301 |
| 98 | 50.29 | 16.24 | 136 | 60 | 0.09 | 0.300 |
| 99 | 19.94 | 36.02 | 132 | 60 | 0.00 | 0.300 |
| 100 | 53.72 | 2.75 | 136 | 50 | 0.73 | 0.300 |

### Example—Logistic Regression Algorithm for Infrastructure Degradation Prediction

In some embodiments, a Logistic Regression Algorithm may be employed to generate the predictions for infrastructure degradation and infrastructure degradation-related failures. In some embodiments, for logistic regression, the purpose is to find the best fitting model to describe the relationship between the dichotomous characteristic of interest and the associated set of independent explanatory variables. In logistic regression, the dichotomous characteristic of interest indicates a single outcome variable Yᵢ (i=1, . . . , n) which represents whether the event of interest occurs or not. The outcome variable follows a Bernoulli probability function that takes on the value 1 with probability pᵢ and 0 with probability 1−pᵢ. pᵢ varies over the observations as an inverse logistic function of a vector Xᵢ, which includes a constant and k−1 explanatory variables:

$${Y}_{i} ∼ Bernoulli ( {Y}_{i} \vert {p}_{i} ) \qquad ( F - 1 )$$

$${p}_{i} = \frac{1}{1 + {e}^{- {X}_{i} β}} \qquad ( F - 2 )$$

The Bernoulli has probability function P(Yᵢ|pᵢ)=pᵢ^{Y}^{ᵢ}(1−pᵢ)^{1-Y}^{ᵢ}. The unknown parameter ρ=(β₀,β′₁)′ is a k×1 vector, where β₀ is a scalar constant term and β₁ is a vector with parameters corresponding to the explanatory variables.

In some embodiments, assuming the N training data points are generated individually, the parameters are estimated by maximum likelihood, with the likelihood function formed by assuming independence over the observations: L(β|Y)=Πᵢ^{N}pᵢ^{Y}^{ᵢ}(1−pᵢ)^{1-Y}^{ᵢ}, where Y={Yᵢ=1, . . . , N}. By taking logs and using Eq. (F-2), the log-likelihood simplifies to

L(β|Y)=Σ_{Y}_{ᵢ}₌₁ ln(pᵢ)+Σ_{Y}_{ᵢ}₌₀ ln(1−pᵢ)=−Σᵢ₌₁^{N} ln(1+e^{(1-2Y}^{ᵢ}^{)X}^{ᵢ}^{β)} (F-3)

Maximum-likelihood logit analysis then works by finding the value of β that gives the maximum value of this function.

TABLE F
1 Pseudo Code of Logistic Regression
Algorithm: Logistic Regression

```
  Input: Dataset D ← {(X₁, y₁), (X₂, y₂), . . . , (Xₙ, yₙ)} Xᵢ =
  (xᵢ¹, xᵢ², . . . , xᵢ^{m}).
    Feature set F.
    The number of features m.
    The learning rate η
    Coefficients β = (β₀, β₁, . . . , βₘ)
    X′ᵢ = {1, Xᵢ}
    $Data likelihood = {\prod }_{i}^{n} P ( {y}_{i} \vert {X}_{i}^{′} , β )$
    To estimate the coefficients β of parameters, minimize
    ${E}_{in} ( β ) = \frac{1}{n} {\sum }_{i = 1}^{n} ln ( 1 + {e}^{- {y}_{i} \cdot {β}^{T} {X}_{i}^{′}} )$
For t = 0, 1, 2, . . . do
    Compute the gradient
    gₜ = ∇Eᵢₙ(β(t))
    Move in the direction vₜ = −gₜ
    Update the coefficient
    β(t + 1) = B(t) + ηvₜ
    ΔEᵢₙ = Eᵢₙ(β(t + 1)) − Eᵢₙ(β(t))
    Iterate until |ΔEᵢₙ| ≤ ε
End for
```

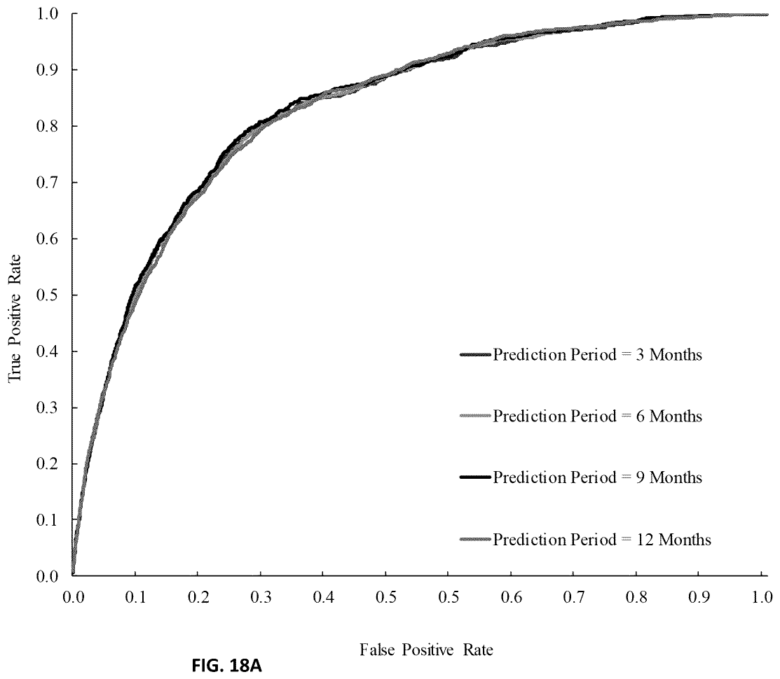

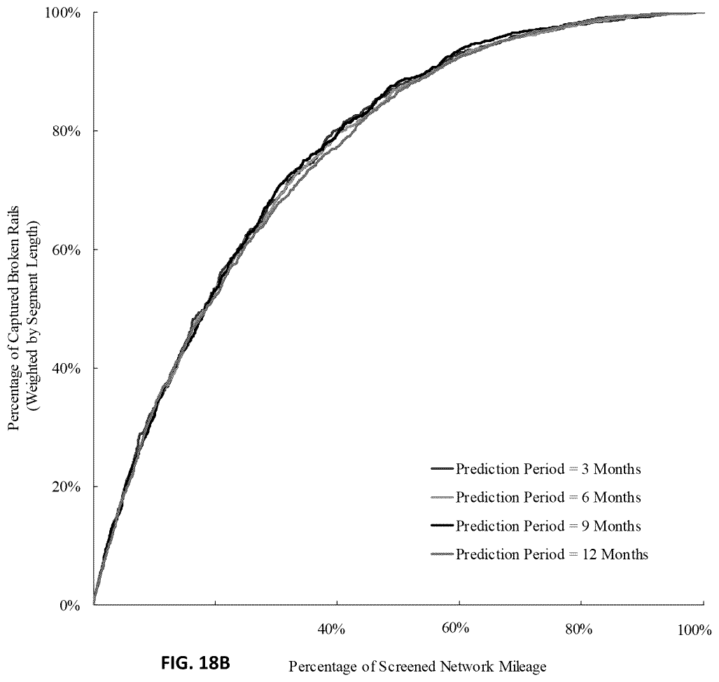

FIG. 18A depicts the ROC curve for the Logistic Regression algorithm of some embodiments, with Table F.2 presenting the AUC.

TABLE F.2
Area Under ROC Curve (AUC)

| Prediction Period | AUC |
|---|---|
| 3 Months | 0.81 |
| 6 Months | 0.82 |
| 9 Months | 0.82 |
| 12 Months | 0.82 |

FIG. 18B depicts the network screen curve for the Logistic Regression algorithm of some embodiments, with Table F.3 presenting the percentage of captured broken rails based on the percentage of screen network mileage.

TABLE F.3
Percentage of Network Screening versus Percentage
of Captured Broken Rails Weighted by Segment
Length with Prediction Period 12 Months

| Percentage of Screened | Percentage of Captured Broken Rails |
|---|---|
| Network Mileage | (Weighted by Segment Length) |
| 10% | 30.4% |
| 20% | 49.8% |
| 30% | 62.1% |
| 40% | 77.3% |
| 50% | 82.1% |

### Example—Cox Proportional Hazards Regression Model Algorithm for Infrastructure Degradation Prediction

In some embodiments, a cox proportional hazards regression model algorithm may be employed to generate the predictions for infrastructure degradation and infrastructure degradation-related failures. In some embodiments, the purpose of cox proportional hazards regression model is to evaluate simultaneously the effect of several risk factors on survival. It allows to examine how specified risk factors influence the occurrence rate of a particular event of interest (e.g., occurrence of broken rails) at a particular point in time. This rate is commonly referred as the hazard rate. Predictor variables (or risk factors) are usually termed covariates in the cox proportional hazards regression algorithm. The cox proportional hazard regression model is expressed by the hazard function denoted by h(t). The hazard function can be interpreted as the risk of the occurrence of specified event at time t. It can be estimated as

h(t)=h₀(t)×exp(b₁x₁+b₂x₂+ . . . +bₚxₚ) (G-1)

where,
t represents the survival time,
h(t) is the hazard function determined by a set of p covariates (x₁, x₂, . . . , xₚ), the coefficients (b₁, b₂, . . . , bₚ) measure the impact of the covariates on the cocurrent rate h₀ is the baseline hazard.

In some embodiments, the quantities exp(bᵢ) are called hazard ratios. A value of b₁ greater than zero, or equivalently a hazard ratio greater than one, indicates that as the value of the i-th covariate increases, the event hazard increases and thus the length of survival decreases.

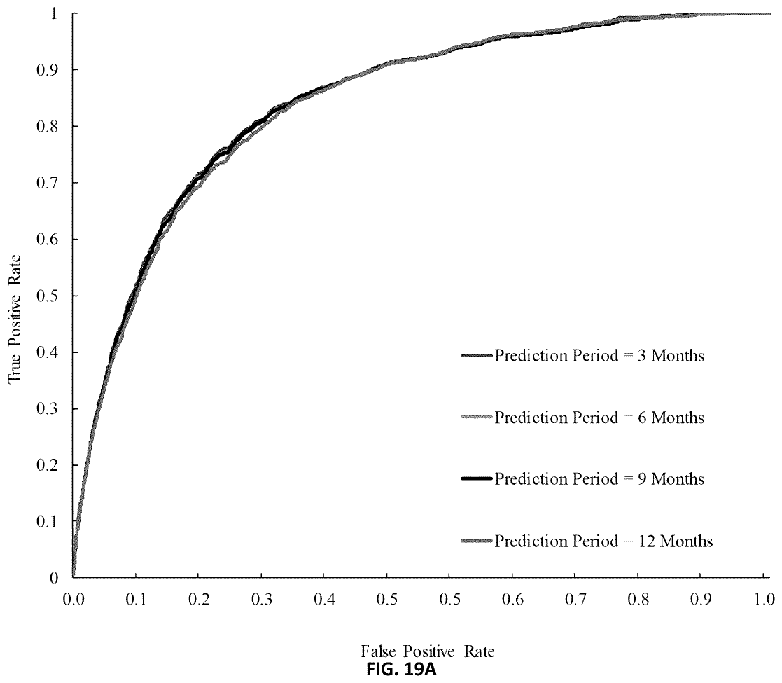

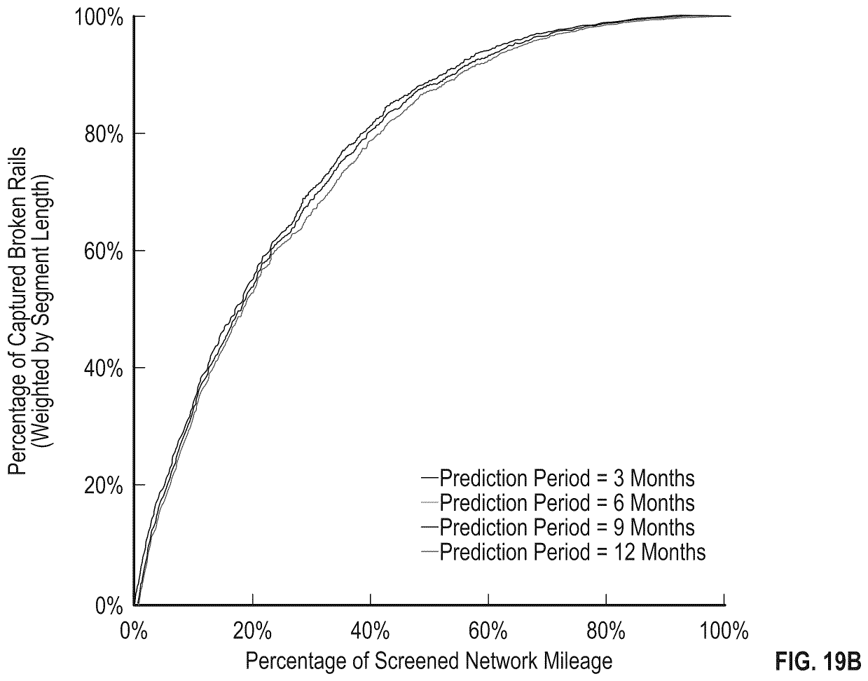

FIG. 19A depicts the ROC curve for the Random Forest algorithm of some embodiments, with Table G.1 presenting the AUC.

TABLE G.1
Area Under ROC Curve (AUC)

| Prediction Period | AUC |
|---|---|
| 3 Months | 0.82 |
| 6 Months | 0.83 |
| 9 Months | 0.84 |
| 12 Months | 0.84 |

FIG. 19B depicts the network screen curve for the Cox Proportional Hazard Regression algorithm of some embodiments, with Table G.2 presenting the percentage of captured broken rails based on the percentage of screen network mileage. Table G.3 presents feature information for the top 100 segments in an example dataset.

TABLE G.2
Percentage of Network Screening versus Percentage
of Captured Broken Rails Weighted by Segment
Length with Prediction Period 12 Months

| Percentage of Screened | Percentage of Captured Broken Rails |
|---|---|
| Network Mileage | (Weighted by Segment Length) |
| 10% | 33.2% |
| 20% | 53.2% |
| 30% | 67.7% |
| 40% | 79.2% |
| 50% | 87.4% |

TABLE G.3
Feature Information of Top 100 Segments

| | Annual | | | | | |
|---|---|---|---|---|---|---|
| | Traffic | Rail | Rail | | | |
| Segment | Density | Age | Weight | Speed | Curve | |
| ID | (MGT) | (Year) | (lbs/yard) | (MPH) | Degree | Probability |
| 1 | 72.49 | 32.02 | 136 | 60 | 0.00 | 0.695 |
| 2 | 53.26 | 21.01 | 135 | 50 | 0.94 | 0.632 |
| 3 | 70.90 | 31.22 | 136 | 58 | 0.00 | 0.569 |
| 4 | 65.02 | 9.87 | 132 | 60 | 0.00 | 0.563 |
| 5 | 35.32 | 41.00 | 134 | 30 | 1.77 | 0.541 |
| 6 | 50.62 | 21.79 | 134 | 30 | 2.07 | 0.523 |
| 7 | 50.00 | 38.30 | 131 | 50 | 0.00 | 0.510 |
| 8 | 48.89 | 44.03 | 137 | 30 | 0.00 | 0.495 |
| 9 | 65.67 | 12.71 | 136 | 45 | 1.39 | 0.492 |
| 10 | 75.52 | 16.04 | 136 | 40 | 2.27 | 0.485 |
| 11 | 77.05 | 19.16 | 136 | 37 | 1.42 | 0.470 |
| 12 | 57.36 | 40.17 | 139 | 50 | 0.34 | 0.464 |
| 13 | 42.46 | 36.02 | 132 | 50 | 0.00 | 0.460 |
| 14 | 33.28 | 39.02 | 122 | 55 | 0.00 | 0.457 |
| 15 | 78.91 | 34.98 | 122 | 57 | 0.00 | 0.445 |
| 16 | 58.90 | 10.66 | 136 | 50 | 0.27 | 0.435 |
| 17 | 54.01 | 24.65 | 134 | 35 | 1.92 | 0.428 |
| 18 | 40.18 | 29.34 | 133 | 60 | 0.00 | 0.427 |
| 19 | 39.63 | 33.02 | 127 | 57 | 0.00 | 0.409 |
| 20 | 35.11 | 48.03 | 122 | 50 | 0.27 | 0.408 |
| 21 | 37.50 | 41.13 | 123 | 50 | 0.26 | 0.399 |
| 22 | 67.81 | 26.37 | 129 | 60 | 0.25 | 0.397 |
| 23 | 59.83 | 2.40 | 136 | 50 | 0.34 | 0.385 |
| 24 | 55.33 | 26.71 | 135 | 50 | 0.44 | 0.381 |
| 25 | 50.79 | 31.70 | 134 | 37 | 1.31 | 0.379 |
| 26 | 85.58 | 33.82 | 134 | 60 | 0.00 | 0.372 |
| 27 | 85.87 | 18.67 | 135 | 58 | 0.73 | 0.368 |
| 28 | 77.71 | 22.35 | 135 | 45 | 0.89 | 0.366 |
| 29 | 35.65 | 38.62 | 132 | 48 | 0.39 | 0.364 |
| 30 | 43.22 | 36.02 | 132 | 60 | 0.01 | 0.361 |
| 31 | 74.78 | 19.38 | 136 | 39 | 1.32 | 0.356 |
| 32 | 42.24 | 27.55 | 133 | 39 | 0.99 | 0.355 |
| 33 | 42.74 | 21.44 | 136 | 40 | 1.61 | 0.353 |
| 34 | 42.43 | 35.56 | 127 | 60 | 0.09 | 0.353 |
| 35 | 48.83 | 33.02 | 132 | 60 | 0.00 | 0.348 |
| 36 | 74.78 | 22.48 | 134 | 40 | 1.13 | 0.348 |
| 37 | 48.96 | 33.02 | 132 | 60 | 0.00 | 0.346 |
| 38 | 37.57 | 29.50 | 133 | 56 | 1.04 | 0.343 |
| 39 | 32.85 | 33.02 | 131 | 60 | 0.00 | 0.340 |
| 40 | 45.34 | 32.52 | 133 | 60 | 0.15 | 0.340 |
| 41 | 34.71 | 39.59 | 132 | 50 | 0.00 | 0.339 |
| 42 | 66.21 | 41.03 | 132 | 50 | 0.00 | 0.339 |
| 43 | 44.93 | 18.95 | 135 | 38 | 1.43 | 0.339 |
| 44 | 50.16 | 18.69 | 136 | 60 | 0.00 | 0.338 |
| 45 | 36.08 | 37.26 | 125 | 44 | 1.25 | 0.336 |
| 46 | 46.42 | 25.18 | 134 | 30 | 0.62 | 0.336 |
| 47 | 19.13 | 40.03 | 127 | 47 | 0.00 | 0.335 |
| 48 | 67.54 | 26.66 | 128 | 60 | 0.00 | 0.332 |
| 49 | 66.01 | 22.49 | 133 | 44 | 1.12 | 0.329 |
| 50 | 37.44 | 30.83 | 131 | 58 | 0.00 | 0.329 |
| 51 | 63.21 | 21.33 | 135 | 50 | 0.41 | 0.326 |
| 52 | 35.78 | 41.03 | 132 | 50 | 0.09 | 0.325 |
| 53 | 47.63 | 36.02 | 122 | 50 | 0.00 | 0.324 |
| 54 | 91.67 | 35.02 | 122 | 60 | 0.00 | 0.322 |
| 55 | 80.22 | 24.21 | 136 | 59 | 0.09 | 0.322 |
| 56 | 79.92 | 30.23 | 136 | 60 | 0.68 | 0.321 |
| 57 | 57.68 | 33.67 | 139 | 50 | 0.21 | 0.319 |
| 58 | 39.95 | 31.79 | 134 | 38 | 1.46 | 0.318 |
| 59 | 59.27 | 36.96 | 140 | 50 | 0.25 | 0.316 |
| 60 | 34.96 | 22.87 | 133 | 45 | 1.09 | 0.314 |
| 61 | 25.40 | 35.01 | 132 | 40 | 0.86 | 0.312 |
| 62 | 20.30 | 30.02 | 132 | 60 | 0.23 | 0.312 |
| 63 | 41.66 | 22.93 | 133 | 40 | 1.47 | 0.308 |
| 64 | 30.59 | 35.82 | 125 | 38 | 1.10 | 0.308 |
| 65 | 53.38 | 7.61 | 135 | 60 | 0.17 | 0.308 |
| 66 | 45.46 | 35.15 | 133 | 45 | 0.78 | 0.308 |
| 67 | 63.49 | 37.02 | 132 | 50 | 0.00 | 0.305 |
| 68 | 23.22 | 36.58 | 132 | 60 | 0.00 | 0.304 |
| 69 | 58.94 | 18.01 | 136 | 60 | 0.00 | 0.303 |
| 70 | 58.43 | 31.45 | 134 | 50 | 0.32 | 0.302 |
| 71 | 67.36 | 46.86 | 123 | 60 | 0.05 | 0.301 |
| 72 | 46.72 | 26.97 | 128 | 50 | 0.06 | 0.299 |
| 73 | 35.46 | 30.27 | 116 | 40 | 0.75 | 0.299 |
| 74 | 33.51 | 41.03 | 132 | 50 | 0.00 | 0.298 |
| 75 | 41.91 | 20.80 | 136 | 33 | 2.13 | 0.298 |
| 76 | 67.97 | 22.20 | 136 | 35 | 0.70 | 0.296 |
| 77 | 36.29 | 37.80 | 134 | 47 | 1.50 | 0.296 |
| 78 | 35.34 | 36.63 | 133 | 28 | 0.20 | 0.295 |
| 79 | 81.27 | 39.63 | 126 | 55 | 0.17 | 0.295 |
| 80 | 29.44 | 48.03 | 132 | 60 | 0.05 | 0.294 |
| 81 | 59.04 | 25.21 | 136 | 40 | 2.02 | 0.294 |
| 82 | 34.70 | 32.02 | 127 | 40 | 1.00 | 0.294 |
| 83 | 33.49 | 56.04 | 132 | 50 | 0.03 | 0.293 |
| 84 | 33.00 | 38.88 | 132 | 35 | 1.11 | 0.292 |
| 85 | 25.14 | 31.22 | 133 | 50 | 0.82 | 0.291 |
| 86 | 69.38 | 27.02 | 132 | 50 | 0.00 | 0.290 |
| 87 | 44.99 | 26.13 | 133 | 59 | 0.17 | 0.290 |
| 88 | 76.70 | 20.19 | 136 | 40 | 0.83 | 0.286 |
| 89 | 32.40 | 29.66 | 132 | 50 | 0.64 | 0.286 |
| 90 | 60.65 | 43.03 | 132 | 60 | 0.03 | 0.285 |
| 91 | 55.88 | 9.12 | 135 | 50 | 0.14 | 0.285 |
| 92 | 60.66 | 22.01 | 136 | 50 | 0.00 | 0.284 |
| 93 | 50.23 | 45.11 | 136 | 60 | 0.07 | 0.282 |
| 94 | 36.48 | 35.85 | 128 | 54 | 0.50 | 0.282 |
| 95 | 22.37 | 33.52 | 133 | 54 | 0.40 | 0.282 |
| 96 | 37.72 | 35.18 | 126 | 50 | 0.30 | 0.280 |
| 97 | 43.81 | 37.80 | 132 | 59 | 0.18 | 0.280 |
| 98 | 49.55 | 32.62 | 136 | 48 | 0.54 | 0.280 |
| 99 | 39.41 | 41.17 | 124 | 60 | 0.26 | 0.279 |
| 100 | 41.17 | 23.58 | 136 | 40 | 1.31 | 0.279 |

### Example—Artificial Neural Network Algorithm for Infrastructure Degradation Prediction

In some embodiments, an Artificial Neural Network algorithm may be employed to generate the predictions for infrastructure degradation and infrastructure degradation-related failures. In some embodiments, the Artificial Neural Network is another main tool in machine learning. Neural networks include input and output layers, as well as (in most cases) a hidden layer consisting of units that transform the input into something that the output layer can use. They are excellent tools for finding patterns which are far too complex or numerous for a human programmer to extract and teach the machine to recognize. The output of the entire network, as a response to an input vector, is generated by applying certain arithmetic operations, determined by the neural networks. In the prediction of broken-rail-caused derailment severity, the neural network can use a finite number of past observations as training data and then make predictions for testing data.

In some embodiments, the prediction accuracy of these four models, which are Zero-Truncated Negative Binomial, random forest, gradient boosting, and artificial neural network, are presented in below table. MSE (Mean Square Error) and MAE (Mean Absolute Error) are employed as two metrics.

TABLE H.1
Prediction Accuracy of Alternative Models

| Prediction Models | MSE | MAE |
|---|---|---|
| Random Forest | 48.30 | 4.89 |
| Gradient Boosting | 52.50 | 5.00 |
| Artificial Neural Network | 55.68 | 5.23 |

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk™, TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux, (2) Microsoft Windows, (3) OS X (Mac OS), (4) Solaris, (5) UNIX (6) VMWare, (7) Android, (8) Java Platforms, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

As used herein, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RCS, CAST and Skipjack), cryptographic hash algorithms (e.g., MD5, RIPEMD-160, RTR0, SHA-1, SHA-2, Tiger (TTH),WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein, and/or a consumer of data supplied by a data provider. By way of example, and not limitation, the terms “user” or “subscriber” can refer to a person who receives data provided by the data or service provider over the Internet in a browser session or can refer to an automated software application which receives the data and stores or processes the data.

At least some aspects of the present disclosure will now be described with reference to the following numbered clauses.

1. A method, comprising:
receiving, by a processor, a first dataset with time-independent characteristics associated with a plurality of infrastructure assets of an infrastructural system;
receiving, by the processor, a second dataset with time-dependent characteristics associated with the plurality of infrastructure assets;
segmenting, by the processor, the infrastructural system to group segments of a plurality of asset components into the plurality of infrastructure assets; generating, by the processor, a plurality of data records comprising a data record for each infrastructure asset of the plurality of infrastructure assets wherein each data record from the plurality of data records comprises:
   i) a subset of the first dataset comprising time-independent characteristics associated with the plurality of asset components, and
   ii) a subset of the second dataset comprising time-dependent characteristics associated with plurality of asset components;
generating, by the processor, a set of features associated with the infrastructural system utilizing the plurality of data records;
inputting, by the processor, the set of features into a degradation machine learning model;
receiving, by the processor, an output from the degradation machine learning model indicative of a prediction of a condition of an infrastructure asset component of the plurality of asset components within a predetermined time; and
rendering, by the processor, on a graphical user interface a representation of a location, the condition predicted for the infrastructure asset component within the predetermined time, and at least one recommended asset management decision.
   2. A system, comprising:
at least one database comprising a first dataset with time-independent characteristics associated with a plurality of infrastructure assets of an infrastructural system and a second dataset with time-dependent characteristics associated with the plurality of infrastructure assets;
at least one processor in communicated with the at least one database, wherein the at least one processor is configured to execute software instructions that cause the at least one processor to perform steps to:
   receive the first dataset with the time-independent characteristics associated with the plurality of infrastructure assets of the infrastructural system;
   receive the second dataset with the time-dependent characteristics associated with the plurality of infrastructure assets;
   segment the infrastructural system into the plurality of infrastructure assets, wherein each segment comprises a plurality of asset components;
   generate a plurality of data records comprising a data record for each infrastructure asset of the plurality of infrastructure assets wherein each data record from the plurality of data records comprises:
      i) a subset of the first dataset comprising time-independent characteristics associated with the plurality of asset components, and
      ii) a subset of the second dataset comprising time-dependent characteristics associated with plurality of asset components;
   generate a set of features associated with the infrastructural system utilizing the plurality of data records;
   input the set of features into a degradation machine learning model;
   receive an output from the degradation machine learning model indicative of a prediction of a condition of an infrastructure asset component of the plurality of asset components within a predetermined time; and
   render on a graphical user interface a representation of a location, the condition predicted for the infrastructure asset component within the predetermined time, and at least one recommended asset management decision.
      3. The systems and methods of any of clauses 1 and/or 2, wherein the infrastructural system comprises a rail system;
wherein the plurality of infrastructure assets comprise a plurality of rail segments; and
wherein the plurality of asset components comprise a plurality of adjacent rail subsegments.
   4. The systems and methods of any of clauses 1 and/or 2, further comprising:
segmenting, by the processor, the plurality of infrastructure assets into a plurality of segments of infrastructure assets based on length; and
generating, by the processor, the plurality of data records representing the plurality of segments of infrastructure assets.
   5. The systems and methods of any of clauses 1 and/or 2, further comprising:
segmenting, by the processor, the plurality of infrastructure assets into a plurality of segments of infrastructure assets based on asset features; and
generating, by the processor, the plurality of data records representing the plurality of segments of infrastructure assets.
   6. The systems and methods of clause 5, wherein the asset features comprise at least one of traffic data, vehicle speed data, vehicle operational data, asset weight data, asset age data, asset design data, asset material data, asset condition data, asset defect data, asset failure data, inspection data, maintenance data, repair data, replacement data, rehabilitation data, asset usage data, asset geometry data or a combination thereof.
   7. The systems and methods of clause 5, further comprising determining, by the processor, the plurality of segments of infrastructure assets according to a minimal internal variance of the asset features of the plurality of infrastructure assets in each segment of the plurality of segments of infrastructure assets.
   8. The systems and methods of any of clauses 1 and/or 2, wherein the asset features comprise at least one of:
i) usage data, traffic data, speed data and operational data,
ii) environmental impact data,
iii) asset characteristics data, design and geometric data, and condition data,
iv) inspection results data,
v) inspection data, maintenance data, repair data, replacement data, rehabilitation data, or
iv) any combination thereof.
   9. The systems and methods of any of clauses 1 and/or 2, further comprising:
generating, by the processor, features associated with the infrastructural system utilizing the plurality of data records; and
inputting, by the processor, the features into a feature selection machine learning algorithm to select the set of features.
   10. The systems and methods of any of clauses 1 and/or 2, further comprising:
inputting, by the processor, the set of features into the degradation machine learning model to produce event probabilities;
encoding, by the processor, outcome events of the set of features into a plurality of outcome labels;
mapping, by the processor, the event probabilities to the plurality of outcome labels; and
decoding, by the processor, the event probabilities based on the mapping to produce the prediction of the condition.
   11. The systems and methods of clause 10, further comprising encoding, by the processor, the outcome events of the set of features into at least one soft tiling of the plurality of outcome labels;
wherein the plurality of outcome labels comprises a plurality of time-based tiles of outcome labels.
   13. The systems and methods of any of clauses 1 and/or 2, wherein the degradation machine learning model comprises at least one neural network.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added, and/or any desired steps may be eliminated).

1. A method, comprising:
receiving, by a processor, a first dataset with time-independent characteristics associated with a plurality of infrastructure assets of an infrastructural system;
receiving, by the processor, a second dataset with time-dependent characteristics associated with the plurality of infrastructure assets;
segmenting, by the processor, the infrastructural system to group segments of a plurality of asset components into the plurality of infrastructure assets;
generating, by the processor, a plurality of data records comprising a data record for each infrastructure asset of the plurality of infrastructure assets wherein each data record from the plurality of data records comprises:
i) a subset of the first dataset comprising time-independent characteristics associated with the plurality of asset components, and
ii) a subset of the second dataset comprising time-dependent characteristics associated with plurality of asset components;
generating, by the processor, a set of features associated with the infrastructural system utilizing the plurality of data records;
inputting, by the processor, the set of features into a degradation machine learning model;
receiving, by the processor, an output from the degradation machine learning model indicative of a prediction of a condition of an infrastructure asset component of the plurality of asset components within a predetermined time; and
rendering, by the processor, on a graphical user interface a representation of a location, the condition predicted for the infrastructure asset component within the predetermined time, and at least one recommended asset management decision.

2. The method of claim 1, wherein the infrastructural system comprises a rail system;
wherein the plurality of infrastructure assets comprise a plurality of rail segments; and
wherein the plurality of asset components comprise a plurality of adjacent rail subsegments.

3. The method of claim 1, further comprising:
segmenting, by the processor, the plurality of infrastructure assets into a plurality of segments of infrastructure assets based on length; and
generating, by the processor, the plurality of data records representing the plurality of segments of infrastructure assets.

4. The method of claim 1, further comprising:
segmenting, by the processor, the plurality of infrastructure assets into a plurality of segments of infrastructure assets based on asset features; and
generating, by the processor, the plurality of data records representing the plurality of segments of infrastructure assets.

5. The method of claim 4, wherein the asset features comprise at least one of traffic data, vehicle speed data, vehicle operational data, asset weight data, asset age data, asset design data, asset material data, asset condition data, asset defect data, asset failure data, inspection data, maintenance data, repair data, replacement data, rehabilitation data, asset usage data, asset geometry data or a combination thereof.

6. The method of claim 4, further comprising determining, by the processor, the plurality of segments of infrastructure assets according to a minimal internal variance of the asset features of the plurality of infrastructure assets in each segment of the plurality of segments of infrastructure assets.

7. The method of claim 1, wherein features of the set of features comprise at least one of:
i) usage data, traffic data, speed data and operational data,
ii) environmental impact data,
iii) asset characteristics data, design and geometric data, and condition data,
iv) inspection results data,
v) inspection data, maintenance data, repair data, replacement data, rehabilitation data, or
iv) any combination thereof.

8. The method of claim 1, further comprising:
generating, by the processor, features associated with the infrastructural system utilizing the plurality of data records; and
inputting, by the processor, the features into a feature selection machine learning algorithm to select the set of features.

9. The method of claim 1, further comprising:
inputting, by the processor, the set of features into the degradation machine learning model to produce event probabilities;
encoding, by the processor, outcome events of the set of features into a plurality of outcome labels;
mapping, by the processor, the event probabilities to the plurality of outcome labels; and
decoding, by the processor, the event probabilities based on the mapping to produce the prediction of the condition.

10. The method of claim 9, further comprising encoding, by the processor, the outcome events of the set of features into at least one soft tiling of the plurality of outcome labels;
wherein the plurality of outcome labels comprises a plurality of time-based tiles of outcome labels.

11. The method of claim 1, wherein the degradation machine learning model comprises at least one neural network.

12. A system, comprising:
at least one database comprising a first dataset with time-independent characteristics associated with a plurality of infrastructure assets of an infrastructural system and a second dataset with time-dependent characteristics associated with the plurality of infrastructure assets; and
at least one processor in communicated with the at least one database, wherein the at least one processor is configured to execute software instructions that cause the at least one processor to perform steps to:
receive the first dataset with the time-independent characteristics associated with the plurality of infrastructure assets of the infrastructural system;
receive the second dataset with the time-dependent characteristics associated with the plurality of infrastructure assets;
segment the infrastructural system into the plurality of infrastructure assets, wherein each segment comprises a plurality of asset components;
generate a plurality of data records comprising a data record for each infrastructure asset of the plurality of infrastructure assets wherein each data record from the plurality of data records comprises:
i) a subset of the first dataset comprising time-independent characteristics associated with the plurality of asset components, and
ii) a subset of the second dataset comprising time-dependent characteristics associated with plurality of asset components;
generate a set of features associated with the infrastructural system utilizing the plurality of data records;
input the set of features into a degradation machine learning model;
receive an output from the degradation machine learning model indicative of a prediction of a condition of an infrastructure asset component of the plurality of asset components within a predetermined time; and
render on a graphical user interface a representation of a location, the condition predicted for the infrastructure asset component within the predetermined time, and at least one recommended asset management decision.

13. The system of claim 12, wherein the infrastructural system comprises a rail system;
wherein the plurality of infrastructure assets comprise a plurality of rail segments; and
wherein the plurality of asset components comprise a plurality of adjacent rail subsegments.

14. The system of claim 12, wherein the at least one processor is further configured to execute software instructions that cause the at least one processor to perform steps to:
segment the plurality of infrastructure assets into a plurality of segments of infrastructure assets based on length; and
generate the plurality of data records representing the plurality of segments of infrastructure assets.

15. The system of claim 12, wherein the at least one processor is further configured to execute software instructions that cause the at least one processor to perform steps to:
segment the plurality of infrastructure assets into a plurality of segments of infrastructure assets based on asset features; and
generate the plurality of data records representing the plurality of segments of infrastructure assets.

16. The system of claim 15, wherein the asset features comprise at least one of traffic data, vehicle speed data, vehicle operational data, asset weight data, asset age data, asset design data, asset material data, asset condition data, asset defect data, asset failure data, inspection data, maintenance data, repair data, replacement data, rehabilitation data, asset usage data, asset geometry data or a combination thereof.

17. The system of claim 15, wherein the at least one processor is further configured to execute software instructions that cause the at least one processor to perform steps to determine the plurality of segments of infrastructure assets according to a minimal internal variance of the asset features of the plurality of infrastructure assets in each segment of the plurality of segments of infrastructure assets.

18. The system of claim 12, wherein features of the set of features comprise at least one of:
i) usage data, traffic data, speed data and operational data,
ii) environmental impact data,
iii) asset characteristics data, design and geometric data, and condition data,
iv) inspection results data,
v) inspection data, maintenance data, repair data, replacement data, rehabilitation data, or
iv) any combination thereof.

19. The system of claim 12, wherein the at least one processor is further configured to execute software instructions that cause the at least one processor to perform steps to:
generate features associated with the infrastructural system utilizing the plurality of data records; and
input the features into a feature selection machine learning algorithm to select the set of features.

20. The system of claim 12, wherein the at least one processor is further configured to execute software instructions that cause the at least one processor to perform steps to:
input the set of features into the degradation machine learning model to produce event probabilities;
encode outcome events of the set of features into a plurality of outcome labels;
map the event probabilities to the plurality of outcome labels; and
decode the event probabilities based on the mapping to produce the prediction of the condition.
